(19) United States
(12) Patent Application Publication
(10) Pub. No.: US 2018/0304157 A1
(43) Pub. Date: Oct. 25, 2018

(54) GAME SYSTEM, GAME CONTROL DEVICE, AND INFORMATION STORAGE MEDIUM

(71) Applicant: KONAMI DIGITAL ENTERTAINMENT CO., LTD., Tokyo (JP)

(72) Inventors: Akihiro TAKATOKU, Tokyo (JP); Hideyuki TAKAHASHI, Tokyo (JP)

(73) Assignee: KONAMI DIGITAL ENTERTAINMENT CO., LTD.

(21) Appl. No.: 15/822,224

(22) Filed: Nov. 27, 2017

(30) Foreign Application Priority Data
Apr. 19, 2017 (JP) 2017-082958
Apr. 19, 2017 (JP) 2017-082959
Apr. 19, 2017 (JP) 2017-082960

(51) Int. Cl. A63F 13/822; A63F 13/35

(52) U.S. Cl. CPC A63F 13/822; A63F 13/35

(57) ABSTRACT

A game system including at least one processor configured to set a first user area, a second user area, and a common area which is different from the first user area and the second user area in a game field; set a common area; accept placement of a first-class card of a first user in the first user area; restrict placement of a second-class card of the first user in the first user area; accept placement of the first-class card of a second user in the second user area; restrict placement of the second-class card of the second user in the second user area; accept placement of the second-class card of the first user or the second-class card of the second user in the common area; and execute game processing, based on a card placed in the first user area, the second user area, or the common area.

### CROSS-REFERENCE TO RELATED APPLICATION

The present application claims priority from Japanese applications JP2017-082958, JP2017-082959, and 2017-082960 filed on Apr. 19, 2017, the content of which is hereby incorporated by reference into these applications.

### BACKGROUND OF THE INVENTION

### 1. Field of the Invention

The present invention relates to a game system, a game control device, and an information storage medium.

### 2. Description of the Related Art

A card game in which some of the cards held by a first user are assembled into a deck so that the first user plays a match with a second user, using the deck has been popular (for example, JP2002-011245A1). In such a game, the first user's turn and the second user's turn are alternatively and repetitively executed. In the first user's turn, the first user selects a card from their hand to place on a field, and attacks the second user, using the card placed in the field. In the second user's turn, on the other hand, the second user follows the procedure same as that which the first user has followed, to attack. One of the users who has decreased the opponent's point to zero wins.

### SUMMARY OF THE INVENTION

In the above described card game, special cards having higher attack points, for example, maybe prepared besides normal cards. In such a card game, use of the special cards in an attack makes it easier to win. Simultaneous use of a plurality of such special cards enables winning through a fewer number of turns, which the user may find unsatisfactory in view of strategic characteristic (amusement in planning a strategy to win) of the game.

The present invention has been conceived in view of the above, and it is an object of the present invention to provide a game system, a game control device, and an information storage medium that can improve the strategic characteristic of a game using cards.

In order to achieve the above described object, according to one aspect of the present invention, there is provided a game system including at least one processor configured to: set a first user area in a game field; set a second user area in the game field;set a common area which is different from the first user area and the second user area in the game field; accept placement of a first-class card of a first user in the first user area; restrict placement of a second-class card of the first user in the first user area; accept placement of the first-class card of a second user in the second user area; restrict placement of the second-class card of the second user in the second user area; accept placement of the second-class card of the first user or the second-class card of the second user in the common area; and execute game processing, based on a card placed in the first user area, the second user area, or the common area.

According to another aspect of the present invention, there is provided a game control device including at least one processor configured to: set a first user area in a game field; set a second user area in the game field; set a common area which is different from the first user area and the second user area in the game field; accept placement of a first-class card of a first user in the first user area; restrict placement of a second-class card of the first user in the first user area; accept placement of the first-class card of a second user in the second user area; restrict placement of the second-class card of the second user in the second user area; accept placement of the second-class card of the first user or the second-class card of the second user in the common area; and execute game processing, based on a card placed in the first user area, the second user area, or the common area.

### BRIEF DESCRIPTION OF THE DRAWINGS

FIG. 1 illustrates a complete structure of a game system according to an embodiment of the present invention;

FIG. 2 illustrates one example of a game image;

FIG. 3 illustrates details of a Duel Field;

FIG. 4 illustrates one example of the card detail image of a Monster Card;

FIG. 5 illustrates one example of the card detail image of a Monster Card;

FIG. 6 illustrates one example of the card detail image of a Monster Card;

FIG. 7 illustrates a part of the Duel Field where a Monster Card is placed at a position pointed to by a Link Arrow;

FIG. 8 illustrates a part of the Duel Field where a Monster Card is placed at a position pointed to by a Link Arrow;

FIG. 9 illustrates a part of the Duel Field with an Extra Link established;

FIG. 10 illustrates one example of the card detail image of a Spell Card;

FIG. 11 illustrates one example of the card detail image of a Trap Card;

FIG. 12 illustrates battle positions of a Monster Card;

FIG. 13 illustrates a case in which a Pendulum Summon is conducted;

FIG. 14 illustrates a case in which a Link Summon is activated;

FIG. 15 is a flowchart of phases in each turn;

FIG. 16 is a flowchart of steps in a Battle Phase;

FIG. 17 is a flowchart of five timings in a Damage Step;

FIG. 18 illustrates a structure of a chain;

FIG. 19 is a functional block diagram showing functional blocks for a first structure;

FIG. 20 illustrates one example of user list data;

FIG. 21 illustrates one example of card list data;

FIG. 22 illustrates one example of held card list data;

FIG. 23 illustrates one example of Deck data;

FIG. 24 illustrates one example of Extra Deck data;

FIG. 25 is a functional block diagram showing functional blocks for a second structure;

FIG. 26 is a functional block diagram showing functional blocks for a third structure;

FIG. 27 illustrates one example of processing executed in a game system;

FIG. 28 illustrates one example of other processing executed in a game system; and

FIG. 29 illustrates one example of determination processing executed in a game system.

### DETAILED DESCRIPTION OF THE INVENTION

The following describes an embodiment of the present invention with reference to the drawings.

### 1. STRUCTURE OF GAME SYSTEM

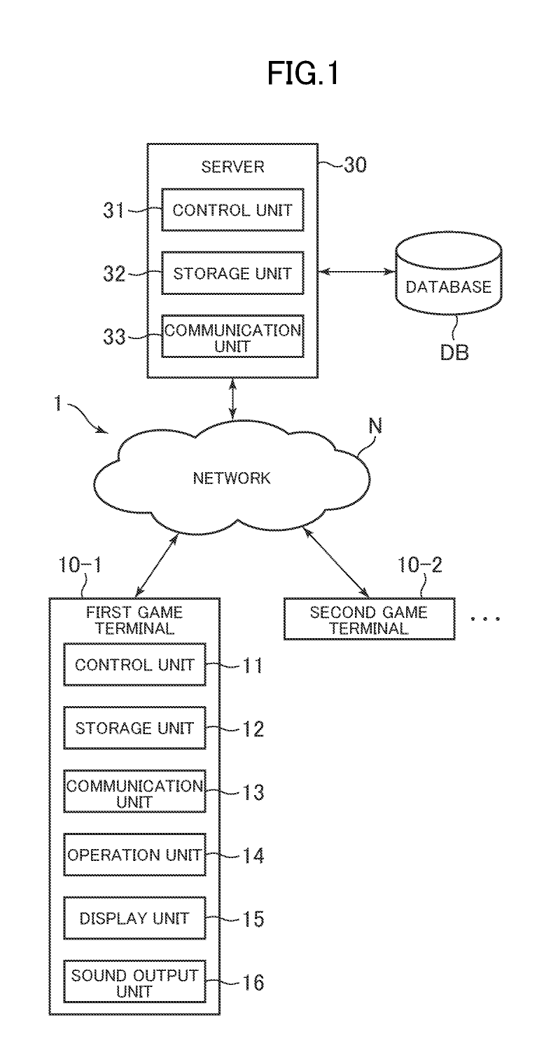

FIG. 1 illustrates a structure of a game system according to an embodiment of the present invention. As illustrated in FIG. 1, a game system 1 according to this embodiment includes a plurality of game terminals (a first game terminal 10-1, a second game terminal 10-2, and so forth) and a server 30. Each of the plurality of game terminals can exchange data with the server 30 through a network N. In the following, the first game terminal 10-1, the second game terminal 10-2, and so forth will be referred to as a game terminal 10 when distinction is unnecessary.

The game terminal 10 is a computer that a user uses to play a game. For example, the game terminal 10 is a portable phone (including a smart phone), a personal digital assistant (including a tablet computer), a portable game device, an installed game device (a consumer game device), a commercial game device, a desk top computer, or a lap top computer.

As illustrated in FIG. 1, the game terminal 10 includes a control unit 11, a storage unit 12, a communication unit 13, an operation unit 14, a display unit 15, and a sound output unit 16. The control unit 11 includes at least one microprocessor, and executes information processing according to a program stored in the storage unit 12. The storage unit 12 includes a main storage unit (for example, a RAM) and an auxiliary storage unit (for example, a nonvolatile semiconductor memory, a hard disk drive, or a solid-state drive), and stores a program and data. The communication unit 13 is used to exchange data with other devices through the network N.

The operation unit 14 is used by a user to perform various operations. The display unit 15 is a liquid crystal display or an organic EL display, for example, and used to display various images. The sound output unit 16 is a speaker or a headphone, for example, and used to output sound data (for example, sound, lines, music, or the like). Although the operation unit 14 and the display unit 15 are illustrated as separate units in FIG. 1, the operation unit 14 and the display unit 15 may be integrally formed as a touch panel. The operation unit 14 may be a pointing device, such as a mouse, a button (a key), or a lever (a stick). The operation unit 14 may be a unit for use by a user to operate by means of sound or gesture.

The server 30 is a server computer, for example. As illustrated in FIG. 1, the server 30 includes a control unit 31, a storage unit 32, and a communication unit 33. The control unit 31, the storage unit 32, and the communication unit 33 are similar to the control unit 11, the storage unit 12, and the communication unit 13, respectively, of the game terminal 10. The server 30 can access a database DB. The database DB may be built in the server 30 or a server computer different from the server 30.

A program and data are supplied to the game terminal 10 or the server 30 through the network N and stored in the storage unit 12 or the storage unit 32. The game terminal 10 or the server 30 may have a structural component (for example, an optical disk drive or a memory card slot) for reading a program and data stored in an information storage medium (for example, an optical disk or a memory card), and the program and data may be supplied via the information storage medium to the game terminal 10 or the server 30.

### 2. OUTLINE OF CARD GAME

The following describes a technique relevant to the present invention with reference to a case in which a game using cards (hereinafter referred to as a “card game”) among various games which the game system 1 can execute is executed in the game system 1.

A card game is a matching card game or a trading card game, for example. A trading card game, sometimes referred to as a “collectable card game” or a “customizable card game” in English speaking countries, is characterized in that a deck to be used is not fixed, like playing cards.

In a card game, a first user assembles some of their cards according to a predetermined rule to thereby create a deck, and plays a match with a second user, using the deck. The second user maybe either a human user other than the first user or a computer (a computer imitating a human user).

A “Deck” is a bunch of cards including a plurality of cards (that is, a collection of cards), and referred to also as a Bank. In the following, a “Deck” refers to a bunch of cards assembled for a user to play a game with, while a “Bank” refers to a bunch of cards placed face down in a game filed (that is, a deck shuffled and placed face down) during a game. In this specification, for distinction, a combination of desired cards held by a user will be referred to as a “Deck”, while virtually piled up cards in a predetermined place for a user to draw a card therefrom will be referred to as a “Bank”

“To execute a card game” means to execute a computerized card game, for example, that is, to play a card game for a match between a first user and a second user through a computer and a network. That is, to play a card game may mean to play a computerized game based on a real trading card game or a virtual (unique) trading card game.

The following describes one example of a card game to be executed in the game system 1. A card game maybe a client/server game to be executed through data transmission between the game terminal 10 and the server 30 or a stand-alone game to be executed in a single game terminal 10.

[2-1]

A card game is executed by turn. A turn refers to an order according to which a first user or a second user can play. In a card game, a first user's turn and a second user's turn are alternatively and repetitively executed. A user to go first and a user to go second are decided at the start of a match in the card game.

The first user and the second users have Life Points at the start of a match. Life Points are points indicating life power in a game, and serve as a base value to judge who wins and who loses, as to be described later. The points may be those named differently, such as “bit points”. The initial Life Points are 8000 points in this embodiment, though they may be any points.

In the first user's turn, the first user draws a card from their bank and adds the card drawn to their hand. A “hand” refers to virtual cards held by each user in the game, that is, cards available to be placed in the game field. Specifically, the first user places any card from their hand on the game field, and attacks the second user or performs other operations, using the card on the game field. Similarly, in the second user's turn, the second user draws a card from their Bank and adds the card drawn to their hand. The second user places any card from their hand on the game field, and attacks the first user or performs other operations, using the card placed on the game field.

Some card games use a special deck (for example, an Extra Deck to be described later), or a combination of special kinds of cards, besides a normal deck (a Main Deck). In such a card game, a card from the special deck is placed on the game field under a predetermined condition and used to attack the opponent, to defend from an attack from the opponent, or to perform other operations.

An attack from the first user against the second user reduces the Life Points of the second user. When the second user's Life Points become zero, the first user wins. Similarly, an attack from the second user against the first user reduces the Life Points of the first user. When the first user's Life Points become zero, the first user loses.

A victory condition of a game is not limited to one involving the Life Points. For example, a victory condition can be that a user who has first drawn up all their cards from the Bank with no card left and thus unable to draw a card from the Bank loses, and their opponent wins. Alternatively, a victory condition can be that, for example, a combination of specific cards is completed in their hands, that cards in a specific combination are placed out in a predetermined order on the game field, or that a predetermined number of turns have elapsed after activation of a spell indicated by a specific card, or the like.

[2-2]

The following describes basic terminologies for the card game and the types of cards.

[2-2-1]

In this embodiment, a game field where to place cards is referred to as a Duel Field. The Duel Field is a virtual world created by the game system 1, and can be a three-dimensional (3D) space or a two dimensional (2D) flat surface. A first user and a second user can place cards in predetermined positions in the Duel Field. During a game, a game image of the Duel Field is displayed on the display unit 15.

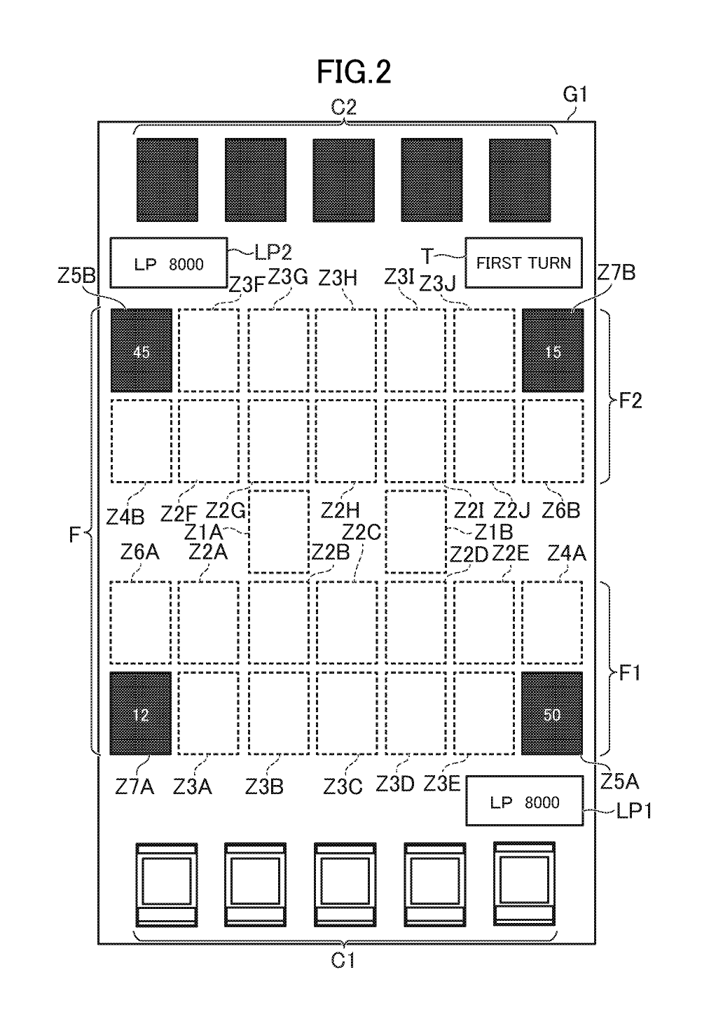

FIG. 2 illustrates one example of the game image. The game image G1 illustrated in FIG. 2 includes the first user's hand C1, the second user's hand C2, the first user's Life Points LP1, the second user's Life Points LP2, a current turn T, and the current situation of the Duel Field F. The first user can advance a card game by performing an operation to, for example, select a card to use from their hand C1, shown in the game image G1, or to draw a card from their Bank on the Duel Field F.

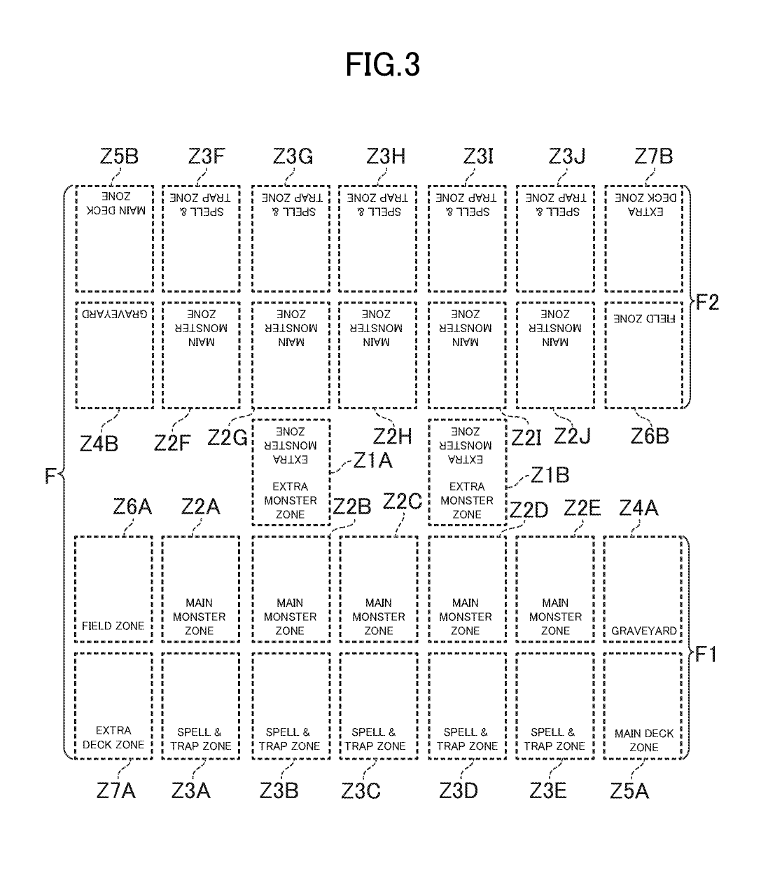

FIG. 3 illustrates details of the Duel Field F. The Duel Field F illustrated in FIG. 3 includes a first user Duel Field F1, a second user Duel Field F2, and Extra Monster Zones Z1A, Z1B. In FIG. 3, texts identifying an area for placement of the first user's cards therein are shown in a normal orientation, texts identifying an area for placement of the second user's cards therein are shown in a reversed orientation, and texts identifying a common area for the first user and the second user are shown in both normal and reversed orientations.

The first user Duel Field F1 is an area where to place the first user's cards and positioned closer to the first user (lower on the drawing paper) than the second user Duel Field F2 and the Extra Monster Zones Z1A, Z1B are. The first user Duel Field F1 includes Main Monster Zones Z2A to Z2E, Spell & Trap Zones Z3A to Z3E, a Graveyard Z4A, a Main Deck Zone Z5A, a Field Zone Z6A, and an Extra Deck Zone Z7A.

The Main Monster Zones Z2A to Z2E are areas where to place Monster Cards to be described later. That is, each of the Main Monster Zones Z2A to Z2E is an area where to place Monster Cards other than Extra Monster Cards to be described later. Using five Main Monster Zones Z2A to Z2E to place Monster Cards therein, the first user can summon up to five monsters. “Summoning a monster” means placing a Monster Card on the Duel Field F (the Main Monster Zones Z2A to Z2E and the Extra Monster Zones Z1A, Z1B, for example) to thereby have the monster ready to battle (an attack against the opponent, for example), which will be described later in detail.

The Spell & Trap Zones Z3A to Z3E are areas where to place Spell Cards and Trap Cards to be described later. Using five Spell & Trap Zones Z3A to Z3E, the first user can place up to five Spell and Trap Cards. The leftmost and rightmost Spell & Trap Zones Z3A, Z3E are available for placement of Pendulum Monster Cards to be described later as Spell Cards, and thus may be referred to as Pendulum Zones in this embodiment. That is, the Pendulum Zones Z3A, Z3E are areas where to place Pendulum Monster Cards to be described later to execute a Pendulum Summon.

The Graveyard Z4A is an area where to place Monster Cards of monsters other than Pendulum Monsters to be described later when destroyed or Spell & Trap Cards being used.

The Main Deck Zone Z5A is an area where to place a Main Deck to be described later as the Bank. A user can draw a card from the Bank in the Main Deck Zone Z5A to add to their hand. In the Main Deck Zone Z5A, the number of remaining cards in the Bank is shown.

The Field Zone Z6A is an area where to place Field Spell Cards to be described later. Field Spell Cards are not placed in the Spell & Trap Zones, and thus not included in the five cards placed in the Spell & Trap Zones.

The Extra Deck Zone Z7A is an area where to place an Extra Deck to be described later. When a Pendulum Monster to be described later is destroyed, the Pendulum Monster Card is placed face up in the Extra Deck Zone Z7A. Only in this case, the number of cards included in the Extra Deck can exceed the upper limit, namely, fifteen, of the cards that can be included in the Extra Deck to be described later. In the Extra Deck Zone Z7A, the number of remaining cards in the Bank is shown.

The second user Duel Field F2 is an area where to place the second user's cards. As illustrated in FIG. 3, the second user Duel Field F2, having the same structure as that of the first user Duel Field F1, includes Main Monster Zones Z2F to Z2J, Spell & Trap Zones Z3F to Z3J, a Graveyard Z4B, a Main Deck Zone Z5B, a Field Zone Z6B, and an Extra Deck Zone Z7B. Meanings and functions of these areas are the same as those of the first user Duel Field F1, and thus will not be described here. In the second user Duel Field F2, the Spell & Trap Zones Z3F, Z3J can be used also as Pendulum Zones.

The Main Monster Zones Z2A to Z2J will be hereinafter referred to as a Main Monster Zone Z2 when distinction is unnecessary. Similarly, the Spell & Trap Zones Z3A to Z3J, the Graveyards Z4A, Z4B, the Main Deck Zones Z5A, Z5B, the Field Zones Z6A, Z6B, and the Extra Deck Zones Z7A, Z7B are respectively referred to as a Spell & Trap Zone Z3, a Graveyard Z4, a Main Deck Zone Z5, a Field Zone Z6, and an Extra Deck Zone Z7 when distinction is unnecessary.

The Extra Monster Zones Z1A, Z1B are areas where to place Extra Monster Cards to be described later. That is, each of the Extra Monster Zones Z1A, Z1B is an area for use to summon Extra Monsters to be described later. The Extra Monster Zones Z1A, Z1B are set between the first user Duel Field F1 and the second user Duel Field F2.

In this embodiment, two Extra Monster Zones Z1A, Z1B are set. That is, the number of Extra Monster Zones Z1A, Z1B is smaller than the number of the Main Monster Zones Z2 for each of the first user and the second user, namely, five. The Extra Monster Zones Z1A, Z1B are common areas for the first user and the second user, where both the first user and the second user can place their cards under a predetermined condition.

When both the Extra Monster Zones Z1A, Z1B are vacant, for example, the first user and the second user can place an Extra Monster Card in either one of the Extra Monster Zones Z1A, Z1B which they like. Once the first user places an Extra Monster Card in one of the Extra Monster Zones Z1A, Z1B, the first user can no longer place an Extra Monster Card in the other one of the Extra Monster Zones Z1A, Z1B on principle, and the second user can place an Extra Monster Card on the other one of the Extra Monsters Z1A, Z1B. Similarly, once the second user places an Extra Monster Card in one of the Extra Monster Zones Z1A, Z1B, the second user can no longer place an Extra Monster Card in the other one of the Extra Monster Zones Z1A, Z1B on principle, and the first user can place an Extra Monster Card on the other one of the Extra Monsters Z1A, Z1B. The Extra Monster Zones Z1A, Z1B will be hereinafter referred to as an Extra Monster Zone Z1 when distinction is unnecessary.

The Duel Field F is not limited to the above described example. For example, the Duel Field F may include a Banished Zone where to place a card banished from a game. The Banished Zone is defined outside the Duel Field F, and may not be displayed in the game image G1.

[2-2-2]

There are two types of decks, namely, a Main Deck and an Extra Deck. The Main Deck includes Monster Cards other than Extra Monster Cards to be described later, Spell Cards, and Trap Cards. The number of cards that can be included in the Main Deck is from forty to sixty inclusive in this embodiment, though the number may be any number.

Meanwhile, the Extra Deck includes only Extra Monster Cards to be described later. The number of cards that can be included in the Extra Deck is up to fifteen in this embodiment, though the number may be any number. The Extra Deck is not an essential component to play a game. When Extra Monster Cards are not used, an Extra Deck need not be created.

[2-2-3]

The following describes the types of cards. There are roughly three types of cards, namely, Monster Cards, Spell Cards, and Trap Cards.

[2-2-3-1]

Monster Cards are cards to summon monsters, and each has a monster to be summoned painted thereon. In this embodiment, a “Monster Card” refers to a card itself that is to be placed on the Duel Field F, while a “Monster” refers to a game character that is played onto a game by its Monster Card. The Monster Cards are categorized into Extra Monster Cards and Monster Cards other than Extra Monster Cards.

Extra Monster Cards are monster cards to summon Extra Monsters, and there are four kinds of Extra Monster Cards, namely, Fusion Monster Cards, Synchro Monster Cards, Xyz Monster Cards, and Link Monster Cards. On principle, Extra Monsters have higher ability than those of other monsters. “Higher ability” here means higher attack or defense points than those of other monsters at the same level or being able to obtain card advantage by an effect activated. “Card advantage” means being able to advance a game by using fewer cards than those of the opponent. One example of the “card advantage” is being able to destroy two cards of the opponent by using one card or being able to destroy one card of the opponent by using a card effect. Extra Monster Cards are subjected to restriction to the effect that Extra Monster Cards can be placed only in the Extra Monster Zone Z1 but not in the Main Monster Zone Z2 on principle. This restriction, however, can be lifted by using a Link Monster Card, as will be described later.

Monster Cards other than Extra Monster Cards are monster cards to summon monsters other than Extra Monsters, and there are four types of such Monster Cards, namely, Normal Monster Cards, Effect Monster Cards, Ritual Monster Cards, and Pendulum Monster Cards.

The first user can display a card detail image showing details of a Monster Card on the Duel Field F or in the hand on the display unit 15 by applying a predetermined operation with the operation unit 14 during a game. However, the first user cannot display the card detail image G2 of a Monster Card of the second user placed, if any, in face-down Defense Position, to be described later, on the Duel Field F. The first user can see the list of cards in the first user's Graveyard Z4 and the second user's Graveyard Z4. Similarly, the second user as well can see the list of cards in the first user's Graveyard Z4 and the second user's Graveyard Z4. The following describes details of the respective Monster Cards with reference to the respective card detail images.

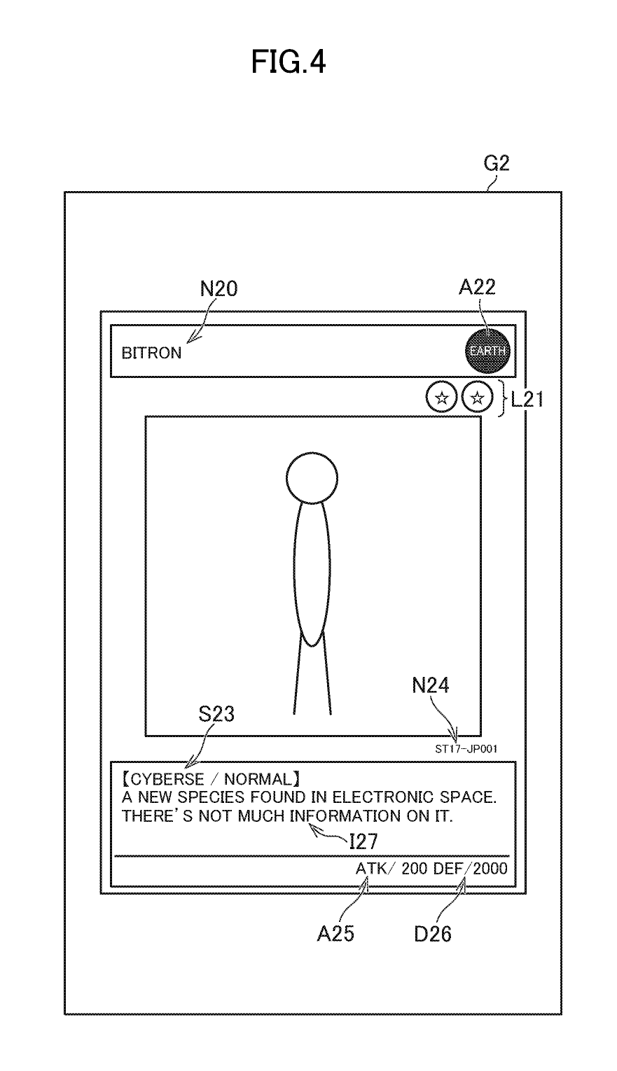

FIGS. 4 to 6 illustrates card detail images of Monster Cards. FIG. 4 illustrates the card detail image G2 of a Normal Monster Card. The layouts of the card detail images G2 of Effect Monster Cards, Ritual Monster Cards, Fusion Monster Cards, Xyz Monster Cards, and Synchro Monster Cards are similar to that of Normal Monster Cards, and thus not illustrated here.

Normal Monster Cards are Monster Cards to summon Normal Monsters. Normal Monsters are basic monsters having no special effect. Many Normal Monsters have high attack points and high defense points, instead of a special effect. On the card detail image G2 illustrated in FIG. 4, the external appearance of the monster is painted, and a Card Name N20, a Level L21, an Attribute A22, a Type S23, a Card Number N24, Attack Points A25, Defense Points D26, and a Card Description I27 are written thereon.

The Card Name N20 is the name of a monster. The Level L21 is the level of the monster, and a higher level makes a stronger monster. The Attribute A22 is an attribute to which the monster belongs among a plurality of attributes (there are six kinds, for example, namely, dark, earth, fire, light, water, and wind). The Type S23 is the type of the monster among a plurality of types (for example, a spellcaster, a fiend, a machine, or the like). The Card Number N24 is information for uniquely identifying the card.

The Attack Points A25 indicate the attack points, that is, the height of the attack ability, of the monster, while the Defense Points D26 indicate the defense points, that is, the height of the defense ability, of the monster. The higher the attack and defense points of a monster are, the more advantageous the monster is in a battle with other monsters. The Card Description I27 is detailed information on the monster, and describes the nature and characteristics of Normal Monsters or an effect or a manner of using the Monster Cards of monsters other than Normal Monsters.

Effect Monster Cards are Monster Cards to summon Effect Monsters. Effect Monsters are monsters that can activate an effect, like Spell Cards. The card detail image G2 of an Effect Monster Card has a description of the content of an effect for activation and a condition for activating the effect, written in the Card Description I27 thereon. Besides Effect Monsters, there are some monsters that can activate an effect among Ritual Monsters, Fusion Monsters, Synchro Monsters, Xyz Monsters, Pendulum Monsters, and Link Monsters.

Ritual Monster Cards are Monster Cards to summon Ritual Monsters. Ritual Monsters are monsters to be summoned upon a Ritual Summon to be described later. The card detail image G2 of a Ritual Monster Card indicates a Ritual Spell Card that is required to summon a Ritual Monster, written in the Card Description I27. Details of Ritual Spell Cards will be described later.

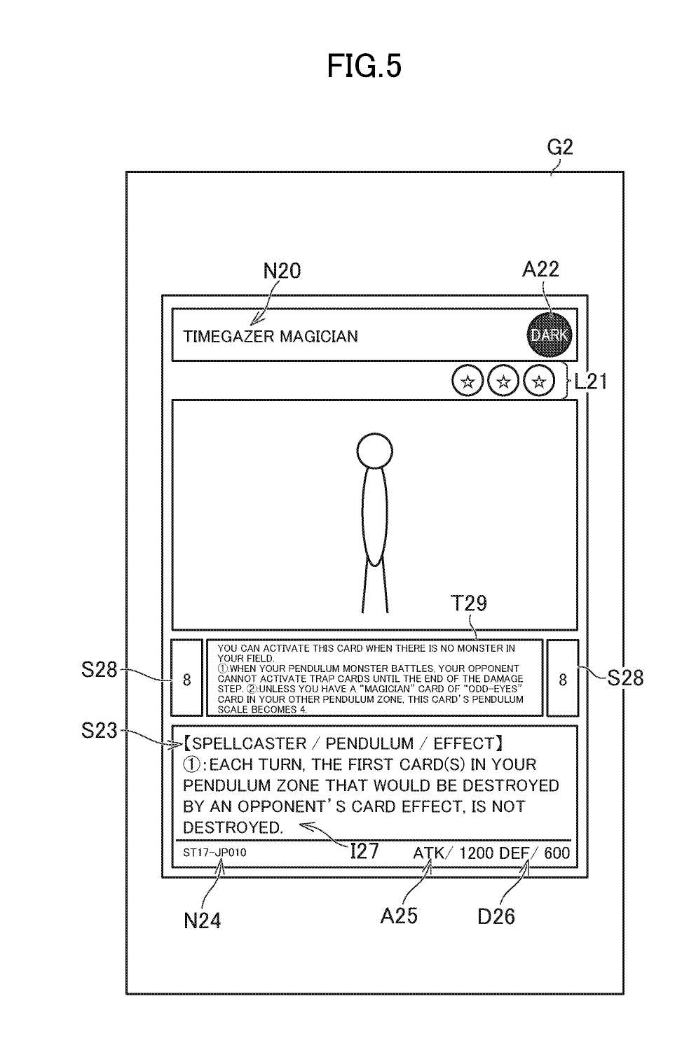

FIG. 5 illustrates the card detail image G2 of a Pendulum Monster Card. A Pendulum Monster Card functions as a Spell Card to conduct a Pendulum Summon to be described later, as well as a Monster Card to summon a Pendulum Monster as a monster. The card detail image G2 illustrated in FIG. 5 includes a Pendulum Scale S28 and a Pendulum Effect Text T29, different from the other card detail images G2.

The Pendulum Scale S28 indicates the numeric value of a Pendulum Scale. The Pendulum Scale is a numeric value for specifying the level of a monster that can be summoned upon a Pendulum Summon. Details of the manner of using the Pendulum Scale will be described later.

Pendulum Monster Cards in a hand can be placed in the Main Monster Zone Z2, like Normal Monster Cards, or in the Pendulum Zone Z3, but not in the Spell & Trap Zone Z3 other than the Pendulum Zone Z3.

In this embodiment, the contents of effects of Pendulum Monster Cards differ depending on the position where a Pendulum Monster Card is placed. That is, an effect to be activated with a Pendulum Monster Card placed in the Main Monster Zone Z2 differs from an effect to be activated with a Pendulum Monster Card placed in the Pendulum Zone Z3.

The Pendulum Effect Text T29 describes an effect to be activated with a Pendulum Monster Card placed in the Pendulum Zone Z3. That is, with a Pendulum Monster Card placed in the Pendulum Zone Z3, the effect described in the Pendulum Effect Text T29 is activated, but the effect described in the Card Description I27 is not activated. Meanwhile, with a Pendulum Monster Card placed in the Main Monster Zone Z2 (that is, when a Pendulum Monster is summoned), the effect described in the Card Description I27 is activated, but the effect described in the Pendulum Effect Text T29 is not.

Fusion Monster Cards are monster cards to summon Fusion Monsters. Fusion Monsters are monsters to be summoned upon a Fusion Summon to be described later. The card detail image G2 of a Fusion Monster Card indicates a material that is needed for a Fusion Summon, written in the Card Description I27. A card that makes a material needed for a Fusion Summon is a Monster Card that is moved to the Graveyard Z4 in exchange for the Fusion Monster Card. In other words, a card that makes a material needed for a Fusion Summon is a Monster Card that is sent from the hand or the field or both to the Graveyard Z4 in exchange for the Fusion Monster Card.

Synchro Monster Cards are Monster Cards to Special Summon Synchro Monsters. Synchro Monsters are monsters to be Special Summoned upon a Synchro Summon to be described later. The card detail image G2 of a Synchro Monster indicates a material that is needed for a Synchro Summon, written in the Card Description I27. A card that makes a material needed for a Synchro Summon is a Monster Card that is moved to the Graveyard Z4 in exchange for the Synchro Monster Card. In other words, a card that makes a material needed for a Synchro Summon is a Monster Card that is sent from the hand or the field or both to the Graveyard Z4 in exchange for the Synchro Monster.

Xyz Monster Cards are Monster Cards to Special Summon Xyz Monsters. Xyz Monsters are monsters to be summoned upon an Xyz Summon to be described later. An Xyz Monster has a numeric value called a rank instead of the level, and the card detail image G2 of an Xyz Monster shows the numeric value of the rank. The rank indicates the level of a material needed for an Xyz Summon. The card detail image G2 of an Xyz Monster indicates a material needed for an Xyz Summon, that is, how many monsters at the same level as the rank is needed, which is written in the Card Description I27. A card that makes a material is placed beneath the Xyz Monster Card, instead of being sent to the Graveyard Z4, whereby an Xyz Monster is summoned to the Duel Field F. The card (the card as a material) placed beneath the Xyz Monster Card will activate various effects when being sent to the Graveyard Z4.

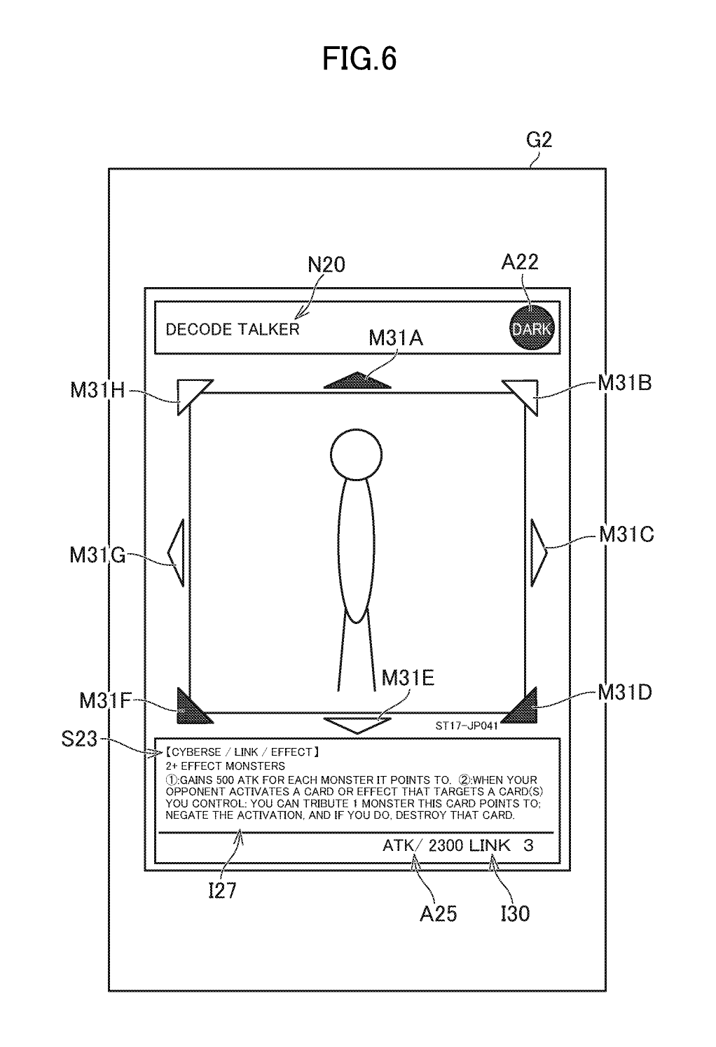

FIG. 6 illustrates the card detail image G2 of a Link Monster Card. Link Monster Cards are Monster Cards to conduct a Link Summon to be described later. Link Monsters are monsters to be Special Summoned upon a Link Summon to be described later. As illustrated in FIG. 6, a Link Monster has a numeric value named a Link, instead of the Defense Points. The Link indicates the number of Link Arrows to be described later. The higher the numeric value of the Link is, the stronger the Link Monster is. The card detail image G2 has Link information I30 that indicates the numeric value of the Link of the Link Monster. A Link Monster may have low attack points as the Link Monster has a special effect to be described later, instead.

The card detail image G2 illustrated in FIG. 6 includes Link Arrows M31A to M31H, different from the other card detail images G2. The Link Arrows M31A to M31H point eight respective directions, namely, the upper, upper right, right, lower right, lower, lower left, left, and upper left directions. The Link Arrows M31A to M31H will be hereinafter referred to as a Link Arrow M31 when distinction is unnecessary.

Link Monster Cards have a special effect that allows placement of Extra Monster Cards in the Main Monster Zone Z2. The Link Arrow M31 is a marker pointing to a direction (a place) in which an effect acts. That is, a Link Monster Card can impart an effect so as to act in a direction which a Link Arrow M31 in a color different, or changed, from the original color points to. In FIG. 6, a Link Arrow M31 in the original color is illustrated white inside, and a Link Arrow M31 in a color changed from the original color, or in the changed color, is illustrated half-toned inside. The Link Monster Card illustrated in FIG. 6 has three Link Arrows M31A, M31D, M31F in the changed color, which means that it is possible to impart an effect so as to act in three directions, namely, the upper, lower right, and lower left directions. The direction pointed to by the Link Arrow M31 in the changed color will be hereinafter referred to as “the direction pointed to by the Link Arrow M31”.

For example, the first user, having placed a Link Monster Card in the Extra Monster Zone Z1A illustrated in FIG. 6, is allowed to place an Extra Monster Card in the Main Monster Zones Z2A, Z2C, Z2G respectively positioned to the lower left of, to the lower right of, and above the Extra Monster Zone Z1A. However, the first user cannot place an Extra Monster Card in the Main Monster Zone Z2G, which is located inside the second user Duel Field F2, and the second user instead can place an Extra Monster Card in the Main Monster Zone Z2G. That is, the first user's placing a Link Monster Card in the Extra Monster Zone Z1A, Z1B may advantage not only the first user, but possibly also the second user, depending on the direction pointed to by the Link Arrow M31 of the Link Monster Card.

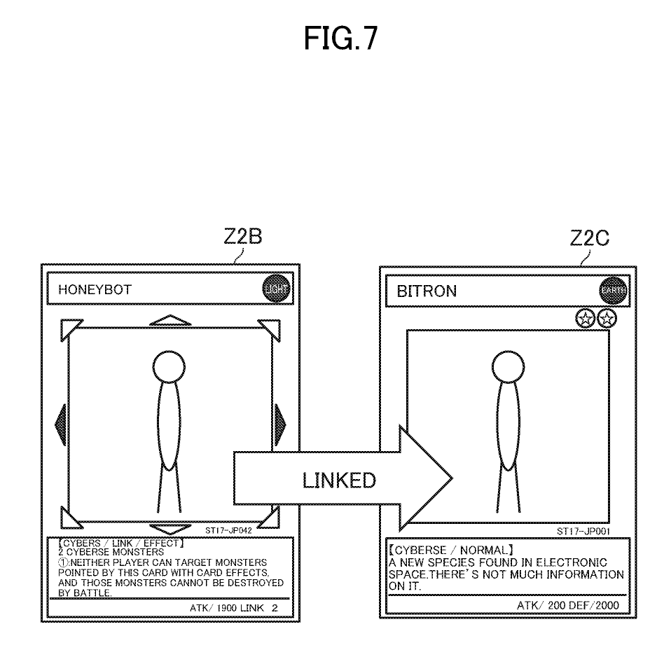

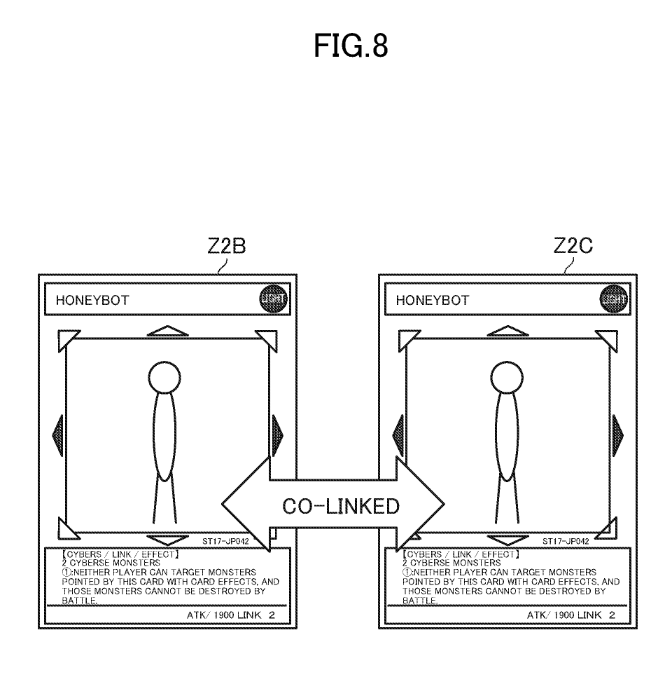

A Link Monster Card placed in the direction pointed to by the Link Arrow M31 can further expand an area that allows placement of Extra Monster Cards therein. For example, when the first user places “Decode Talker” illustrated in FIG. 6 in the Extra Monster Zone Z1A and, further, a Link Monster Card with Link Arrows M31C, M31G in the changed color (that is, a Link Monster Card with the Link Arrows M31 pointing to the left direction and the right direction, respectively, such as “Honeybot”, to be describe later, illustrated in FIGS. 7 and 8, for example) in the Main Monster Zone Z2C, the first user is now allowed to place additional Extra Monster Cards in the Main Monster Zones Z2B, Z2D to the left and right of the Main Monster Zone Z2C, respectively. This connection of Link Monster Cards enables gradual expansion of an area for placement of Extra Monster Cards therein.

Note that it is not always necessary to place an Extra Monster Card at a position pointed to by the Link Arrow M31 of a Link Monster Card, and a Monster Card other than Extra Monster Cards can be placed instead. The first user and the second user are not allowed to place their card upside down, and thus cannot change a position to be affected by the effect of a Link Monster Card by changing the orientation in placing a card.

FIGS. 7 and 8 illustrate a part of the Duel Field F where a Monster Card is placed at a position pointed to by the Link Arrow M31. In FIG. 7, a Link Monster Card “Honeybot” is placed in the Main Monster Zone Z2B by an effect of another Link Monster Card, and a Normal Monster Card “Bitron” is placed in the Main Monster Zone Z2C.

As illustrated in FIG. 7, a situation can occur during a match in a card game in which a Monster Card is placed at a position pointed to by the Link Arrow M31 of another Link Monster Card. This will be hereinafter referred to as “linked”. In FIG. 7, as “Bitron” is placed at a position pointed to by the Link Arrow M31C of “Honeybot”, “Honeybot” and “Bitron” are linked to each other.

Of the cards linked, the card placed at a position pointed to by a Link Arrow M31 is referred to as a linked card, and the Link Monster Card with the Link Arrow M31 pointing to is referred to as a linking card. In FIG. 7, “Bitron” is a linked card, and “Honeybot” is a linking card. Some of the monsters have an effect that is activated only when their Monster Cards are linked. For example, the linking “Honeybot” can activate an effect that gives tolerance for an effect or a battle to the linked “Bitron”.

FIG. 8 illustrates a case in which Link Monster Cards “Honeybot” are placed in the respective Main Monsters Zones Z2B, Z2C. As illustrated in FIG. 8, a situation can occur in which the Link Arrows M31 of two Link Monsters are pointing at each other. This will be hereinafter referred to as “co-linked”. In FIG. 8, the two cards “Honeybot” are co-linked, mutually imparting an effect that gives tolerance for an effect or a battle.

In this embodiment, when a user establishes a “co-linked” state with a Link Monster Card placed in either one of the Extra Monster Zones Z1A, Z1B, the user is now allowed to place a Link Monster Card in the other one of the two Extra Monster Zones Z1A, Z1B. In this embodiment, a state in which two Link Monster Cards in the two respective Extra Monster Zones Z1A, Z1B are co-linked via other cards placed in the Main Monster Zone Z2 is referred to as an Extra Link.

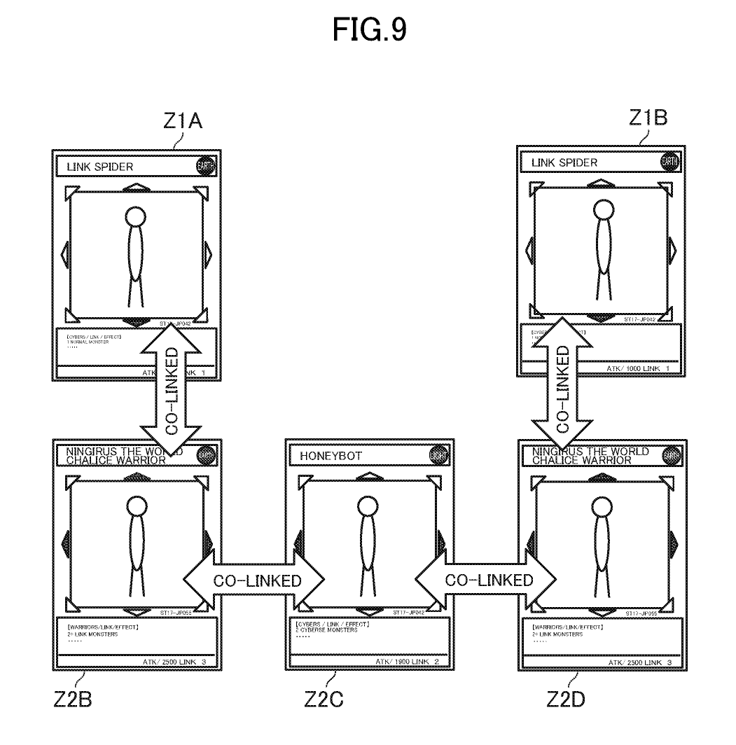

FIG. 9 illustrates a part of the Dual Field F with an Extra Link established. As described above, when the first user places a Link Monster Card in the Extra Monster Zone Z1A, the first user is no longer allowed to place a Link Monster Card in the Extra Monster Zone Z1B. However, when the first user places Link Monster Cards in the Main Monster Zones Z2B, Z2C, Z2D such that all monsters are co-linked (that is, an Extra Link is established), the first user is resultantly allowed to place an Extra Monster in the Extra Monster Zone Z1B as well.

For example, in the case where the first user sequentially places “Link Spider” in the Extra Monster Zone Z1A, then first “Ningirsu the World Chalice Warrior”, “Honeybot”, and second “Ningirsu the World Chalice Warrior” in the respective Main Monster Zones Z2B, Z2C, Z2D, as in the example illustrated in FIG. 9, these four Link Monster Cards are co-linked. In the above, as the upward Link Arrow M31A of the “Ningirsu the World Chalice Warrior” in the Main Monster Zone Z2D is shown in the changed color, the first user can place a Link Monster Card in the Extra Monster Zone Z1B as well. Then, the first user's additionally placing “Link Spider” in the Extra Monster Zone Z1B completes an Extra Link. The completion of an Extra Link hinders the second user from placing an Extra Monster Card in the Extra Monster Zone Z1B, where a Link Monster Card of the first user is already placed.

In the example in FIG. 9, Link Monster Cards are placed in all three Main Monster Zones Z2B, Z2C, Z2D whereby an Extra Link is completed. Meanwhile, there are some Link Monster Cards that can complete an Extra Link without placing Link Monster Cards in all three Main Monster Zones Z2B, Z2C, Z2D. In the example in FIG. 9, for example, when a Link Monster with the lower rightward Link Arrow M31D in the changed color (that is, a Link Monster pointing the lower right direction) is placed in the Extra Monster Zone Z1A, and a Link Monster with the upper leftward Link Arrow M31H and the rightward Link Arrow M31C both in the changed color (that is, a Link Monster pointing the upper left direction and the right direction) is placed in the Main Monster Zone Z2C, an Extra Link is completed without a Link Monster placed in the Main Monster Zone Z2B. Alternatively, in the example in FIG. 9, for example, when a Link Monster with the lower rightward Link Arrow M31D in the changed color (that is a Link Monster pointing the lower right direction) is placed in the Extra Monster Zone Z1A, a Link Monster with the upper leftward Link Arrow M31H and the upper rightward Link Arrow M31B both in the changed color (that is, a Link Monster pointing the upper left and upper right respective directions) is placed in the Main Monster Zone Z2C, and a Link Monster with the lower leftward Link Arrow M31F in the changed color (that is, a Link Monster pointing the lower left direction) is placed in the Extra Monster Zone Z1B, an Extra Link can complete without Link Monsters placed in the Main Monster Zones Z2B, Z2D.

[2-2-3-2]

Spell Cards are cards having an effect to support a match, and there are six types of Spell Cards, namely, Normal Spell Cards, Quick-Play Spell Cards, Continuous Spell Cards, Field Spell Cards, Equip Spell Cards, and Ritual Spell Cards.

The first user can display details of a Spell Card on the Duel Field For in the hand in the card detail image G2 by applying a predetermined operation with the operation unit 14 during a game. However, the first user cannot display a card detail image G2 of a Spell Card of the second user placed, if any, in a face-down Position on the Duel Field F. The following describes the details of the respective Spell Cards with reference to the card detail images thereof.

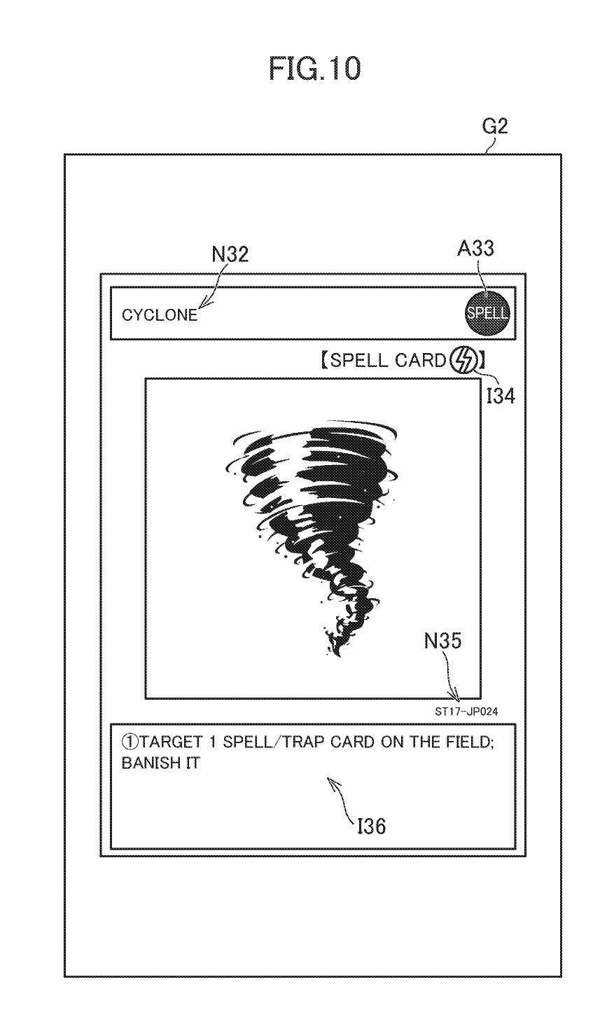

FIG. 10 illustrates the card detail image G2 of a Spell Card. Specifically, FIG. 10 illustrates the card detail image G2 of a Quick-Play Spell Card. The layouts of the card detail images G2 of Normal Spell Cards, Continuous Spell Cards, Field Spell Cards, Equip Spell Cards, and Ritual Spell Cards are similar to that of Normal Spell Cards, and thus not illustrated here.

Normal Spell Cards are cards that are each usable only during the Main Phase of the user holding the Normal Spell Card, and once used, are moved to the Graveyard. Normal Spell Cards have a Speed Spell 1. Details of the Main Phase and the Speed Spell will be described later.

The card detail image G2 illustrated in FIG. 10 has an illustration painted thereon that represents the content of a spell, and also has a Card Name N32, a Card Type A33, an Effect Icon I34, a Card Number N35, and Effect Description I36 written thereon.

The Card Name N32 is the name of a Spell Card. The Card Type A33 is indicated with an icon identifying either a Spell Card or a Trap Card. The Effect Icon I34 is an icon indicating the type of an effect. For example, although no icon is shown for a Normal Spell of Normal Spell Cards, a Quick-Play Spell of Quick-Play Spell Cards, a Continuous Spell of Continuous Spell Cards, a Continuous Spell of Field Spell Cards, an Equip Spell of Equip Spell Cards, and a Ritual Spell of Ritual Spell Cards are represented by respective icons for identification. For example, the Spell Card “Cyclone” illustrated in FIG. 10 has an Effect Icon I34 representing a Quick-Play spell. The Card Number N35 is information for uniquely identifying the card. The Effect Description I36 includes a description of an activation condition and an effect of the Spell Card.

Quick-Play Spell Cards are cards that can basically activate an effect all the time. Quick-Play Spell Cards are special Spell Cards that can activate an effect even during the opponent's turn. Each Quick-Play Spell Card cannot activate an effect during the turn in which the Quick-Play Spell Card has been placed in the Spell & Trap Zone Z3. Activation of an effect of a Quick-Play Spell Card during the opponent's turn requires pre-placement of the Quick-Play Spell Cardin a face-down position to be described later in the Spell & Trap Zone Z3. Quick-Play Spell Cards have a Speed Spell 2.

Continuous Spell Cards are cards that each can be used only in the Main Phase of the user holding the Continuous Spell Card. Continuous Spell Cards remain in the Spell & Trap Zone after activation of an effect so that the effect remains continuously activated. Continuous Spell Cards have a Speed Spell 1.

Field Spell Cards are cards that activate an effect similar to that of Continuous Spell Cards, and can be placed only in the Field Zone Z6. Field Spell Cards remain in the Field Zone Z6 after activation of an effect. In exchange of moving a Field Spell Card from the Field Zone Z6 to the Graveyard, a new Field Spell Card can be placed in the Field Zone Z6. Field Spell Cards have a Speed Spell 1.

Equip Spell Cards impart an effect to one monster, and remain in the Spell & Trap Zone Z3 after activation of the effect so that the effect remains continuously activated. Equip Spell Cards have a Speed Spell 1.

Ritual Spell Cards are Spell Cards to summon Ritual Monsters. A Ritual Spell Card having been used is moved to the Graveyard Z4. Ritual Spell Cards have a Speed Spell 1.

[2-2-3-3]

Trap Cards are cards having an effect to support a match. Trap Cards are similar to Spell Cards but different in that Trap Cards can activate an effect during the opponent's turn. Thus, basically, each Trap Card cannot be activated during the turn in which the Trap Card has been placed in the Spell & Trap Zone Z3, and becomes available for activation in the next turn and thereafter. Each Trap Card can be activated during either the first user's turn or the second user's turn after the turn in which the Trap Card has been placed. There are three kinds of Trap Cards, namely, Normal Trap Cards, Continuous Trap Cards, and Counter-Trap Cards.

The first user can display details of a Trap Card on the Duel Field F or in the hand in the card detail image G2 by applying a predetermined operation with the operation unit 14 during the game. However, the first user cannot display the card detail image G2 of a Trap Card of the second user placed, if any, in a face-down Position on the Duel Field F. The below describes details of the respective Trap Cards with reference to the card detail images.

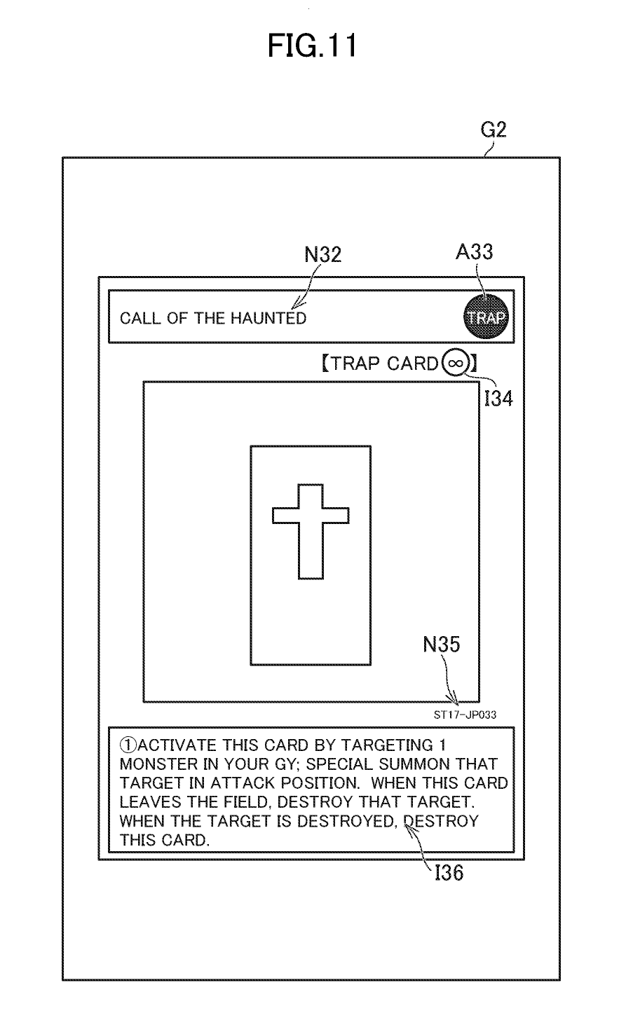

FIG. 11 illustrates the card detail image G2 of a Trap Card. Specifically, FIG. 11 illustrates the card detail image G2 of a Continuous Trap Card. The layouts of the card detail image G2 of Normal Trap Cards and of Counter-Trap Cards are similar to that of Normal Spell Cards, and thus not illustrated here. As illustrated in FIG. 11, a Trap Card has an illustration painted thereon that represents the content of a trap, and has basically the same layout as that of a Spell Card. That is, each Trap Card has the Card Name N32, the Card Type A33, the Effect Icon I34, the Card Number N35, and the Effect Description I36 written thereon.

Normal Trap Cards are Trap Cards having a single-use effect, and will be moved to the Graveyard after activation, similar to Normal Spell Cards. Normal Trap Cards have a Speed Spell 2.

Continuous Trap Cards remain in the Spell & Trap Zone Z3 so that the effect remains continuously activated, similar to Continuous Spell Cards. Continuous Trap Cards have a Speed Spell 2.

Counter-Trap Cards are cards to be activated basically upon activation of other cards, and have an effect that negates activation itself of a card, for example. Counter-Trap Cards have a Speed Spell 3.

[2-3]

The following describes summoning of monsters. Summoning a Monster means placing a Monster Card in a position that fulfills a condition to thereby play a Monster onto a game. That is, “summoning a Monster” means placing a Monster Card in a position that fulfills a condition to thereby have the Monster ready to battle (an attack against the opponent, for example). Below, before explanation of summons, a battle position of a card (a display position) will be described. In this embodiment, there are a plurality of battle positions available so that the first user and the second user can select any battle position when placing a Monster Card on the Duel Field F.

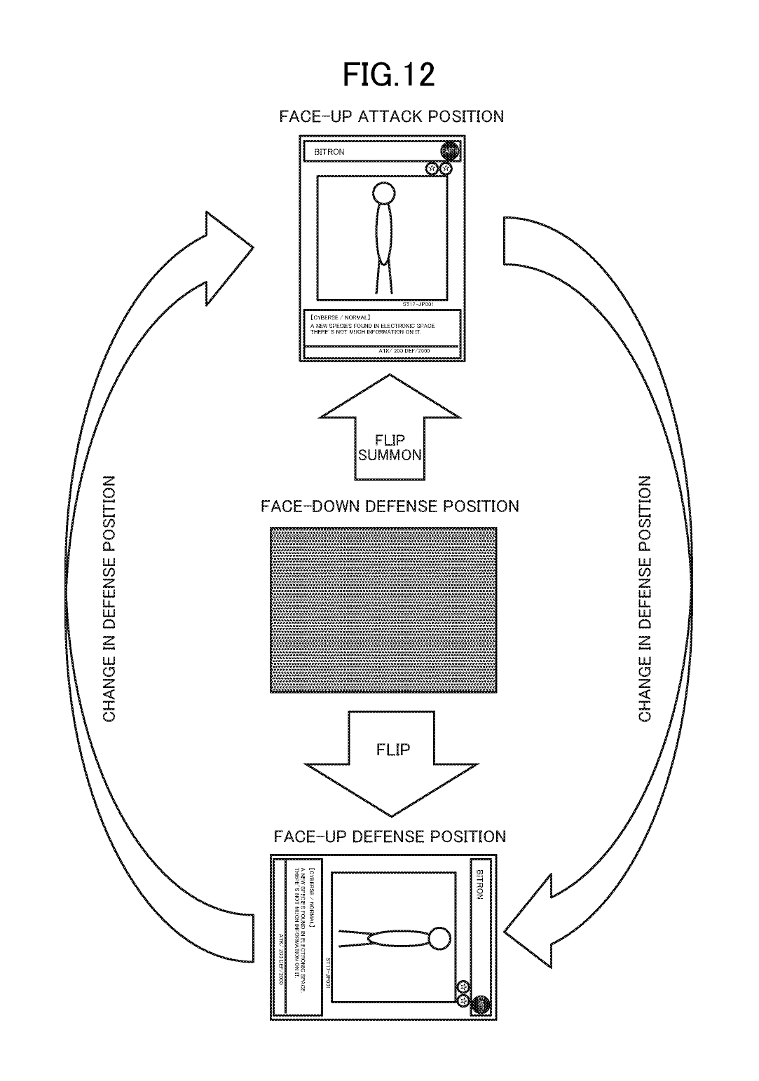

FIG. 12 illustrates battle positions of Monster Cards. As illustrated in FIG. 12, there are three ways to place a Monster Card, namely, face-up Attack Position, face-down Defense Position, and face-up Defense Position. Face-up Attack Position refers to upright face-up placement of a Monster Card, which enables a battle based on the attack points of the Monster Card. Face-down Defense Position refers to sideway face-down placement of a Monster Card, which enables a battle based on the defense points of the Monster Card. Face-up Defense Position refers to sideway face-up placement of a Monster Card, which enables a battle based on the defense points of the Monster Card.

In placing a Monster Card to summon a Monster, the first user or the second user can select either face-up Attack Position or face-down Defense Position, but not face-up Defense Position. Exceptionally, the user can select either face-up Attack Position or face-up Defense Position when summoning an Extra Monster. The first user or the second user can execute a Flip Summon to flip a Monster Card in face-down Defense Position into face-up Attack Position, although a Flip Summon cannot flip a Monster Card in face-down Defense Position into face-up Defense Position. A Monster Card in face-down Defense Position is flipped into face-up Defense Position when attacked by the opponent or upon activation of a specific Spell Card. The battle position is changeable between face-up Attack Position and face-up Defense Position.

There are two ways to place Spell Cards and Trap Cards, namely, face-up Position and face-down Position. Face-up Position corresponds to upright face-up placement of a Spell Card or a Trap Card, in which an effect is activated. Meanwhile, face-down Position corresponds to upright face-down placement of a Spell Card or a Trap Card, in which an effect is yet to be activated. When a Spell Card or a Trap Card is in face-down Position, the card needs to be flipped into face-up Position to activate an effect. Sideway placement is not allowed to Spell Cards and Trap Cards. Face-down placement of cards, which may be typically referred to as “set”, is referred to as face-down Position or face-down Defense Position in this embodiment.

There are two types of summons, namely, Normal Summons and Special Summons. Normal Summons are allowed once per turn. Special Summons are allowed at any number of times without limitation unless otherwise stated on the card.

A Normal Summon is a way to place a Monster Card from a hand in the Main Monster Zone Z2. Monsters at Level 4 or less can be summoned without any exchange. Monsters at Level 5 or 6 can be summoned in exchange for one monster already summoned and placed on the Duel Field F. “In exchange for a monster” means to send a monster already summoned (that is a Monster Card placed on the Duel Field F) to the Graveyard Z4, and will be referred to as “Tribute”. Monsters at Level 7 or greater require Tribute of two monsters already summoned and placed on the Duel Field F. A Normal Summon that requires Tribute of one or more monsters (that is, Normal Summoning a monster at Level 5 or greater) will be referred to as a Tribute Summon.

In Normal Summoning, a Monster Card can be placed in face-up Attack Position or face-down Defense Position. Note that in placing a Monster Card of a Level 5 or greater monster in face-down Defense Position as well, Tribute of one or more monsters is needed as this placement is achieved by a Tribute Summon.

Special Summons are summons other than Normal Summons, and Ritual Summons, Fusion Summons, Contact Fusions, Synchro Summons, Xyz Summons, Pendulum Summons, and Link Summons, for example, are examples of “Special Summons”. In Special Summoning, either face-up Attack Position or face-up Defense Position can be selected, although only face-up Attack Position is allowed in Link Summons as Link Monsters have no Defense Points. As only face-up Attack Position is allowed to Link Monsters, neither a Monster Effect nor an effect of a Spell Card or a Trap Card can change the Battle Position of Link Monsters.

A Ritual Summon is a way to Special Summon a Ritual Monster. A Ritual Summon can be conducted by placing a Ritual Spell Card in the Spell & Trap Zone Z3 to have the Ritual Spell Card to activate an effect, and then Tributing a monster, based on the Summoning Condition written in the Card Description 127 of the Ritual Spell Card. A Ritual Summon does not need a specific monster as a material, but requires Tribute that fulfills a Summoning Condition that “the sum of the levels is eight or greater” or that a card is sent from a hand to the Graveyard Z4. A Ritual Spell Card used for Ritual Summoning is moved to the Graveyard.

A Fusion Summon is a way to Special Summon a Fusion Monster. A Fusion Summon can be conducted by placing a Fusion Card, or a Normal Spell Card, in the Spell & Trap Zone Z3 to have the Fusion Card to activate an effect and then Tributing a monster that makes a material written in the Card Description I27 of the Fusion Card. A monster that makes a material is not necessarily summoned in advance, and the Monster of a Monster Card in a hand can be used as a material. A Fusion Card used for Fusion Summoning is moved to the Graveyard.

A Contact Fusion is a way to Special Summon a Fusion Monster according to a Special Summon method different from a Fusion Summon. A Contact Fusion can be conducted by returning a specific Normal Monster Card and a Monster Card as a material back to the Bank in the Main Deck Zone Z5. A Fusion Monster summoned by a Contact Fusion is returned to the Bank in the Extra Deck Zone Z7 during the End Phase of the turn in which the Fusion Monster has been summoned. Details of the End Phase will be described later.

A Synchro Summon is a way to Special Summon a Synchro Monster. A Synchro Summon can be conducted by Tributing a specific monster named “Tuner” and other monster or monsters when the sum of the Levels of “Tuner” and the other monster or monsters is equal to the Level of a Synchro Monster. In this embodiment, a Dark Synchro Summon is available as one type of the Synchro Summon. A Dark Synchro Summon can be executed by Tributing a specific Monster named “Dark Tuner” and other monster or monsters when the difference in level between the Dark Tuner and the other monster or monsters is equal to the Level of a Synchro Monster.

An Xyz Summon is a way to Special Summon an Xyz Monster. An Xyz Summon can be conducted by stacking an Xyz Monster Card and a Monster Card of a monster at the same level as the rank of the Xyz Monster. An Xyz Summon is achieved using a monster as a material written in the Card Description I27 of an Xyz Monster Card. An Xyz Summon does not need a specific monster as a material, but needs to fulfill the Summoning Condition, such as, “2 or more Level 4 monsters”. The monster as a material is not Tributed but placed beneath the Xyz Monster, and activates various effects when being sent to the Graveyard Z4.

A Pendulum Summon is a way to Special Summon monsters other than Pendulum Monsters, using a Pendulum Monster. A Pendulum Summon can be conducted by placing a Pendulum Monster Card in the Pendulum Zone Z3. A Pendulum Monster Card is drawn from the hand and placed in the Pendulum Zone Z3, similar to Field Spell Cards and Continuous Spell Cards. In a Pendulum Summon, a user can Special Summon, once per turn, as many monsters as the user wants at the levels between the Pendulum Scales indicated by the Pendulum Monster Cards placed on the left and right respective sides.

Assume here, for example, that the smaller one of the Pendulum Scales indicated by the two Pendulum Monster Cards placed on the left and right respective sides is defined as a first value, while the larger one is defined as a second value. In the above, Pendulum Summoning can Special Summon a monster whose level is greater than the first value and less than the second value. When the Pendulum Scales of the two Pendulum Monster Cards placed on the left and right respective sides are the same or different by one, a Pendulum Summon is not applicable as there is no numeric value between the Pendulum Scales.

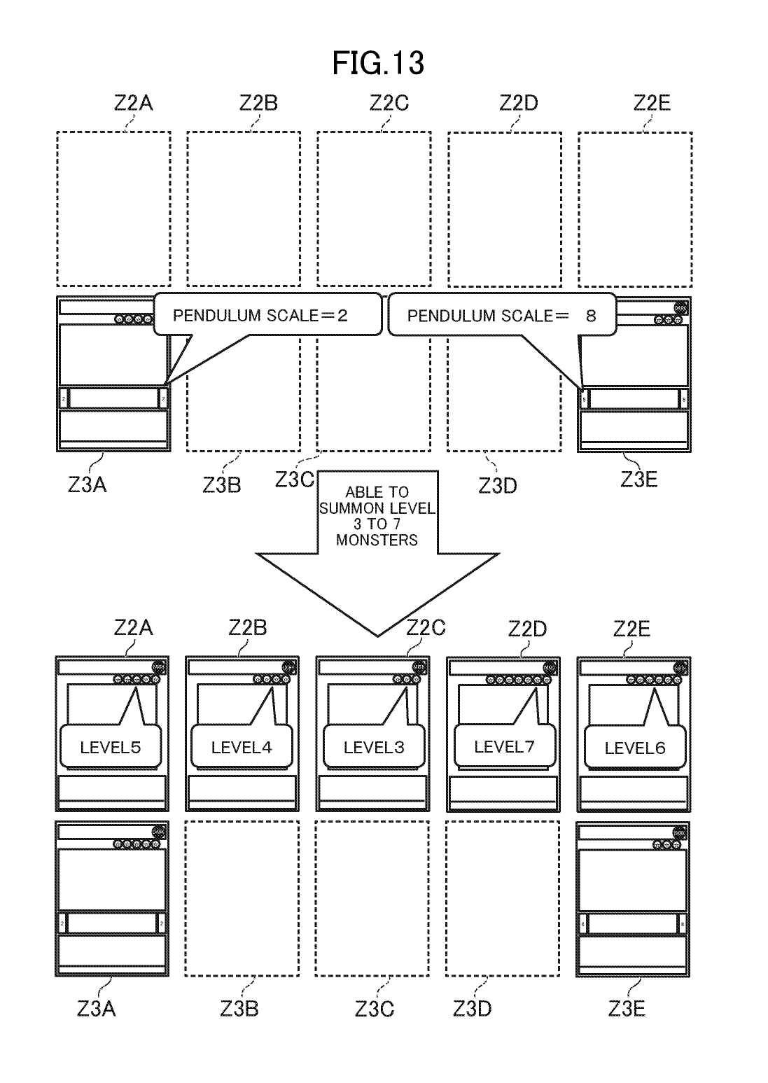

FIG. 13 illustrates a case in which a Pendulum Summon is conducted. In the example in FIG. 13, a Pendulum Monster Card with the Pendulum Scale 2 is placed in the left Pendulum Zone Z3A, while one with the Pendulum Scale 8 is placed in the right Pendulum Zone Z3E. In this case, it is possible to Pendulum Summon a monster whose level is in between Levels 3 to 7 inclusive, or the levels between Level 2 and Level 8. In the example in FIG. 13, monsters at levels 3 to 7 are Pendulum Summoned one for each level. Two or more monsters at the same Level can be Pendulum Summoned. In the example illustrated in FIG. 13, for example, two Level 4 monsters, two Level 5 monsters, and one Level 7 monster can be summoned.

When the first user or the second user wants to Special Summon a Pendulum Monster from their hand, the user draws a Pendulum Monster card from the hand and places in the Main Monster Zone Z2. Meanwhile, when the first user or the second user wants to Special Summon a Pendulum Monster from the Bank in their Extra Deck Zone Z7, the user draws a Pendulum Monster Card from the Bank and places in the Extra Monster Zone Z1. That is, a Pendulum Monster Card having been moved to the Bank in the Extra Deck Zone Z7 will be treated same as an Extra Monster Card. Note that in the case where a proper Extra Monster is summoned, sent to the Graveyard Z4, and then Special Summoned from the Graveyard Z4, the Extra Monster Card is placed in the Main Monster Zone Z2.

A Link Summon is a way to Special Summon a Link Monster. A Link Summon is conducted by Tributing a monster as a material based on the Summoning Condition written in the Card Description I27 of the Link Monster Card. A material for a Link Summon is not necessarily a specific monster, and may be any monster that fulfills the Summoning Condition. A Summoning Condition may be a condition such as, for example, “2 or more Effect Monsters, equal to the number of numeric value of the Link of the Link Monster Card”.

In using a summoned Link Monster as a material for a Link Summon, the numeric value of the Link of the Link Monster as a material is considered as the number of monsters as a material. Thus, in using a Link Monster with the Link of 2, the Link Monster is counted as a material for two monsters.

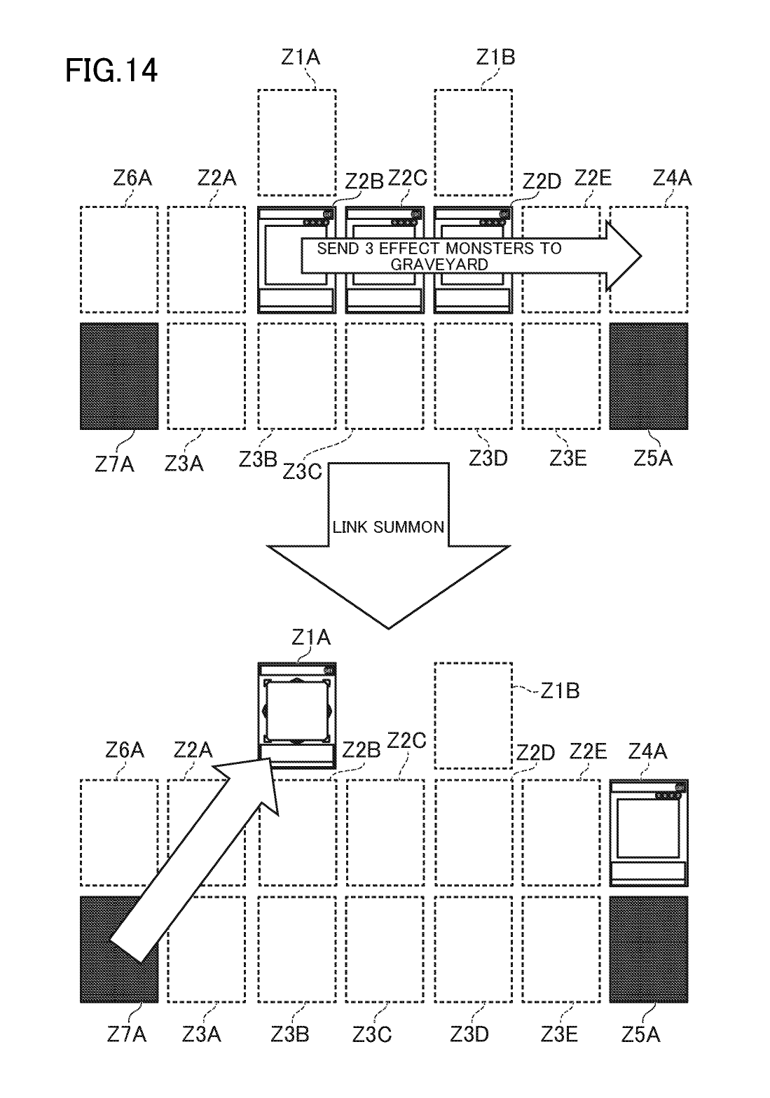

FIG. 14 illustrates a case in which a Link Summon is conducted. In this example described here, the numeric value of the Link of a Link Monster Card is three and the Summoning Condition is “2 or more Effect Monsters, equal to the numeric value of the Link of the Link Monster Card”. In the case where three Effect Monsters have been Normal Summoned, for example, as illustrated in FIG. 14, which fulfills the above described Summoning Condition, it is possible to conduct a Link Summon by using a Link Monster Card having the above described Summoning Condition written thereon.

In the example in FIG. 14, a target Link Monster Card is drawn from the Bank in the Extra Deck Zone Z7A and placed in the Extra Monster Zone Z1A in exchange for Tributing three Effect Monsters. This completes a Link Summon. If both Extra Monster Zones Z1A, Z1B are vacant in the above, a Link Monster Card can be placed in either one of these zones which the user likes.

[2-4]

The following describes a flow of the card game. As described above, the card game is played by turn, and a first user's turn and a second user's turn are alternatively and repetitively executed during a match. Each turn includes a plurality of phases that distinctly separate the procedure in the turn.

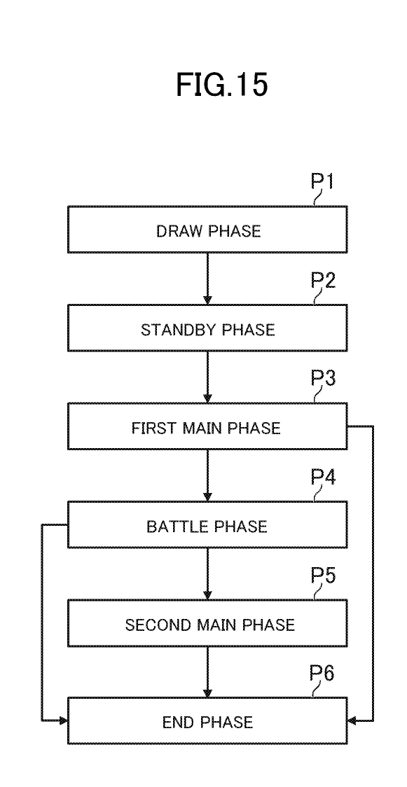

FIG. 15 is a flowchart of phases in each turn. As illustrated in FIG. 15, there are six types of phases, namely, a Draw Phase P1, a Standby Phase P2, a first Main Phase P3, a Battle Phase P4, a second Main Phase P5, and an End Phase P6. At the start of a match, a display effect in which a user to go first and a user to go second are decided between the first user and the second user, and the first user and the second user each draw five cards from their bank in their Main Deck Zone Z5 is presented. Thereafter, the hands C1, C2 are displayed in the game image G1 to start a game, beginning with a turn of the user to go first.

In the first turn after the start of the match, the Draw Phase P1, the Battle Phase P4, and the second Main Phase P5 are omitted. That is, after the start of a match, the match proceeds, beginning with the Standby Phase P2 of the user to go first, the first Main Phase P3 of the user to go first, the End Phase P6 of the user to go first, the Draw Phase P1 of the user to go second, the Standby Phase P2 of the user to go second, the first Main Phase P3 of the user to go second, the Battle Phase P4 of the user to go second, the second Main Phase P5 of the user to go second, the End Phase P6 of the user to go second, and the Draw Phase P1 of the user to go first, and so on. The number of turns is counted, like the first turn, the second turn, the third turn, and so on, for every end of a turn of each of the first user and the second user, and displayed in the Turn T in the game image G1.

[2-4-1]

The Draw Phase P1 is the initial phase of each turn. Of the first user and the second user, a user advancing the turn will be hereinafter referred to as a turn user, and a user not advancing the turn is referred to as an opponent user. In the first user's turn, the turn user is the first user and the opponent user is the second user. In the second user's turn, the turn user is the second user and the opponent user is the first user.

In the Draw Phase P1, a display effect in which the turn user draws one card from the top of the Bank in their Main Deck Zone Z5A, and adds to their hand is presented. When the turn user is left with no card in the Bank in the Main Deck Zone Z5A and thus unable to draw a card, the turn user loses, as described above. During the period after presentation of the display effect in which the turn user draws a card from the Bank in the Draw Phase P1 before the start of the Standby Phase P2, the Quick Effect of a Monster Card having a Quick Effect or an effect of a Quick-Play Spell Card, a Normal Trap Card, a Continuous Trap Card, or a Counter-Trap Card can be activated. Activation of the Quick Effect of a Monster Card having a Quick Effect or the effect of a Quick-Play Spell Card, a Normal Trap Card, a Continuous Trap Card, or a Counter-Trap Card at this stage will be hereinafter referred to as a Quick Effect.

[2-4-2]

In the Standby Phase P2, an effect of a card having an effect “during Standby Phase P2” and placed, if any, in the Duel Field F, is resolved. Basically, this effect can be activated only once in the Standby Phase P2. For example, an effect of “pay 300 Life Points during Standby Phase in your turn to select one card other than the Monster Cards in your Graveyard and put it at the bottom of your Bank” is activated in the Standby Phase P2. Alternatively, for example, an effect of “pay 500 Life Points during each of your opponent's Standby phases, and you can see one card at random in your opponent's hand” is activated in the Standby Phase P2.

[2-4-3]

The first Main Phase P3 is a phase during which the turn user can most freely use cards and summon monsters (place Monster Cards), change the battle positions of Monster Cards, activate an effect of each card, place Spell Cards or Trap Cards in a face-down Position, and so forth. The turn user can execute these actions in any order they like, though some actions is limited in the number of times of execution.

For example, when the turn user wants to summon a monster in the first Main Phase P3, the turn user can activate a Flip Summon and a Special Summon as many times as they want during one turn, but can activate either one of a Normal Summon into face-up Attack Position and a Normal Summon into face-down Defense Position only once per turn, in which the Normal Summon here includes the Tribute Summon described above. The limit number of times of activation of Normal Summons is set so as to include the number of times of activation during the second Main Phase P5 to be described later. That is, in the case where the turn user has activated a Normal Summon in the first Main Phase, as the limit number of times of activation of Normal Summons is already reached, the turn user can no longer activate a Normal Summon during the second Main Phase P5 in the same turn.

When the turn user wants to change the battle position of a Monster Card during the first Main Phase P3, the turn user can change the position only once per each Monster Card on the Duel Field F. That is, the turn user cannot change the battle position of the same Monster Card more than twice during the same turn. Further, the turn user cannot change the battle position of the Monster Card of a monster having been summoned in the first Main Phase P3, during the first Main Phase P3 in the same turn. Still further, the turn user cannot change the battle position of the Monster Card of a monster that has attacked in the Battle Phase P4, during the second main phase P5, even though the battle position of the Monster Card has not been changed in the first Main Phase P3.

When the turn user wants to activate an effect of a card in the first Main Phase P3, the turn user can activate the effect as many times as the hand and the cost permit. When the turn user wants to place a Spell Card or a Trap Cardin a face-down Position in the first Main Phase P3, the turn user can set up to five cards including a Spell Card and a Trap Card already placed, except in the Field Zone Z6.

[2-4-4]

The Battle Phase P4 is a phase for a battle using Monster Cards on the Duel Field F. The Battle Phase P4 is divided into a plurality of steps, and proceeds according to a predetermined procedure. The Battle Phase P4 is not mandatory and can be omitted. That is, even though a Monster Card is placed on the Duel Field F, the turn user can decide to shift to the End Phase P6, omitting the Battle Phase P4.

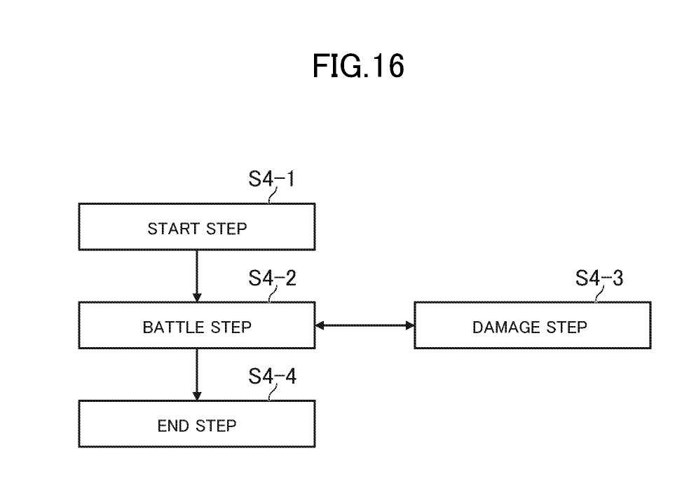

FIG. 16 is a flowchart of the Battle Phase P4. As illustrated in FIG. 16, the Battle Phase P4 includes a Start Step S4-1, a Battle Step S4-2, a Damage Step S4-3, and an End Step S4-4. The Battle Step S4-2 and the Damage Step S4-3 can be repetitively conducted as many time as possible.

The Start Step S4-1 is a step at which entry to the Battle Phase P4 is declared. To enter the Battle Phase P4, a display effect showing the turn user declaring “I'm entering the Battle Phase P4” is shown in the game image G1. The Battle Phase P4 is omitted during the first turn, as described above, but is executed in the second and thereafter turns.

The Battle Step S4-2 is a step at which the turn user selects one monster from among their Monster Cards in face-up Attack Position to attack with and one of the opponent's monsters as an attack target. In this case, a display effect showing the turn user declaring an attack is shown in the game image G1. Basically, each monster can attack once. After the display effect for declaration of an attack, the procedure proceeds to the Damage Step S4-3. After the end of the Damage Step S4-3, the procedure returns to the Battle Step S4-2 to repeat the above-described sequence as many times as possible.

The Damage Step S4-3 is a step for damage calculation to see the result of the battle. After the end of the Damage Step S4-3, the procedure returns to the Battle Step S4-2. The Damage Step S4-3 proceeds through five timings.

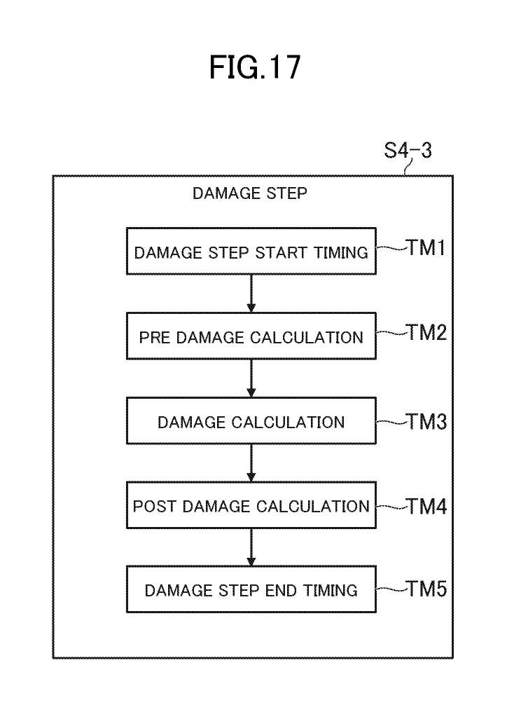

FIG. 17 indicates five timings in the Damage Step S4-3. The Damage Step S4-3 in FIG. 17 includes, in time series, Damage Step Start Timing TM1, Pre Damage Calculation Timing TM2, Damage Calculation Timing TM3, Post Damage Calculation Timing TM4, and Damage Step End Timing TM5.

The Damage Step Start Timing TM1 starts the Damage Step S4-3. In attacking a Monster of a Monster Card in face-down Defense Position, the Monster Card is yet to be flipped into face-up Defense Position at this timing. At the Damage Step Start Timing TM1, an effect of a card having the phrase “at Damage Step S4-3” or “without damage calculation” written thereon and an effect that changes the attack points and defense points of a monster are activated.

The Pre Damage Calculation Timing TM2 is a timing at which a Monster Card in face-down Defense Position is flipped into face-up Attack Position or face-up Defense Position. The effect of a Monster Card including the phrase “when this Monster Card is flipped” written thereon is not resolved here, but will be resolved at the Post Damage Calculation Timing TM4 to be described later. After a Monster Card in face-down Defense Position is flipped, the effect of a card having the phrase “at Damage Step S4-3” or “Pre Damage Calculation Timing TM2” written thereon and an effect that changes the attack points and the defense points of a monster are activated.

The Damage Calculation Timing TM3 is a timing for damage calculation. At the Damage Calculation Timing TM3, decrease in Life Points due to battle and destroy of a monster are confirmed. A monster that is confirmed as having been destroyed in a battle is not sent to the Graveyard at this timing, but will be sent to the Graveyard at the Damage Step End Timing TM5 to be described later. At the Damage Calculation Timing TM3, an effect of a card having the phrase “at Damage Calculation Timing TM3” and an effect of a Counter-Trap Card are activated.

In damage calculation at the Damage Calculation Timing TM3, a different calculation method is used depending on the battle position of the Monster Card of a Monster as an attack target. Assume here that a monster that attacks is referred to as an attacking monster, and a monster as an attack target is referred to as an opponent monster.

In the case of the Monster Card of an opponent monster in face-up Attack Position, victory or defeat and damage are calculated based on the attack points of the attacking monster and the attack points of the opponent monster. For example, when the attack points of the attacking monster are higher than the attack points of the opponent monster, the opponent monster is destroyed, and the amount by which the attack points of the attacking monster exceed those of the opponent monster makes a damage to the opponent user. For example, when the attack points of the attacking monster are equal to the attack points of the opponent monster, the monsters are both destroyed. In this case, neither the turn user nor the opponent user is damaged. For example, when the attack points of the attacking monster are lower than the attack points of the opponent monster, the attacking monster is destroyed, and the amount by which the attack points of the opponent monster exceed those of the attacking monster makes a damage to the turn user.

In the case of the Monster Card of the opponent monster in face-up Defense Position or face-down Defense Position, victory or defeat and damage are calculated based on the attack points of the attacking monster and the defense points of the opponent monster. A monster in face-down Defense Position is flipped into face-up Defense Position before damage determination. For example, when the attack points of the attacking monster are higher than the defense points of the opponent monster, the opponent monster is destroyed. In this case, neither the turn user nor the opponent user is damaged. For example, when the attack points of the attacking monster are equal to the defense points of the opponent monster, neither monster is destroyed, and both monsters remain. In this case, neither the turn user nor the opponent user is damaged. For example, when the attack points of the attacking monster are lower than the defense points of the opponent monster, neither monster is destroyed, and both monsters remain. In this case, the amount by which the defense points of the opponent monster exceed the attack points of the attacking monster makes a damage to the turn user.

When there are no monsters, the attacking monster can directly attack the opponent user. In a direct attack, the full attack points of the attacking monster make a damage to the opponent user.

The Post Damage Calculation Timing TM4 is a timing at which an effect that is activated upon execution of a battle is resolved. When a Monster Card placed in face-down Defense Position at the Pre Damage Calculation Timing TM2 is flipped, the effect of the Monster Card including the phrase “when this card is flipped” is resolved. At the Post Damage Calculation Timing TM4, an effect of a card having the phrase “when a battle damage is caused”, “when damaged in a battle”, “Post Damage Calculation Timing TM4”, or “when a battle is executed” is activated, based on a chain to be described later. As to the effects of other cards, basically, effects other than those of Counter-Trap Cards are not activated.

The Damage Step End Timing TM5 is a timing at which a monster confirmed as having been destroyed in a battle is sent to the

Graveyard to thereby end the Damage Step S4-3. At the Damage Step End Timing TM5, the effect of a card having the phrase “when this card is destroyed in a battle and sent to the Graveyard”, or the like, is activated based on a chain to be described later. As to the effects of other cards, basically, effects other than those of Counter-Trap Cards are not activated.

At the timings other than the Pre Damage Calculation Timing TM2 among the five timings in the Damage Step S4-3, a chain to be described later can be created only once. For example, even if there are two Effect Monsters having an effect of, such as, “when an opponent monster attacks, you can discard this card from the hand and activate at the Damage Calculation Timing. The damage caused to you in the battle is negated”, when an effect of such an Effect Monster is negated by the effect of, such as, “you discard one card to activate. Activation of the effect of an Effect Monster is negated and destroyed” of a Counter-Trap Card, the effect of the second Effect Monster is not activated.

The End Step S4-4 is a step to be executed after repetition of the Battle Step S4-2 and the Damage Step S4-3 until no monster as an attack target is left. In this case, a display effect showing the turn user announcing that “I finish the Battle Phase P4” is shown in the game image G1. This ends the Battle Phase P4.

[2-4-5]

The second Main Phase P5 is executed only when the Battle Phase P4 is executed. Actions which the turn user can perform during the second Main Phase P5 are basically the same as those during the first Main Phase P3. That it, summoning monsters (placing Monster Cards), changing the battle positions of Monster Cards, activating the effect of each card, and placing Spell Cards or Trap Cards in a face-down position, or the like, can be executed in the second Main Phase P5.

However, in the case where the turn user has already executed an action subjected to limit on the number of times of execution in the first Main Phase P3, the turn user can no longer execute the action in the second Main Phase P5. For example, as Normal Summoning a monster is allowed once per turn, in the case where the turn user has already executed a Normal Summon in the first Main Phase P3, the turn user can no longer execute a Normal Summon in the second Main Phase P5. It is during the second Main Phase P5 that Synchro Summons, Xyz Summons, and Pendulum Summons can be executed.

[2-4-6]

The End Phase P6 ends the turn. In the End Phase P6, a display effect showing the turn user declaring the end of the turn is shown in the game image G1. If the turn user has more than six cards in their hand, the turn user discards their card until the turn user has six cards in their hand.

[2-5]

The following describes Priority. In the above described respective phases or steps, the turn user advancing the turn always has the right to first activate a card. This right will be hereinafter referred to as the turn user's Priority. As long as the turn user has the Priority, the opponent user cannot first activate a card, except Trigger Effects that are automatically activated. The Priority will automatically pass to the opponent user when the turn user has activated a card, using the Priority, or when the turn user has given up the Priority. The turn user must give up the Priority when advancing the phase or step. The Priority passes to the opponent user when the turn user has activated a card and then ended the step or the turn. When the opponent user destroys the Priority, the step or turn ends.

Actions which do not cause the turn user's Priority to pass to the opponent user are determined in advance. Such actions include, for example, the start of each phase or the turn user's declaration of the start of each phase, at the start of each step, at a timing with activation of a Quick Effect immediate thereafter allowed, when a monster is successfully summoned, when the turn user has “summoned a monster without creating a chain” and “summoned a monster for the chain 1”, when the battle position of a monster is changed, when an attack is declared, when a card is placed in a face-down Position, immediately after the end of processing, when the battle is drawn in the Draw Phase P1, and so forth.

[2-6]

The following describes card effect resolution. During a match, card effect activations are exchanged between users by the users activating a card effect in response to their opponent's activating a card effect. In response to effect activation, a chain to be described later is created, and the effects are serially resolved.

[2-6-1]

A chain is a method for smoothly resolving the effects of Spell Cards or Trap Cards, for example, activated by the users, and refers to an action of activating a card in response to activation of another card. Activation of a card in response to activation of another card will be hereinafter referred to as chain activation.

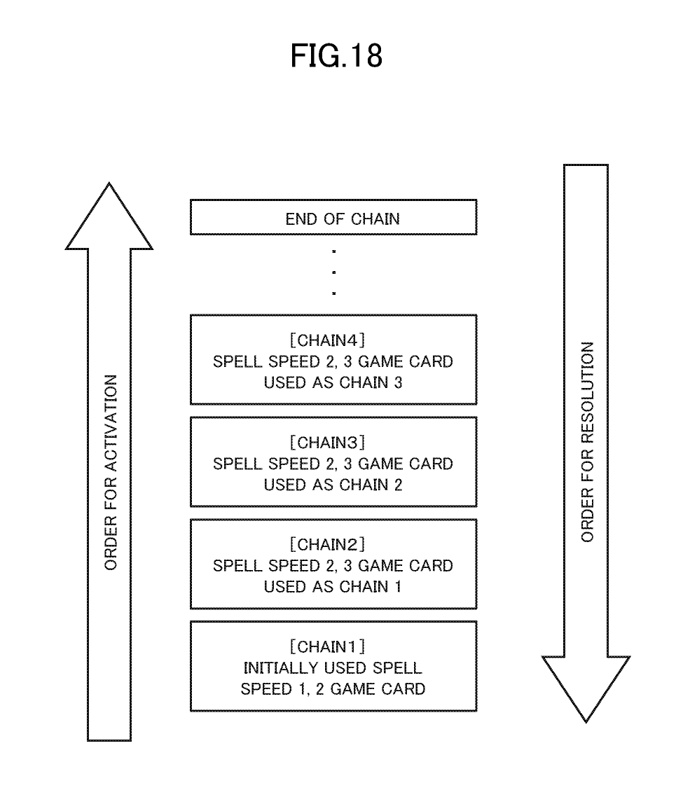

FIG. 18 illustrates a structure of a chain. As illustrated in FIG. 18, the card first activated is a chain 1, and every chain activation, cards activated to make chains are stacked up, like a chain 2, a chain 3, and so forth (a chain block). Once chain activation completes, effect resolution starts, beginning with the effect last activated. For example, when the chain 5 is the last activated chain, effect resolution is executed serially, starting with the chain 5, chain 4, chain 3, chain 2, and chain 1.

[2-6-2]

A Spell Speed is set to each of the effects of Spell Cards, Trap Cards, and Effect Monster Cards. There are three types of Spell Speeds, namely, Spell Speed 1, Spell Speed 2, and Spell Speed 3.

The Spell Speed 1 is the slowest of all Spell Speeds, and a card with Spell Speed 1 cannot be automatically activated to make a chain in response to any other activation. Thus, basically, a card with Spell Speed 1 does not make a Chain 2 or higher. Cards with Spell Speed 1 include Normal Spell Cards, Equip Spell Cards, Field Spell Cards, Ritual Spell Cards, Continuous Spell Cards, and Effect Monster Cards.

A card with Spell Speed 2 can be activated to make a chain in response to activation of a card with Spell Speed 1 or 2. That is, a card that can be activated in response to activation of a card with Spell Speed 1 or 2 is a card with Spell Speed 2. A card with Spell Speed 2 corresponds to a card that can be activated at any timing or during the opponent's turn.

Spell Speed 3 is the fastest of all Spell Speeds, and a card with Spell Speed 3 can be activated to make a chain in response to activation of a card with any Spell Speed. Only a card with Spell Speed 3 can respond to a card with Spell Speed 3. A card with Spell Speed 3 includes Counter-Trap Cards.

[2-6-3]

There are three kinds of effects of monsters, namely, an Ignition Effect, a Trigger Effect, and a Quick Effect.

An Ignition Effect is an effect that becomes usable upon declaration of activation. Basically, a user can activate an Ignition Effect only during the user's Main Phase. A user can activate an Ignition Effect only when the user has the Priority that allows activation of a card with Spell Speed 1 during the Main Phase in the user's turn. For example, even though the card says “once per turn”, it is not possible to activate an Ignition Effect during the opponent's turn.

A Trigger Effect is an effect that is activated at a timing determined by a Monster Card, such as “during the Standby Phase P2” or “when the Monster is destroyed”, for example. Although a Trigger Effect is readily predictable and responded in advance by the opponent, a user can devise to fulfill the activation condition of the effect through an effect of other cards or their playing skill to activate a Trigger Effect at their aimed timing.

A Quick Effect, allowed to be used only at a timing limited, is a special effect that can be desirably activated even during the opponent's turn. Only the Quick Effect has Spell Speed 2, although cards with a Quick Effect are Effect Monster Cards. Since it is difficult for the opponent to predict the presence of a card with a Quick Effect, similar to Trap Cards, cards with a Quick Effect can give unexpected effect to the opponent.

[2-6-4]

There are many cards or effects whose activation conditions include conditions of “is destroyed” or “is sent to the Graveyard”, and which are triggered to be activated by a specific action. Of these cards or effects, an optional effect whose activation condition includes “when” can be activated only at a timing immediately after fulfillment of the activation condition. Note that an optional effect is an effect of which card has the phrase “you can”, for example, written thereon, so that a user can select whether or not to activate the effect.

Some of such optional effects may not be allowed to be activated despite fulfillment of their activation conditions. Specifically, if any processing should be executed after fulfillment of the activation condition, that effect can no longer be activated thereafter. This is referred to as “missing the timing” in this embodiment.

The effects are categorized roughly into three types, namely, “Mandatory Effects”, “Optional Effects with ‘when’”, and “Optional Effects with ‘if’”. “Mandatory Effects” are effects of which cards include the phrase “take an action” written thereon, and which are always activated once the activation condition is fulfilled regardless of the first or second user's intention. “Optional Effects with ‘when’” are optional effects whose activation conditions include “when” mentioned above. “Optional Effects with ‘if’” are optional effects whose activation conditions include “if”.

In this embodiment, an effect of a card having the word “when” written thereon is discriminated from an effect of a card having the word “if” written thereon. The word “when” means that it is possible to use only immediately after its activation condition is fulfilled. That is, a situation can occur in which the effect of such a card cannot be used even though its activation condition is fulfilled if the fulfillment is resulted in the midway of any effect or chain processing. Meanwhile, “if” means that fulfillment of an activation condition makes the effect usable. That is, the word “if” means that the effect of such a card can be used as long as its activation condition is fulfilled even in the midway of any effect or chain processing, after the end of the processing. That is, an effect with “if” can be activated not only immediately after fulfillment of its activation condition but also later than that.

As described above, as “Mandatory Effects” are forcibly activated and “Optional Effects with ‘if’” are activated after completion of any effect or chain processing, these effects do not miss activation timing on principle. Meanwhile, “Optional Effects with ‘when’” are activated only immediately after their activation conditions are fulfilled, and thus can miss activation timing, depending on a situation.

[2-6-4-1]

The below first describes processing to be executed when a timing for an effect is not missed. Specifically, an Effect Monster named “Sacred Crane” with an effect of “If this card Special Summoned; the controller of this card takes an action of drawing 1 card” will be described as an example. The effect of the “Sacred Crane” is a Mandatory Effect of “take an action”, as described above.

For example, assume that the first user activates, as a chain 1, a Spell Card named “Cyclone” with a Quick-Play Spell of “Activate this card by targeting 1 Spell & Trap Card on the Field; destroy it”.

Then, assume that the second user activates, as a chain 2, a Trap Card named “Call of the Haunted” with a Continuous Trap of “Activate this card by targeting 1 monster in your Graveyard; Special Summon that target in Attack Position. When this card leaves the field, destroy that target. When that target is destroyed, destroy this card”, targeting “Sacred Crane” in the Graveyard.

With no card left which either the first user or the second user wants to activate to make a chain, effect resolution starts, as described above. The effect resolution starts with the latest one of the chains. Specifically, effect resolution for the chain 2 is executed, whereby “Sacred Crane” is Special Summoned by “Call of the Haunted”. At this stage, the activation condition of the effect of “Sacred Crane” is fulfilled.

Then, effect resolution for the chain 1 is executed. As “Cyclone” has an effect that destroys a card, as described above, the timing is changed to “when the card is destroyed”. After the second user destroys a Spell Card or a Trap Card by the effect of “Cyclone”, the effect resolution for a series of chains is finished. Immediately after the finish, the effect of “Sacred Crane” is forcibly activated, and the second user draws one card from the Bank in the Main Deck Zone Z5B. In this manner, “Sacred Crane”, having a Mandatory Effect, will not miss the timing to activate the effect.

Meanwhile, cases where timing to activate an effect can be missed are those of three patterns described below. A first pattern is a case in which an activation condition is fulfilled in the chain 2 or thereafter. A second pattern is a case in which an activation condition is fulfilled in the midway of processing by a series of effects. A third pattern is a case in which an activation condition is fulfilled as a result of a card being sent to the Graveyard as a cost, Tribute, or a material for Synchro Summon.

[2-6-4-2]

Initially, the first pattern will be described. An Effect Monster named “Yellow Gadget” having an effect of “when this card is Normal or Special Summoned; You can add 1 “Green Gadget” from your Deck to your hand” will be described as an example. The effect of “Yellow Gadget” is “an Optional Effect with ‘when’”.

For example, assume that the first user activates “Cyclone” as a chain 1, and the second user activates “Call of the Haunted”, as a chain 2, targeting “Yellow Gadget” in the Graveyard. With no card left which either the first user or the second user wants to activate to make a chain, effect resolution starts.

Initially, effect resolution for the chain 2 is executed, whereby “Yellow Gadget” is Special Summoned by “Call of the Haunted”. With the above, the activation timing of the effect of “Yellow Gadget” has come. However, the effect cannot be activated as it is in the midway of chain processing.

Thereafter, effect resolution for the chain 1 is executed, whereby the effect of “Cyclone” is activated. With the above, the timing is changed to “when the card is destroyed”. After the second user destroys a Spell Card or a Trap Card by the effect of “Cyclone”, the effect resolution for the series of chains is finished. In the above, the effect of “Yellow Gadget” is not activated as “Yellow Gadget” is “an Optional Effect with ‘when’”, and its activation timing has already gone by the end of the chain processing, different from the Mandatory Effect of “Sacred Crane”. Thus, the first user cannot add “Green Gadget” to their hand. This is the first pattern in which the timing for an effect is missed.

[2-6-4-3]

The second pattern will be described next. An Effect Monster named “Goblindbergh” with an effect of “When this card is Normal Summoned; You can Special Summon 1 Level 4 or lower monster from your hand, also, after that, change this card to Defense Position” will be described as an example. The effect of “Goblindbergh” is “an Optional Effect with ‘when’”.

For example, assume that the first user summons “Goblindbergh”, and that the effect is activated and effect resolution is executed. Assume that, in the above, “Green Gadget” is Special Summoned from the first user's hand through the effect resolution for “Goblindbergh”. “Green Gadget” is an Effect Monster having an effect of “when this card is Normal or Special Summoned: You can add 1 “Red Gadget” from your Deck to your hand”, or “an Optional Effect with ‘when’”.

Special Summoning “Green Gadget” fulfills the activation condition of the “Green Gadget”. “Goblindbergh” is flipped into face-up Defense Position by the effect of “Goblindbergh”, and the timing is changed to “when the monster is flipped into Defense Position”.

As described above, with completion of the series of processing for “Goblindbergh”, effect activation is now possible. However, an activation timing of the effect of “Green Gadget”, or “an Optional Effect with ‘when’”, has been missed due to interference by the processing by the series of effects of “Goblindbergh” immediately after fulfillment of the activation condition of “Green Gadget”. Note that processing by the series of effects can be discontinued halfway when subsequent processing is impossible. In such a case, a timing for activation will not be missed. This is the second pattern in which the timing for an effect is missed.

[2-6-4-4]

The third pattern will be described next. An Effect Monster named “Pinch Hopper” with an effect of “When this card on your field is sent to your Graveyard: You can Special Summon 1 Insect-Type Monster from your hand” will be described as an example. The Effect of “Pinch Hopper” is “an Optional Effect with ‘when’”.

For example, assume that the first user Tributes “Pinch Hopper”, for example, in order to conduct a Tribute Summon. In this case, “Pinch Hopper” is sent to the Graveyard, which fulfills its activation condition. Then, a monster is Tribute Summoned from the first user's hand, and the timing is changed to “when Tribute Summon is activated”. In the above, an effect of “Pinch Hopper”, or a “an Optional Effect with ‘when’”, misses the timing for activation due to interference by a Tribute Summon after the Tribute, though not due to processing for the chain. This is the third pattern in which the timing of an effect is missed.

Note here that, in this embodiment, placing a Spell Card from a hand in face-up Position in the Spell & Trap Zone Z3 or flipping a Spell Card or a Trap Card in a face-down Position in the Spell & Trap Zone Z3 into face-up Position is referred to as “activation of a card”. Meanwhile, an effect that is activated with a Continuous Spell Card or a Continuous Trap Card in face-up Position or when a Continuous Spell Card or a Continuous Trap Card are destroyed or sent to the Graveyard is referred to as “activation of an effect”. In this manner, card activation is discriminated from effect activation.

[2-7]

The above described card game has the characteristics described below.

[2-7-1]

The above described card game has a first structure that includes not only the first user Duel Field F1 and the second user Duel Field F2 but also the Extra Monster Zone Z1 as a common area in the Duel Field F. This improves the strategic characteristic of the card game.

[2-7-2]

The above described card game has a second structure that accepts, with a Link Monster Card associated with a Link Arrow M31 placed in the Extra Monster Zone Z1, placement of an Extra Monster Card in one of the Main Monster Zones Z2, the one positioned in the direction pointed to by the Link Arrow M31. This improves the strategic characteristic of the card game.

As background technique relevant to the second structure, a card game in which some of the cards held by the first user are assembled into a Deck so that the first user plays a match with the second user, using the deck has been popular (for example, JP2002-011245A1). In such a game, the first user's turn and the second user's turn are alternatively and repetitively executed. In the first user's turn, the first user places a desired card from their hand on a field, and attacks the second user, using the card placed on the field. In the second user's turn, on the other hand, the second user follows the procedure same as that which the first user has followed, to attack. One of the users who has decreased the opponent's point to zero wins.

In the above described card game, special cards having higher attack points, for example, may be prepared besides normal cards. In such a card game, use of such special cards in an attack makes it easier to win. Simultaneous use of a plurality of such special cards enables winning through a fewer number of turns, which a user may find unsatisfactory in view of strategic characteristic (amusement in planning a strategy to win) of the game.

The second structure has been conceived in view of the above, and it is an object of the second structure to provide a game system, a game control device, and a program that can improve the strategic characteristic of a game using cards.

[2-7-3]

The above described card game includes a third structure that allows placement of Pendulum Cards in the Spell & Trap Zone Z3 (the Pendulum Monster Zone) and thus does not require an area dedicated to Pendulum Cards, so that a smaller space is resulted for Pendulum Monster Cards.

As background technique relevant to the third structure, a card game in which some of the cards held by a user are assembled into a Deck and the user plays a match with the opponent, using the deck has been popular (for example, JP2002-11245A1).

In the above described card game, a match is played while placing cards in predetermined positions in the game field. As there are multiple types of cards, and a position to place a card is determined for every type of cards, an increase in the type of cards leads to a need of a larger space where to place the cards. However, as a display space of a small portable terminal, such as a smart phone, a portable phone, or the like, is limited, reduction of the space needed is necessary in order to execute a card game on a portable terminal.

The third structure has been conceived in view of the above, and it is an object of the third structure to provide a game system, a game control device, and a program that requires a smaller space to execute a game.

### 3. FUNCTIONAL BLOCKS

The above-described first structure, second structure, and third structure will be described in detail.

[3-1]

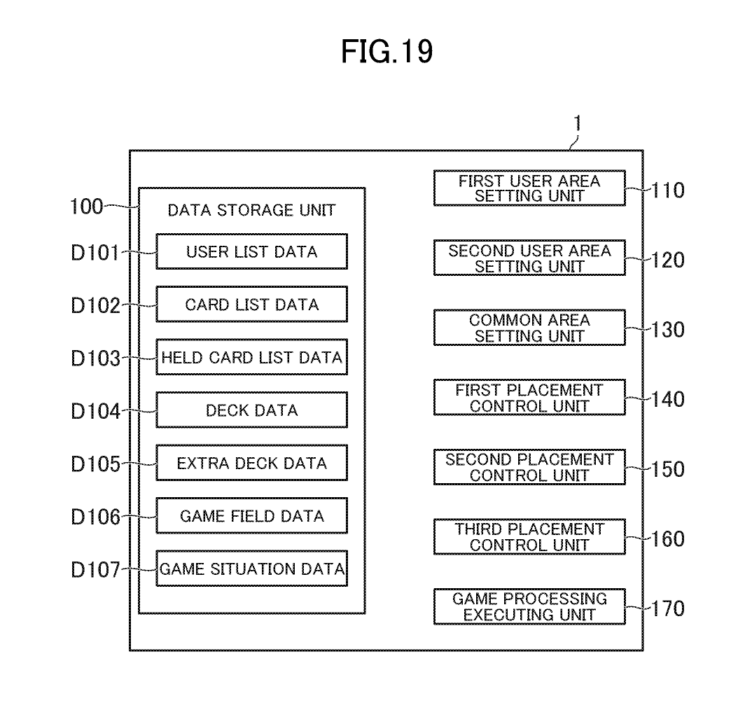

Initially, the first structure will be described. FIG. 19 is a functional block diagram illustrating functional blocks of the first structure. As illustrated in FIG. 19, the game system 1 includes, as functional blocks of the first structure, the data storage unit 100, the first user area setting unit 110, the second user area setting unit 120, the common area setting unit 130, the first placement control unit 140, the second placement control unit 150, the third placement control unit 160, and the game processing executing unit 170.

For example, the data storage unit 100 is formed using at least one of the storage unit 12, the database DB, and the storage unit 32, while the other functional blocks are formed using at least one of the control unit 11 and the control unit 31. Instead of (or in addition to) the storage unit 12, a storage unit of another device accessible from the game terminal 10 may be used.

[3-1-1]

The data storage unit 100 stores data necessary to execute a card game. Here, user list data D101, card list data D102, held card list data D103, Deck data D104, Extra Deck data D105, game field data D106, and game situation data D107 will be described as examples of data stored in the data storage unit 100.

[3-1-1-1]

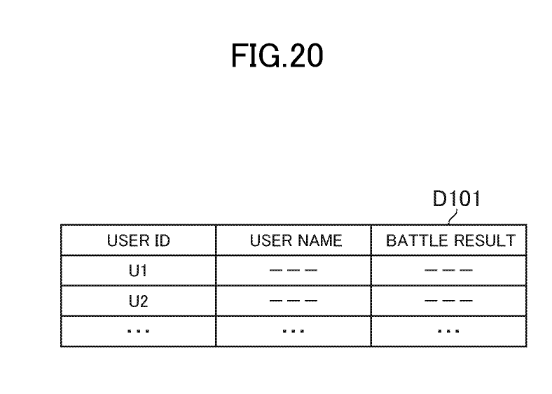

FIG. 20 illustrates one example of the user list data D101. The user list data D101 is data on a list of users who use the game system 1. As illustrated in FIG. 20, the user list data D101 includes “user ID”, “user name”, and “battle result” fields. The “user ID” field indicates identification information for uniquely identifying each user. The “user name” field indicates the name of the user. The “battle result” field indicates the battle result of the user. The user list data D101 may include additional fields indicating other information on the user.

[3-1-1-2]

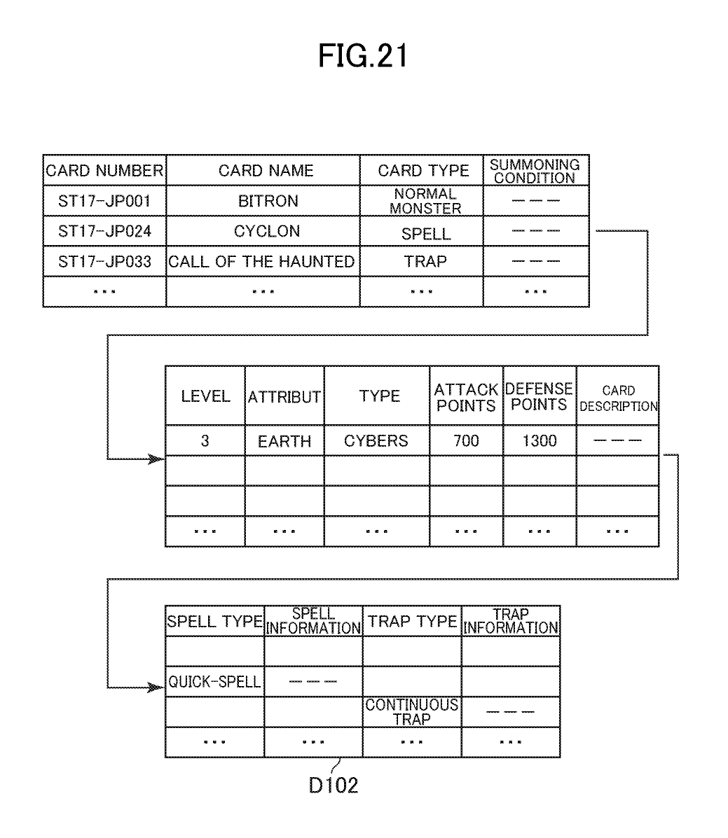

FIG. 21 illustrates one example of the card list data D102. The card list data D102 is data on a list of all cards for use in a card game. As illustrated in FIG. 21, the card list data D102 includes fields described below.

A “card number” field indicates identification information for uniquely identifying a card for use in the card game. For example, the Card Number N24 illustrated in FIG. 4 is registered in the “card number” field. A “card name” field indicates the name of the card. A “card type” field indicates the type of the card. In the above described card game, information indicating which of a Normal Monster Card, an Effect Monster Card, a Link Monster Card, a Pendulum Monster Card, an Xyz Monster Card, a Synchro Monster Card, a Fusion Monster Card, a Ritual Monster Card, a Spell Card, and a Trap Card the card concerned is registered in the “card type” field. One card can correspond to two or more types. For example, there is a Monster Card that is a Fusion Monster Card and also an Effect Monster Card.

“Summoning Condition”, “level”, “attribute”, “type”, “attack points”, “defense points”, and “card description” fields indicate information on Monster Cards. That is, information on Monster Cards is registered in these fields, while no information is registered in these fields for Spell Cards and Trap Cards.

The “Summoning Condition” field indicates a condition for placing a Monster Card on the game field. “Level”, “attribute”, and “type” fields indicate the level, attribute, and type of the Monster Card. For Xyz Monster Cards, a rank, instead of a level, is registered in the “level field”. The “attack points” field and the “defense points” field indicate attack points and defense points, respectively, of the Monster Card. For Link Monster Cards, the numeric value of a Link, instead of the defense points, is registered in the “defense points” field. The “card description” field indicates detail information on the Monster Card. For example, an effect of the Monster Card, a condition needed to be fulfilled to activate the effect, and other information on the Monster Card are registered in the “card description” field. For Link Monster Cards, information on a direction which the Link Arrow 31 points to, for example, is registered in the “card description” field.

A “spell type” field and a “spell information” field indicate information on Spell Cards. That is, information on Spell Cards is registered in these fields, while no information is registered in these fields for Monster Cards and Trap Cards.

The “spell type” field indicates the type of a Spell Card. In the above described card game, information indicating which of a Normal Spell, a Ritual Spell, a Continuous Spell, an Equip Spell, a Field Spell, or a Quick-Play spell the card concerned is of is registered in the “spell type” field. The “spell information” field indicates detail information on the Spell Card. For example, information on an effect of a Spell Card or an activation condition of the effect is registered in the “spell information” field. For Pendulum Monster Cards, information on the Pendulum Effect or the Pendulum Scale, for example, is registered in the “spell information” field.

A “trap type” field and a “trap information” field indicate information on Trap Cards. Information on Trap Cards is registered in these fields, while no information is registered in these fields for Monster Cards and Spell Cards.

The “trap type” field indicates the type of a Trap Card. In the above described card game, information indicating which of a Normal Trap, a Continuous Trap, and a Counter-Trap the card concerned is of is registered in the “trap type” field. The “trap information” field indicates detail information on Trap Cards. For example, information on the effect of a Trap Card or the activation condition of the effect is registered in the “trap information” field.

[3-1-1-3]

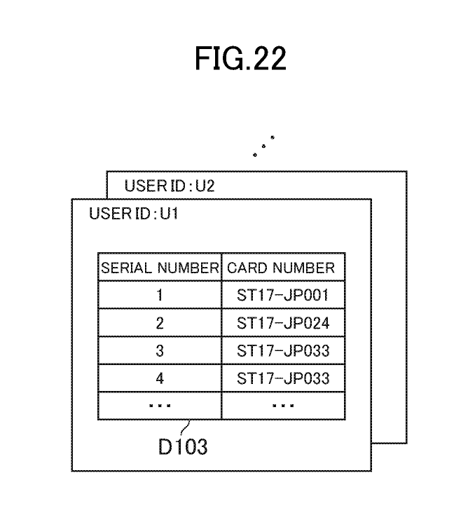

FIG. 22 illustrates one example of the held card list data D103. The held card list data D103 is stored for every user (stored so as to be associated with the user ID of each user), and indicates a list of cards held by the user. For example, each user can obtain a card by lot in exchange for virtual currency (intra-game currency) or a point, for example, or from other users through exchange or in other ways. A method for obtaining a card is not limited to the above, and various methods can be employed. As illustrated in FIG. 22, the held card list data D103 includes “serial number” and “card number” fields. The “serial number” field indicates identification information for uniquely identifying each of the cards held by a user. The “card number” field indicates the card number of a card held by the user. When a user holds two or more same cards, the card number of these cards are the same but serial numbers thereof are different.

[3-1-1-4]

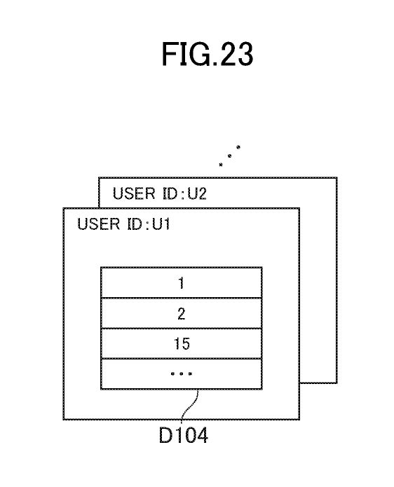

FIG. 23 illustrates one example of the Deck data D104. The Deck data D104 is stored for every user (stored so as to be associated with the user ID of each user), and indicates a list of cards included in a Deck created by the user. That is, a list of the serial numbers of cards assembled into the Deck from among the cards held by the user is registered in the Deck data D104.

[3-1-1-5]

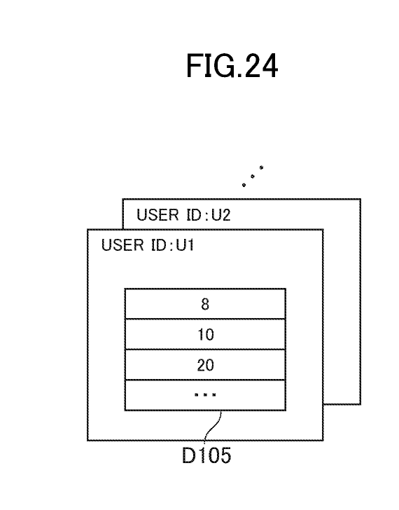

FIG. 24 illustrates one example of the Extra Deck data D105. The Extra Deck data D105 is stored for every user (stored so as to be associated with the user ID of each user), and indicates a list of cards included in an Extra Deck created by the user. That is, a list of the serial numbers of the cards assembled into the Extra Deck from among the cards held by the user is registered in the Extra Deck data D105.

The game field data D106 is data that defines each area set inside the game field. For example, in the example of the above described card game, data indicating the Duel Field F illustrated in FIG. 3 is stored as the game field data D106. That is, data that defines the first user Duel Field F1 (the Main Monster Zones Z2A to Z2E, the Spell & Trap Zones Z3A to Z3E, the Graveyard Z4A, the Main Deck Zone Z5A, the Field Zone Z6A, and the Extra Deck Zone Z7A), the second user Duel Field F2 (the Main Monster Zones Z2F to Z2J, the Spell & Trap Zones Z3F to Z3J, the Graveyard Z4B, the Main Deck Zone Z5B, the Field Zone Z6B, and the Extra Deck Zone Z7B), and the Extra Monster Zones Z1A, Z1B is stored as the game field data D106. In the case where a Banished Zone where to place a card excluded from a game is included in the Fuel Field F, the game field data D106 includes data that defines the Banished Zone as well.

The game situation data D107 is data indicating a current situation of a card game (a match). In the above described card game, the game situation data D107 includes data mentioned below: (1) data indicating that the current turn is the n^{th} turn; (2) data indicating whether the current turn is the first user's turn or the second user's turn; (3) data indicating the first user's current Life Points and the second user's current Life Points; (4) data indicating the current situation of the first user Duel Field F1 (the Main Monster Zones Z2A to Z2E, the Spell & Trap Zones Z3A to Z3E, the Graveyard Z4A, the Main Deck Zone Z5A, the Field Zone Z6A, and the Extra Deck Zone Z7A); (5) data indicating the current situation of the second user Duel Field F2 (the Main Monster Zones Z2F to Z2J, the Spell & Trap Zones Z3F to Z3J, the Graveyard Z4B, the Main Deck Zone Z5B, the Field Zone Z6B, and the Extra Deck Zone Z7B); and (6) data indicating the current situation of the Extra Monster Zones Z1A, Z1B.

The data (4) to (6) include data indicating whether or not there is any card placed in each zone, data indicating the serial number of the card, if any, placed in each zone, and data indicating the battle position (whether the card is in face-up Position or face-down Position or in Attack Position or Defense Position, or the like) of the card, if any, placed in each zone.

Besides the data described above, image data on each card and match history data for each user, for example, are stored in the data storage unit 100.

[3-1-2]

The first user area setting unit 110 sets a first user area in the game field. For example, the first user area setting unit 110 sets a plurality of first user areas.

The second user area setting unit 120 sets a second user area in the game field. For example, the second user area setting unit 120 sets a plurality of second user areas.

The common area setting unit 130 sets a common area in the game field, which is different from the first user area and the second user area. The common area setting unit 130 sets a smaller number of common areas than that of the first user areas or the second user areas. For example, the common area setting unit 130 sets a first common area and a second common area.

The first user area setting unit 110 and the second user area setting unit 120 set the first user area and the second user area, respectively, so as to face each other. The common area setting unit 130 sets the common area between the first user area and the second user area.

Here, the “game field” refers to a virtual field for playing a game using cards. That is, the “game field” refers to a virtual field where to place cards held by the first user and the second user, respectively. In the example of the above described card game, the Duel Field F corresponds to one example of the “game field”.

The “Card” refers to a virtual game object corresponding to a card. For example, the “Card” refers to a virtual game object corresponding to a card in a trading card game. Each card is associated with various information on the card. For example, ability information describing the ability of each card is associated with the card. Specifically, information indicating the strength of each card (a level, attack points, or defense points, for example), effect information indicating an effect (for example, a monster effect, a spell effect, or a trap effect) of the card, or a condition information on a condition that should be fulfilled in order to place the card in the game field, for example, is associated with the card as “ability information”. Rareness information indicating rareness of a card may be associated with the card.

The “first user area” is an area dedicated to the first user, where to place the first user's cards. Specifically, the “first user area” is an area where to place the first user's first-class cards, with placement of the first user's second-class cards therein restricted. Each area (a zone, a box, or a block, for example) where to place the first user's cards corresponds to the “first user area”. The second user's cards are not placed in the “first user area”. In the example of the above described card game, each of the Main Monster Zones Z2A to Z2E in the first user Duel Field F1 corresponds to one example of the “first user area”.

The “second user area” is an area dedicated to the second user, where to place the second user's cards. Specifically, the “second user area” is an area where to place the second user's first-class cards, with placement of the second user's second-class cards therein restricted. Each area (a zone, a box, or a block, for example) where to place the second user's cards corresponds to the “second user area”. The first user's cards are not placed in the “second user areas”. In the example of the above described card game, each of the Main Monster Zones Z2F to Z2J in the second user Duel Field F2 corresponds to one example of the “second user area”.

The “first-class cards” are cards that can be placed in the first user area or the second user area, but not in the common area. In the example of the above described card game, Monster Cards in each of the first user's and second user's hands C1, C2 correspond to one example of the “first-class cards”.

The “second-class cards” are cards that can be placed in the common area, but not in either the first user area or the second user area. For example, the “second-class cards” are higher in usability than first-class cards. “Cards higher in usability than first-class cards” refer to, for example, cards having higher ability (that is, cards associated with ability information indicating higher ability than that of first-class cards) than that of the first-class cards. In the example of the above described card game, an Extra Monster Card in the Extra Deck Zone Z7A, Z7B corresponds to one example of the “second-class card”. When a Pendulum Monster Card having been summoned from the hand C1, C2 by being placed in the Main Monster Zone Z2 is destroyed, the Pendulum Monster Card is sent to the Extra Deck Zone Z7 and placed face up there, as described above. In this case, the Pendulum Monster Card placed in the Extra Deck Zone Z7 can be placed in the Extra Monster Zone Z1 but not in the Main Monster Zone Z2. That is, as to Pendulum Monster Cards, one in the hand C1, C2 corresponds to one example of the “first-class card”, and one in the Extra Deck Zone Z7 corresponds to one example of the “second-class card”.

The “common area” is an area commonly used by the first user and the second user. In other words, the “common area” is an area where both the first user's cards and the second user's cards can be placed. In the example of the above described card game, the respective Extra Monster Zones Z1A, Z1B correspond to one example of the “common areas”. For example, the Extra Monster Zone Z1A corresponds to one example of the “first common area”, while the Extra Monster Zone Z1B corresponds to one example of the “second common area”.

“To set a common area, which is different from the first user area and the second user area” means to set an area as a common area separately from the first user area and the second user area.

“To set a common area between the first user area and the second user area” means to set a common area such that the first user area is opposed to the second user area with the common area in-between.

In the example of the above described card game, the first user area setting unit 110 sets the Main Monster Zones Z2A to Z2E in the Duel Field F. The second user area setting unit 120 sets the Main Monster Zones Z2F to Z2J in the Duel Field F. The common area setting unit 130 sets the Extra Monster Zones Z1A, Z1B in the Duel Field F.

[3-1-3]

The first placement control unit 140 accepts placement of the first user's first-class cards in the first user area, and restricts placement of the first user's second-class cards in the first user area.

The second placement control unit 150 accepts placement of the second user's first-class cards in the second user area, and restricts placement of the second user's second-class cards in the second user area.

The third placement control unit 160 accepts placement of the first or second user's second-class cards in the common area.

“To accept placement of cards in an area” means to place a card in an area in response to a placement instruction by a user, that is, to place a card designated by a user. Alternatively, this may mean to place a card designated by a user in an area designated by the user.

“To restrict placement of cards in an area” means to prohibit placement of cards in an area. This may mean that placement of cards in an area is prohibited on principle and allowed only when a predetermined condition is fulfilled.

When a second-class card of the first user is placed in either the first common area or the second common area, the third placement control unit 160 restricts placement of a second-class card of the first user in the other of the first common area and the second common area.

“When a second-class card of the first user is placed in either the first common area or the second common area, placement of a second-class card of the first user in the other of the first common area and the second common area is restricted” means that, when a second-class card of the first user is placed in the first common area (or the second common area), the first user is prohibited from placing a second-class card in the second common area (or in the first common area), and the second user is allowed to place a second-class card in the second common area (or in the first common area). Alternatively, this may mean that, when a second-class card of the first user is placed in the first common area (or in the second common area), the first user is prohibited from placing a second-class card in the second common area (or in the first common area) on principle, and is allowed only when a predetermined condition is fulfilled with this prohibition lifted.

Similarly, when a second-class card of the second user is placed in either the first common area or the second common area, the third placement control unit 160 restricts placement of a second-class card of the second user in the other of the first common area and the second common area.

“When a second-class card of the second user is placed in either the first common area or the second common area, placement of a second-class card of the second user in the other of the first common area and the second common area is restricted” means that, when a second-class card of the second user is placed in the first common area (or in the second common area), the second user is prohibited from placing a second-class card in the second common area (or in the first common area), and the first user is allowed to place a second-class card in the second common area (or in the first common area). Alternatively, this may mean that, when a second-class card of the second user is placed in the first common area (or in the second common area), the second user is prohibited from placing a second-class card in the second common area (or in the first common area) on principle, and is allowed only when a predetermined condition is fulfilled with this prohibition lifted.

In the example of the above described card game, the first placement control unit 140 accepts placement of Monster Cards from the first user's hand C1 (one example of the first-class card) in the Main Monster Zones Z2A to Z2E (one example of the first user area). Additionally, the first placement control unit 140 restricts placement of Extra Monster Cards from the Extra Deck Zone Z7A (one example of the second-class card) in the Main Monster Zones Z2A to Z2E (one example of the first user area).

The second placement control unit 150 accepts placement of Monster Cards from the second user's hand C2 (one example of the first-class card) in the Main Monster Zones Z2F to Z2J (one example of the second user area). Additionally, the second placement control unit 150 restricts placement of Extra Monster Cards in the Extra Deck Zone Z7B (one example of the second-class card) in the Main Monster Zones Z2F to Z2J (one example of the second user area).

The third placement control unit 160 accepts placement of Extra Monster Cards in the Extra Deck Zone Z7A (one example of the second-class card) in the Extra Monster Zones Z1A, Z1B (one example of the common area). Additionally, the third placement control unit 160 accepts placement of Extra Monster Cards in the Extra Deck Zone Z7B (one example of the second-class card) in the Extra Monster Zones Z1A, Z1B (one example of the common area).

When an Extra Monster Card of the first user is placed in the Extra Monster Zone Z1A, the third placement control unit 160 prohibits placement of an Extra Monster Card of the first user in the Extra Monster Zone Z1B on principle, and accepts only when a predetermined condition is fulfilled (see FIG. 9).

Similarly, when an Extra Monster Card of the second user is placed in the Extra Monster Zone Z1A, the third placement control unit 160 prohibits placement of an Extra Monster Card of the second user in the Extra Monster Zone Z1B on principle, and accepts only when a predetermined condition is fulfilled.

[3-1-4]

The game processing executing unit 170 executes game processing, based on a card placed in the first user area, the second user area, or the common area.

“To execute game processing” means to execute game processing of a card game, for example, to exhibit the ability indicated by the ability information associated with the card placed. Specifically, this means to implement an effect indicated by the effect information associated with the card placed. Alternatively, this may mean to conduct an attack from either one of the first user and the second user against the other, based on the strength information (the attack points or the defense points, for example) associated with the card placed. “An attack from the first user against the second user”, for example, may mean an attack against a card placed by the second user or against the second user themselves (to decrease the points of the second user or of a character representing the second user). This is similarly applicable to “an attack from the second user against the first user”.

In the example of the above described card game, for example, the game processing executing unit 170 executes processing for an attack from a Monster Card of the first user placed in any of the Main Monster Zones Z2A to Z2E against a Monster Card of the second user placed in the Main Monster Zones Z2F to Z2J, or the like, based on an instruction from the first user. Alternatively, the game processing executing unit 170 may execute processing to implement an effect of a Spell Card or a Trap Card placed in any of the Spell & Trap Zones Z3A to Z3, based on an instruction from the first user. Still alternatively, the game processing executing unit 170 may execute processing for an attack from an Extra Monster Card of the first user placed in either of the Extra Monster Zones Z1A, Z1B against a Monster Card of the second user placed in the Main Monster Zones Z2F to Z2J, or the like, based on an instruction from the first user.

For example, the game processing executing unit 170 executes processing for an attack from a Monster Card placed in any of the Main Monster Z2F to Z2J against a Monster Card of the first user placed in the Main Monster Zones Z2A to Z2E, or the like, based on an instruction from the second user. Alternatively, the game processing executing unit 170 may execute processing to implement an effect of a Spell Card or a Trap Card placed in any of the Spell & Trap Zones Z3F to Z3J, based on an instruction from the second user. Still alternatively, the game processing executing unit 170 may execute processing for an attack from an Extra Monster Card of the second user placed in either of the Extra Monster Zones Z1A, Z1B against a Monster Card of the first user placed in the Main Monster Zones Z2A to Z2E, or the like, based on an instruction from the second user.

[3-2]

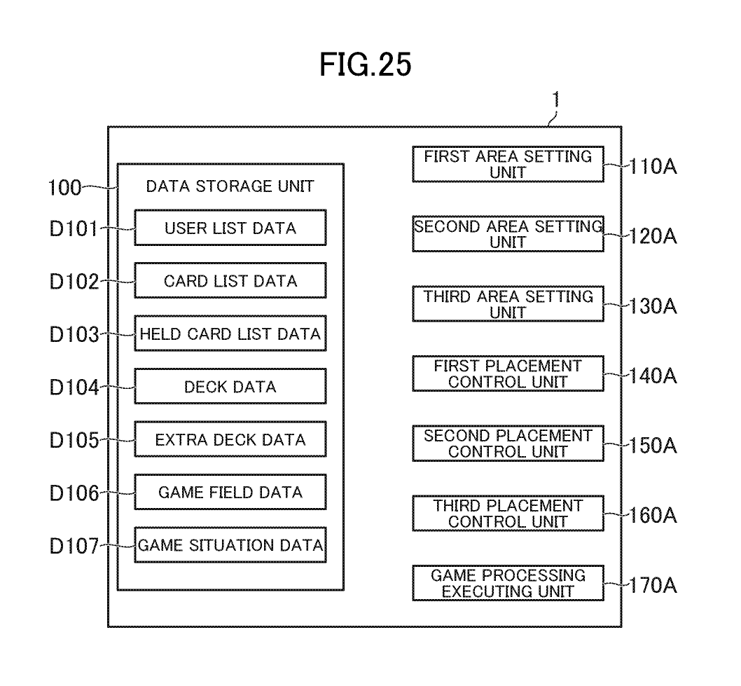

The following describes the second structure. FIG. 25 is a functional block diagram illustrating the second structure. As illustrated in FIG. 25, the game system 1 includes, as functional blocks for the second structure, the data storage unit 100, the first area setting unit 110A, the second area setting unit 120A, the third area setting unit 130A, the first placement control unit 140A, the second placement control unit 150A, the third placement control unit 160A, and the game processing executing unit 170A.

For example, the data storage unit 100 is formed using at least one of the storage unit 12, the database DB, and the storage unit 32, while the other functional blocks are formed using at least one of the control unit 11 and the control unit 32. Instead of (or together with) the storage unit 12, a storage unit of another device accessible from the game terminal 10 may be used. The data storage unit 100 is similar to that in the first structure (FIG. 19) and thus is not described here.

[3-2-1]

The first area setting unit 110A sets a plurality of first areas in the game field. The second area setting unit 120A sets a second area in the game field.

The first area setting unit 110A and the second area setting unit 120A set the plurality of first areas and the second area, respectively, such that the first areas are positioned in at least three directions viewed from the second area.

The “game field” and the “card” will not be described here as being similar to those of the first structure.

The “first area” is an area where the first user's first-class cards can be placed, with placement of the first user's second-class cards therein restricted. The “first area” is an area dedicated to the first user, where the second user's cards are not placed. Each area (a zone, a box, or a block, for example) where to place the first user's cards corresponds to the “first area”. In the example of the above described card game, each of the Main Monster Zones Z2A to Z2E in the first user Duel Field F1 corresponds to one example of the “first area”.

The “second area” is an area where the first user's second-class cards can be placed, with placement of the first user's first-class cards therein restricted. Note that the “second area” may be either a common area for use by the first user and the second user or an area dedicated to the first user. That is, the “second area” may be an area where both the first user's second-class cards and the second user's second-class cards can be placed or an area where only the first user's second-class cards can be placed. In the example of the above described card game, each of the Extra Monster Zones Z1A, Z1B corresponds to one example of the “second area”.

“The plurality of first areas and the second area are set such that the first areas are positioned in at least three directions viewed from the second area” means that, for example, the plurality of first areas are defined so as to be positioned below the second area: specifically, to the lower left of, below, and to the lower right of the second area, respectively. Alternatively, the plurality of first areas may be defined so as to be positioned above the second area: specifically, to the upper left of, above, and to the upper right of the second area, respectively. Still alternatively, the plurality of first areas may be defined so as to be positioned to the left of the second area: specifically, to the upper left of, to the left of, and to the lower left of the second area, respectively. Yet alternatively, the plurality of first areas may be defined so as to be positioned to the right of the second area: specifically, to the upper right of, to the right of, and to the lower right of the second area, respectively.

In the example of the above described card game, the Main Monster Zones Z2A, Z2B, Z2C (one example of the first area) are positioned to the lower left of, below, and to the lower right of the Extra Monster Zone Z1A (one example of the second area), respectively, as illustrated in FIG. 3. Similarly, the Main Monster Zone Z2C, Z2D, Z2E (one example of the first area) are positioned to the lower left of, below, and to the lower right of the Extra Monster Zone Z1B (one example of the second area), respectively.

The “first user's first-class cards” are the first user's cards allowed to be placed in the first area but restricted from being placed in the second area. In the example of the above described card game, Monster Cards in the first user's hand C1 correspond to one example of the “first user's first-class cards”.

The “first user's second-class cards” are the first user's cards allowed to be placed in the second area but restricted from being placed in the first area. In the example of the above described card game, an Extra Monster Card of the first user in the Extra Deck Zone Z7A corresponds to one example of the “second-class card”. As described above, when a Pendulum Monster Card having been summoned from the hand C1 by being placed in any of the Main Monster Zones Z2A to Z2E is destroyed, the Pendulum Monster Card is sent to the Extra Deck Zone Z7A and placed face up. In this case, the Pendulum Monster Card placed in the Extra Deck Zone Z7A can be placed in the Extra Monster Zones Z1A, Z1B but not in the Main Monster Zones Z2A to Z2E or the Spell & Trap Zones Z3A to Z3E. That is, as to Pendulum Monster Cards, one in the hand C1 corresponds to one example of the “first-class card”, and one in the Extra Deck Zone Z7A corresponds to one example of the “second-class card”.

[3-2-2]

The third area setting unit 130A sets a plurality of third areas in the game field. The third area setting unit 130A and the second area setting unit 120A set the plurality of third areas and the second area such that the third areas are positioned in at least three directions viewed from the second area.

The “third area” is an area where the second user's first-class cards can be placed, with placement of the second user's second-class cards therein restricted. The “third area” is an area dedicated to the second user, where the first user's cards are not placed. Each area (a zone, a box, or a block, for example) where to place the second user's cards corresponds to the “third area”. In the example of the above described card game, each of the Main Monster Zones Z2F to Z2J in the second user Duel Field F2 corresponds to one example of the “third area”.

“The second user's first-class cards” refer to the first user's cards allowed to be placed in the third area but restricted from being placed in the second area. In the example of the above described card game, Monster Cards in the second user's hand C2 correspond to one example of “the second user's first-class cards”.

“The second user's second-class cards” refer to the second user's cards allowed to be placed in the second area but restricted from being placed in the third area. In the example of the above described card game, Extra Monster Cards of the second user in the Extra Deck Zone Z7B correspond to one example of the “second-class card”.

“To set the plurality of third areas and the second area such that the third areas are positioned in at least three directions viewed from the second area” is similar to “to set the plurality of first areas and the second area such that the first areas are positioned in at least three directions viewed from the second area”. In the example of the above described card game, the Main Monster Zones Z2F, Z2G, Z2H (one example of the third area) are positioned to the upper left of, above, and to the upper right of the Extra Monster Zone Z1A (one example of the second area), respectively. Similarly, the respective Main Monster Zones Z2H, Z2I, Z2J (one example of the third area) are positioned to the upper left of, above, and to the upper right of the Extra Monster Zone Z1B (one example of the second area).

[3-2-3]

The first placement control unit 140A accepts placement of the first user's first-class cards in the first area, and restricts placement of the first user's second-class cards in the first area.

The third placement control unit 160A accepts placement of the second user's first-class cards in the third area, and restricts placement of the second user's second-class cards in the third area.

The second placement control unit 150A accepts placement of the first user's second-class cards in the second area, and restricts placement of the first user's first-class cards in the second area. Additionally, the second placement control unit 150A accepts placement of the second user's second-class cards in the second area, and restricts placement of the second user's first-class cards in the second area.

“To accept placement of cards in an area” and “to restrict placement of cards in an area” means similar to that with the first structure, and thus not described here again.

In the example of the above described card game, the first placement control unit 140A accepts placement of Monster Cards from the first user's hand C1 (one example of the first-class card of the first user) in the Main Monster Zones Z2A to Z2E (one example of the first area) in the first user Duel Field F1.

The third placement control unit 160A accepts placement of Monster Cards from the second user's hand C2 (one example of the first-class card of the second user) in the Main Monster Zones Z2F to Z2J (one example of the third area) in the second user Duel Field F2.

The second placement control unit 150A accepts placement of Extra Monster Cards of the first user in the Extra Deck Zone Z7A (one example of the second-class card of the first user) or Extra Monster Cards of the second user in the Extra Deck Zone Z7B (one example of the second-class card of the second user) in the Extra Monster Zones Z1A, Z1B (one example of the second area).

[3-2-4]

More particularly, when a second-class card of the first user is placed in the second area, the first placement control unit 140 sets one of the plurality of first areas, the one determined based on the parameter of the second-class card as an area for accepting placement of the first user's second-class cards.

“The parameter of the second-class card” refers to information associated with the second-class card, and is used as a base in designation of a first area for accepting placement of the second-class cards. For example, “the parameter of the second-class card” here includes a direction parameter indicating one or more directions. “A direction parameter” refers to information indicating one or more directions of eight directions (or four directions), for example. A parameter (a direction parameter, for example) that is used as a base in designation of a first area for accepting placement of the second-class cards maybe associated with some or all of the second-class cards. For example, in the case where the above described parameter used as the base is a direction parameter, there may be some or no second-class cards that are not associated with the direction parameter.

“The first area determined based on the parameter of the second-class card” refers to one of the plurality of first areas, the one determined based on the second area with the second-class card therein and the parameter of the second-class card. Specifically, this refers to one of the first areas adjacent to the second area with the second-class card therein, the one selected based on the parameter of the second-class card. For example, this refers to one of the plurality of first areas, the one corresponding to the direction pointed to by the direction parameter of the second-class card. “The first area corresponding to the direction pointed to by the direction parameter of the second-class card” refers to the first area positioned in the direction pointed to by the direction parameter of the second-class card in the second area when viewed from the second area. Specifically, for example, this refers to one of the first areas adjacent to the second area with the second-class card therein, the one positioned in the direction pointed to by the direction parameter of the second-class card when viewed from the second area.

“To set as an area for accepting placement of the first user's second-class cards” means to allow placement of a second-class card of the first user in the first area determined.

“When a second-class card is placed in the second area, the first area determined based on the parameter of the second-class card is set as an area for accepting placement of the first user's second-class cards” means that, for example, during the first user's turn with a second-class card placed in the second area, placement of a second-class card of the first user in the first area determined based on the parameter of the second-class card is allowed. Alternatively, this may mean that, only during the first user's turn in which a second-class card has been placed in the second area, placement of a second-class card of the first user in the first area determined based on the parameter of the second-class card is allowed. Still alternatively, this may mean that, during the first user's turn in which a second-class card has been placed in the second area, placement of a second-class card of the first user in the first area determined based on the parameter of the second-class card may be restricted, and during the first user's subsequent turn, the placement may be accepted. Note that if the second-class card placed in the second area is removed by an attack or the like, placement of a second-class card of the first user in the first area determined based on the parameter of the second-class card may not be accepted but restricted.

Thereafter, when a second-class card of the first user is placed in the first area determined, the first placement control unit 140A sets one of the plurality of first areas, the one determined based on the parameter of the second-class card newly placed as an area for accepting placement of the first user's second-class cards.

“The first area determined based on the parameter of the second-class card” refers to one of the plurality of first areas, the one determined based on the first area with the second-class card therein and the parameter of the second-class card. Specifically, for example, this refers to one of the first areas other than and adjacent to the first area with the second-class card therein, the one determined based on the parameter of the second-class card. For example, this refers to one of the plurality of first areas, the one corresponding to the direction pointed to by the direction parameter of the second-class card. “The first area corresponding to the direction pointed to by the direction parameter of the second-class card newly placed” refers to a first area other than the first area with the second-class card therein, the first area positioned in the direction pointed to by the direction parameter of the second-class card newly placed in the first area when viewed from the first area. Specifically, for example, this refers to one of the first areas other than and adjacent to the first area with the second-class card therein, the one positioned in the direction pointed to by the direction parameter of the second-class card newly placed in the first area when viewed from the first area.

“Thereafter, when a second-class card of the first user is placed in the first area determined, one of the plurality of first areas, the one determined based on the parameter of the second-class card newly placed is set as an area for accepting placement of the first user's second-class cards” means that, during the first user's turn with a second-class card of the first user placed in the first area, placement of a second-class card of the first user in the other first area determined based on the parameter of the second-class card newly placed is allowed. Alternatively, this many mean that, only during the first user's turn in which a second-class card of the first user has been placed in the first area, placement of a second-class card of the first user in the other first area determined based on the parameter of the second-class card newly placed is allowed. Still alternatively, this may mean that, during the first user's turn in which a second-class card of the first user has been placed in the first area, placement of a second-class card of the first user in the other first area determined based on the parameter of the second-class card newly placed may not be allowed but restricted, and during the first user's subsequent turn, the placement is allowed. Note that if the second-class card of the first user placed in the first area is removed by an attack or the like, placement of a second-class card of the first user in the other first area determined may not be accepted but restricted.

In the example of the above described card game, when a Link Monster Card of the first user, that is, one type of an Extra Monster Card, (one example of the second-class card) is placed in the Extra Monster Zone Z1A, Z1B (one example of the second area), the first placement control unit 140A sets one of the Main Monster Zones Z2A to Z2E (one example of the plurality of first areas), the one positioned in the direction pointed to by the Link Arrow M31 of the Link Monster Card as a zone where an Extra Monster Card of the first user can be placed. When a Link Monster Card of the first user is thereafter placed in the Main Monster Zone that becomes available for placement therein of an Extra Monster Card of the first user, the first placement control unit 140A sets a Main Monster Zone as well positioned in the direction pointed to by the Link Arrow M31 of the Link Monster Card newly placed as a zone where an Extra Monster Card of the first user can be placed.

For example, the Link Arrows M31 of the Link Monster Card (Decode Talker) illustrated in FIG. 6 point to the lower left, the lower right, and upper directions, respectively. When the first user places this Link Monster Card in the Extra Monster Zone Z1A, the first user is now allowed to place an Extra Monster Card in the Main Monster Zones Z2A and Z2C positioned to the lower left of and to the lower right of the Extra Monster Zone Z1A, respectively. When the first user thereafter places the Link Monster Card (Honeybot) illustrated in FIG. 7 in the Main Monster Zone Z2C, the first user is now allowed to place Extra Monster Cards in the respective Main Monster Zones Z2B, Z2D as well respectively positioned to the left of and to the right of the Main Monster Zone Z2C as the Link Arrows M31 of the Link Monster Card point to the left and right respective directions.

The third placement control unit 160A may have the similar function as that of the first placement control unit 140A described above. For example, when a Link Monster Card (one example of the second-class card) of the second user is placed in the Extra Monster Zone Z1A, Z1B (one example of the second area), the third placement control unit 160A may set one of the Main Monster Zones Z2F to Z2J (one example of the plurality of third areas), the one positioned in the direction pointed to by the Link Arrow M31 of the Link Monster Card as a zone where an Extra Monster Card of the second user can be placed. When the second user thereafter places a Link Monster Card in the Main Monster Zone that becomes available for placement therein of an Extra Monster Card of the second user, the third placement control unit 160A may set a Main Monster Zone positioned in the direction pointed to by the Link Arrow M31 of the Link Monster Card newly placed as a zone where an Extra Monster Card of the second user can be placed.

[3-2-5]

When a second-class card of the first user is placed in the second area, the third placement control unit 160A may set one of the plurality of third areas, the one determined based on the parameter of the second-class card as an area for accepting placement of the second user's second-class cards.

“The third area determined based on the parameter of the second-class card” refers to one of the plurality of third areas, the one determined based on the second area with the second-class card therein and the parameter of the second-class card. Specifically, this refers to one of the third areas adjacent to the second area with the second-class card therein, the one selected based on the parameter of the second-class card. For example, this refers to one of the plurality of third areas, the one corresponding to the direction pointed to by the direction parameter of the second-class card. “The third area corresponding to the direction pointed to by the direction parameter of the second-class card” refers to a third area positioned in the direction pointed to by the direction parameter of the second-class card in the second area when viewed from the second area. Specifically, for example, this refers to one of the third areas adjacent to the second area with the second-class card therein, the one positioned in the direction pointed to by the direction parameter of the second-class card in the second area when viewed from the second area.

“When a second-class card of the first user is placed in the second area, one of the plurality of third areas, the one determined based on the parameter of the second-class card is set as an area for accepting placement of the second user's second-class cards” means that, during the second user's turn with a second-class card of the first user placed in the second area, placement of a second-class card of the second user in the third area determined based on the parameter of the second-class card is allowed. Alternatively, this many mean that only during the second user's turn immediately after the first user's turn in which a second-class card of the first user has been placed in the second area, placement of a second-class card of the second user in the third area determined based on the parameter of the second-class card is allowed. Note that if the second-class card of the first user placed in the second area is removed by an attack or the like, placement of a second-class card of the second user in the third area may not be accepted but restricted.

In the example of the above described card game, when a Link Monster Card (one example of the second-class card) of the first user is placed in the Extra Monster Zone Z1A, Z1B (one example of the second area), the third placement control unit 160A sets one of the Main Monster Zones Z2F to Z2J (one example of the plurality of third areas), the one positioned in the direction pointed to by the Link Arrow M31 of the Link Monster Card as a zone where an Extra Monster Card of the second user can be placed.

For example, the Link Arrows M31 of the Link Monster Card (Decode Talker) illustrated in FIG. 6 point to the lower left, lower right, and upper directions, respectively. When the first user places this Link Monster Card in the Extra Monster Zone Z1A, the second user is allowed to place an Extra Monster Card in the Main Monster Zone Z2G positioned above the Extra Monster Zone Z1A. When the second user thereafter places the Link Monster Card (Honeybot) illustrated in FIG. 7 in the Main Monster Zone Z2G, the second user is now allowed to place Extra Monster Cards in the Main Monster Zones Z2F, Z2H as well respectively positioned to the left of and to the right of the Main Monster Zone Z2G as the Link Arrows M31 of the Link Monster Card point to the left and right respective directions.

The first placement control unit 140A may have the similar functions to that of the third placement control unit 160A described here. For example, when a Link Monster Card (one example of the second-class card) of the second user is placed in the Extra Monster Zone Z1A, Z1B (one example of the second area), the first placement control unit 140A may set one of the Main Monster Zones Z2A to Z2E (one example of the plurality of the first areas), the one positioned in the direction pointed to by the Link Arrow M31 of the Link Monster Card as a zone where an Extra Monster Card of the first user can be placed.

[3-2-6]

The second area setting unit 120A may set the first common area and the second common area as the second area. The second placement control unit 150A may accept placement of the first or second user's second-class cards in the first or second common area. When a second-class card of the first user is placed in the first common area, the second placement control unit 150A may restrict placement of a second-class card of the first user in the second common area.

However, even when a second-class card of the first user is placed in the first common area, the second placement control unit 150A may set the second common area as an area for accepting placement of the first user's second-class cards in the case where a second-class card of the first user is placed in any first area and the second common area corresponds to an area determined based on the parameter of that second-class card.

The “common area” is an area commonly used by the first user and the second user and where a second-class card of the first user and a second-class card of the second user can both be placed. In the example of the above described card game, each of the Extra Monster Zones Z1A, Z1B corresponds to one example of the “common area”. For example, the Extra Monster Zone Z1A corresponds to one example of the “first common area”, and the Extra Monster Zone Z1B corresponds to one example of the “second common area”.

“In the case where a second-class card of the first user is placed in any first area and the second common area corresponds to an area determined based on the parameter of that second-class card” refers to a case in which a second-class card of the first user is placed in any first area and the second common area corresponds to the direction pointed to by the direction parameter of that second-class card. “In the case where the second common area corresponds to the direction pointed to by the direction parameter of that second-class card” refers to a case, for example, where the second common area is positioned in the direction pointed to by the direction parameter of the second-class card of the first user placed in any first area when viewed from the first area. Specifically, this refers to a case, for example, where the second common area is adjacent to the first area with a second-class card of the first user therein and is positioned in the direction pointed to by the direction parameter of the second-class card when viewed from the first area.

“To set as an area for accepting placement of the first user's second-class cards” means to allow placement of a second-class card of the first user in the second common area. Alternatively, during the first user's turn with a second-class card of the first user placed in any first area, placement of a second-class card of the first user in the second common area may be allowed, or only during the first user's turn in which a second card of the first user has been placed in any first area, placement of a second-class card of the first user in the second common area may be allowed. Still alternatively, during the first user's turn in which a second-class card of the first user has been placed in any first area, placement of a second-class card of the first user in the second common area may not be accepted, and during the first user's subsequent turn, the placement may be allowed. If the second-class card of the first user placed in the first area is removed by an attack or the like, placement of a second-class card of the first user in the second common area may not be accepted but restricted.

In the example of the above described card game, in the case where, for example, a Link Monster Card of the first user, that is, one kind of the Extra Monster Card, (one example of the second-class card) is placed in the Extra Monster Zone Z1A (one example of the first common area), the second placement control unit 150A prohibits placement of an Extra Monster Card of the first user in the Extra Monster Zone Z1B (one example of the second common area) on principle.

However, when an Extra Link, such as the example illustrated in FIG. 9, is completed (that is, when the Link Arrows M31 of adjacent ones of all the Link Monster Cards of the first user placed on the path from the Extra Monster Zone Z1A to the Extra Monster Zone Z1B via at least one of the Main Monster Zones Z2A to Z2F are pointing to each other), exceptionally, the second placement control unit 150A allows placement of an Extra Monster Card of the first user in the Extra Monster Zone Z1B as well.

[3-2-7]

The game processing executing unit 170A executes game processing, based on the card placed in the first area or the second area. To “execute game processing” is similar to that with the first structure, and will not described here.

In the example of the above described card game, the game processing executing unit 170A executes processing for an attack from a Monster Card of the first user placed in any of the Main Monster Zones Z2A to Z2E against a Monster Card of the second user placed in the Main Monster Zones Z2F to Z2J, or the like, based on an instruction from the first user. Alternatively, the game processing executing unit 170A executes processing for an attack from an Extra Monster Card of the first user placed in either of the Extra Monster Zones Z1A, Z1B against a Monster Card of the second user placed in the Main Monster Zones Z2F to Z2J, or the like, based on an instruction from the first user.

For example, the game processing executing unit 170A executes processing for an attack from a Monster Card placed in any of the Main Monster Zones Z2F to Z2J against a Monster Card of the first user placed in the Main Monster Zones Z2A to Z2E, or the like, based on an instruction from the second user. Alternatively, the game processing executing unit 170A executes processing for an attack from an Extra Monster Card of the second user placed in either of the Extra Monster Zones Z1A, Z1B against a Monster Card of the first user placed in the Main Monster Zones Z2A to Z2E, or the like, based on an instruction from the second user.

[3-3]

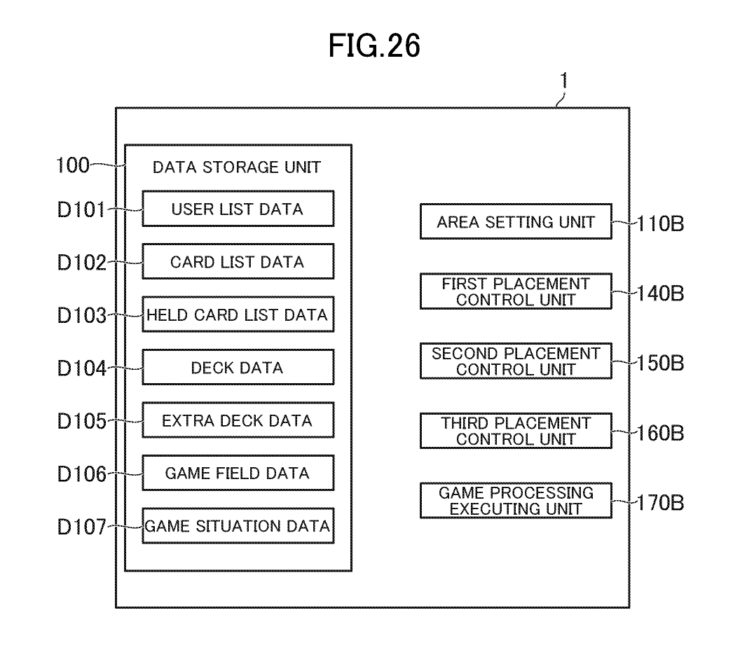

The following describes the third structure. FIG. 26 is a functional block diagram showing functional blocks for the third structure. As illustrated in FIG. 26, the game system 1 includes, as functional blocks for the third structure, the data storage unit 100, an area setting unit 110B, a first placement control unit 140B, a second placement control unit 150B, a third placement control unit 160B, and a game processing executing unit 170B.

For example, the data storage unit 100 is formed using at least one of the storage unit 12, the database DB, and the storage unit 32, while the other functional blocks are formed using at least one of the control unit 11 and the control unit 31. Instead of (or in addition to) the storage unit 12, a storage unit of another device accessible from the game terminal 10 maybe used. The data storage unit 100 is similar to that of the first structure (FIG. 19), and thus is not described here again.

[3-3-1]

The area setting unit 110B sets a first area and a second area in the game the field. For example, the area setting unit 110B sets a plurality of second areas so as to be aligned in a predetermined direction in the game field.

The first placement control unit 140B accepts placement of a user's first-class cards in the first area, and restricts placement of the user's second-class cards in the first area. Meanwhile, the second placement control unit 150B accepts placement of the user's second-class cards in the second area, and restricts placement of the user's first-class cards in the second area.

The “game field”, the “card”, “to accept placement of cards in an area”, and “to restrict placement of cards in an area” are similar to those in the case of the first structure, and thus not described here again.

The “first area” is an area where to place mainly the user's first-class cards, with placement of the user's second-class cards therein restricted. Each area (a zone, a box, or a block, for example) where to place the user's first-class cards corresponds to the “first area”. In the example of the above described card game, each of the Main Monster Zones Z2A to Z2E corresponds to one example of the “first area”.

The “second area” is an area where to place mainly the user's second-class cards, with placement of the user's first-class cards therein restricted. Each area (a zone, a box, or a block, for example) where to place the user's second-class cards corresponds to the “second area”. In the example of the above described card game, each of the Spell & Trap Zones Z3A to Z3E corresponds to one example of the “second area”.

The “first-class cards” are specific type of cards. For example, the “first-class cards” are a type of cards that can be placed in the first area, but are restricted from being placed in the second area. In the example of the above described card game, a type of cards that can be placed in the main Monster Zones Z2A to Z2E, that is, Monster Cards other than Extra Monster Cards, correspond to one example of the “first-class card”.

The “second-class cards” are specific type of cards different in type from the first-class cards. For example, the “second-class cards” are a type of cards that can be placed in the second area, but are restricted from being placed in the first area. In the example of the above described card game, a type of cards allowed to be placed in the Spell & Trap Zones Z3A to Z3E, namely, Spell Cards or Trap Cards, correspond to one example of the “second-class card”.

The “predetermined direction” refers to a widthwise or lengthwise direction, for example. “To set a plurality of second areas so as to be aligned in a predetermined direction” means to set a plurality of second areas so as to be aligned along a straight line extending in a predetermined direction.

In the example of the above described card game, the first placement control unit 140B allows placement of the first user's Monster Cards other than Extra Monster Cards (one example of the first-class card) in the Main Monster Zones Z2A to Z2E (one example of the first area), and restricts placement of the first user's Spell Cards or Trap Cards (one example of the second-class card) in the Main Monster Zones Z2A to Z2E. The second placement control unit 150B accepts placement of the first user's Spell Cards or Trap Cards (one example of the second-class card) in the Spell & Trap Zones Z3A to Z3E (one example of the second area), and restricts placement of the first user's Monster Cards other than Extra Monster Cards (one example of the first-class card) in the Spell & Trap Zones Z3A to Z3E (one example of the second area).

[3-3-2]

The third placement control unit 160B accepts placement of the user's third-class cards in the first area or the second area. For example, the third placement control unit 160B accepts placement of the third-class cards in two second areas at the respective both ends of the plurality of second areas aligned in a predetermined direction, and restricts placement of the third-class cards in other second areas.

The “third-class cards” are cards of a specific type, different from the first-class cards and the second-class cards. For example, the “third-class cards” have attributes of both first-class cards and second-class cards, and each can be used as a first-class card and also as a second-class card. For example, the “third-class cards” are associated with first ability information relevant to a first ability and second ability information relevant to a second ability. An “ability” refers to, for example, the strength (a level, attack points, or defense points, for example) or an effect of a card. A “first ability” refers to an ability to be exhibited when a third-class card is placed in a first area. In other words, the “first ability” refers to an ability of a third-class card used as a first-class card. That is, the “first ability” refers to an ability as a first-class card. Meanwhile, a “second ability” refers to an ability to be exhibited when a third-class card is placed in a second area. In other words, the “second ability” refers to an ability of a third-class card used as a second-class card. That is, the “second ability” is the ability as a second-class card.

In the example of the above described card game, Pendulum Monster Cards in the first user's hand C1 correspond to one example of the “third-class card”. As described above, when a Pendulum Monster Card having been summoned from the hand C1 and placed in any of the Main Monster Zones Z2A to Z2E is destroyed, the Pendulum Monster Card is sent to the Extra Deck Zone Z7A and placed face up. In this case, the Pendulum Monster Card placed in the Extra Deck Zone Z7A can be placed in the Extra Monster Zones Z1A, Z1B, but not in the Main Monster Zones Z2A to Z2E or the Spell & Trap Zones Z3A to Z3E, and is not either a “first-class card”, a “second-class card”, or a “third-class card” mentioned above. As described above, a Pendulum Monster Card has the ability (the attack points and the defense points) as a Monster Card and the ability as a Spell Card that activates a Pendulum Summon: the ability as a Monster card corresponds to one example of the “first ability”, and the ability as a Spell Card to activate a Pendulum Summon corresponds to one example of the “second ability”.

The “two areas at the respective both ends” refer to, in the case where a plurality of second areas are aligned in the widthwise direction, the leftmost and rightmost second areas, for example, and in the case where a plurality of second areas are aligned in the lengthwise direction, the uppermost and lowermost second areas. In the example of the above described card game, the Spell & Trap Zones Z3A, Z3E (Pendulum Zones) correspond to one example of the “two second areas at the respective both ends”.

In the example of the above described card game, the third placement control unit 160B accepts placement of the first user's Pendulum Monster Cards in the Main Monster Zones Z2A to Z2E (one example of the first area). The third placement control unit 160B accepts placement of the first user's Pendulum Monster Cards in the Spell & Trap Zone Z3A, Z3E (one example of the second area).

[3-3-3]

The game processing executing unit 170B executes game processing, based on a card placed in the first area or the second area. For example, when a third-class card is placed in the first area, the game processing executing unit 170B executes game processing, based on the first ability information associated with the third-class card. Meanwhile, when a third-class card is placed in the second area, the game processing executing unit 170B executes game processing, based on the second ability information associated with the third-class card.

To “execute game processing, based on the first ability information associated with the third-class card” means, for example, to conduct an attack from the first user against the second user or an attack from the second user against the first user, or to exhibit the first ability (an effect, for example) of the third-class card, based on the first ability (the attack points or the defense points, for example) of the third-class card.

To “execute game processing, based on the second ability information associated with the third-class card” means, for example, to exhibit the second ability (an effect or the like) of the third-class card, for example. That is, this may mean to conduct an attack from the first user against the second user or an attack from the second user against the first user, based on the second ability (the attack points or the defense points, for example) of the third-class card.

In the case where third-class cards are placed in two respective second areas, the first placement control unit 140B accepts placement of a plurality of first-class cards or third-class cards at once in a plurality of first areas, based on the combination of the third-class cards placed in these two second areas.

To “accept placement of a plurality of first-class cards or third-class cards at once in a plurality of first areas, based on the combination of the third-class cards” means to accept placement of a plurality of first-class cards or third-class cards in the plurality of first areas when the combination of the third-class cards is specific. The number of first cards or third-class cards that can be placed at once may be set as a numeric value corresponding to a combination of third cards. “A plurality of first-class cards or third-class cards” may be “a plurality of first-class cards”, “a plurality of third-class cards”, or “one or more first-class cards and one or more third-class cards”.

In the example of the above described card game, in the case where a Pendulum Monster Card of the first user (one example of the third-class card) is placed in any of the Main Monster Zones Z2A to Z2E (one example of the first area), the game processing executing unit 170B executes processing for an attack from the Pendulum Monster Card against a Monster Card of the second user placed in the Main Monster Zones Z2F to Z2J, or the like, based on the attack points (one example of the first ability information) of the Pendulum Monster Card, following an instruction from the first user.

Meanwhile, in the case where Pendulum Monster Cards of the first user are placed in both the Spell & Trap Zones Z3A, Z3E (one example of the second area), the game processing executing unit 170B activates a Pendulum Summon, based on the Pendulum Scales (one example of the second ability information) of the Pendulum Monster Cards, following an instruction from the first user. In this case, the first placement control unit 140B can accept, once per turn, placement in the Main Monster Zones Z2A to Z2E, of as many Monster cards as the first user wants whose levels are in between the Pendulum Scales of the Pendulum Monster Cards placed in the respective Spell & Trap Zones Z3A, Z3E from the first user's hand C1 or the Extra Deck Zone Z7A.

### 4. PROCESSING

The following describes processing to be executed in the game system 1.

[4-1]

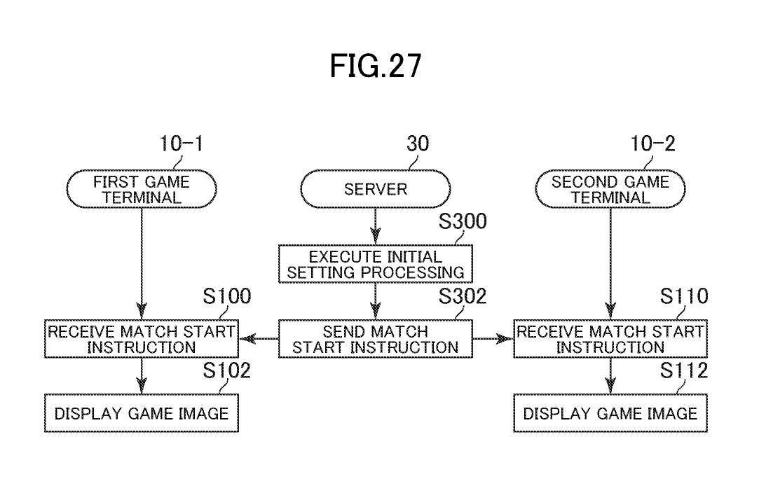

FIG. 27 is a flowchart of one example of processing executed at the start of a match in a card game. In FIG. 27, assume a first user using the first game terminal 10-1 and a second user using the second game terminal 10-2 as a combination of users playing a match.

As illustrated in FIG. 27, initially, the control unit 31 of the server 30 executes initial setting processing (S300). For example, the control unit 31 sets respective zones in the Duel Field F. Specifically, the control unit 31 sets zones other than the Main Deck Zones Z5A, Z5B and the Extra Deck Zones Z7A, Z7B such that no cards are placed therein. The control unit 31 shuffles the first user's Deck to create a Bank for the first user to be placed in the first user's Main Deck Zone Z5A, with reference to the first user's Deck data D104. Further, the control unit 31 creates an Extra Deck for the first user to be placed in the first user's Extra Deck Zone Z7A, with reference to the first user's Extra Deck data D105. Similarly, the control unit 31 shuffles the second user's Deck to create a Bank for the second user to be placed in the second user's Main Deck Zone Z5B, with reference to the second user's Deck data D104. Further, the control unit 31 creates an Extra Deck for the second user to be placed in the second user's Extra Deck Zone Z7B, with reference to the second user's Extra Deck data D105. The control unit 31 sets the first user's and second user's Life Points to the respective initial values, and decides with which of the first user's turn and the second user's turn the game starts. At Step S300, the above-described processing is executed, to thereby initialize the game situation data.

After execution of Step S300, the control unit 31 sends a match start instruction to start a card game to the first game terminal 10-1 and the second game terminal 10-2 via the communication unit 33 (S302). Specifically, the control unit 31 sends data necessary to display various images, such as the game image G1, on the display unit 15, together with the match start instruction, to each of the first game terminal 10-1 and the second game terminal 10-2. For example, game situation data and data (a serial number, a card number, a card name, an image, for example) on each of the cards included in the first user's and second user's decks or Extra Decks are sent.

The first game terminal 10-1 and the second game terminal 10-2 receive the match start instruction via the communication unit 13 (S100, S110). Then, the respective control units 11 display the game image G1 on the display unit 15 (S102, S112) to start a match in the card game.

[4-2]

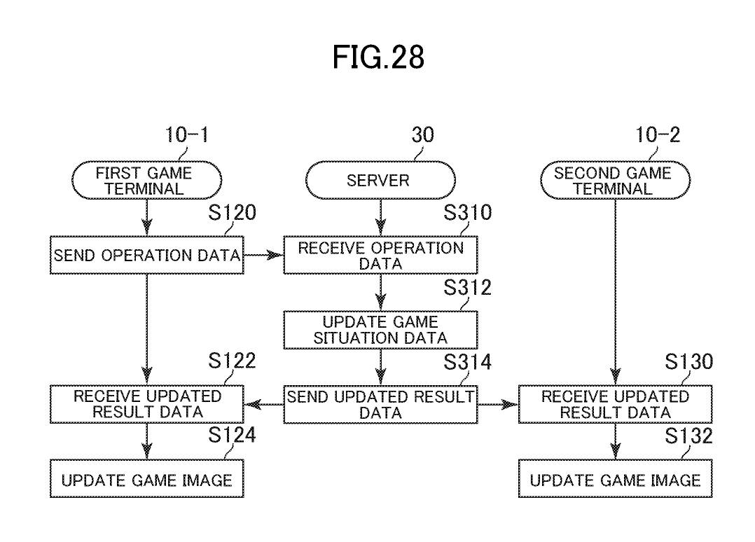

FIG. 28 is a flowchart of one example of processing that is executed in response to a card placement instruction operation or an attack instruction operation by a user during a match. In FIG. 28, assume that the first user performs a card placement instruction operation or an attack instruction operation. The same processing is executed when the second user performs a card placement instruction operation or an attack instruction operation as well.

As illustrated in FIG. 28, when the first user performs a card placement instruction operation or an attack instruction operation during a match, the control unit 11 of the first game terminal 10-1 initially sends operation data to the server 30 via the communication unit 13 (S120). The server 30 receives the operation data via the communication unit 33 (S310). The control unit 31 of the server 30 updates the game situation data, based on the operation data (S312).

Upon receipt of the operation data indicating a card placement instruction operation, the control unit 31 initially determines whether or not placement of a placement target card designated by the first user in a placement target zone designated by the first user is possible.

For example, in the case where the placement target card is a Normal Monster Card in the hand C1, the control unit 31 determines which of the Main Monster Zones Z2A to Z2E the placement target zone is, whether or not the placement target zone is vacant, and whether or not the Summoning Condition of the placement target card is fulfilled. For a placement target card having no Summoning Condition set thereto, the control unit 31 considers that the Summoning Condition of the placement target card is fulfilled. When the placement target zone is any of the Main Monster Zones Z2A to Z2E, the placement target zone is vacant (that is, no other card is placed in the placement target zone), and the Summoning Condition of the placement target card is fulfilled, the control unit 31 determines that placement of the placement target card in the placement target zone is possible.

For example, in the case where the placement target card is a Spell Card or a Trap Card in the hand C1, the control unit 31 determines which of the Spell & Trap Zones Z3A to Z3E the placement target zone is and whether or not the placement target zone is vacant. When the placement target zone is any of the Spell & Trap Zones Z3A to Z3E and the placement target zone is vacant, the control unit 31 determines that placement of the placement target card in the placement target zone is possible.

For example, in the case where the placement target card is a Pendulum Monster Card, the control unit 31 determines which of the Main Monster Zones Z2A to Z2E or the Spell & Trap Zones Z3A, Z3E the placement target zone is, whether or not the placement target zone is vacant, whether or not the Summoning Condition of the placement target card is fulfilled. When the placement target zone is any of the Main Monster Zones Z2A to Z2E and the Spell & Trap Zones Z3A, Z3E, the placement target zone is vacant, and the Summoning Condition of the placement target card is fulfilled, the control unit 31 determines that placement of the placement target card in the placement target zone is possible.

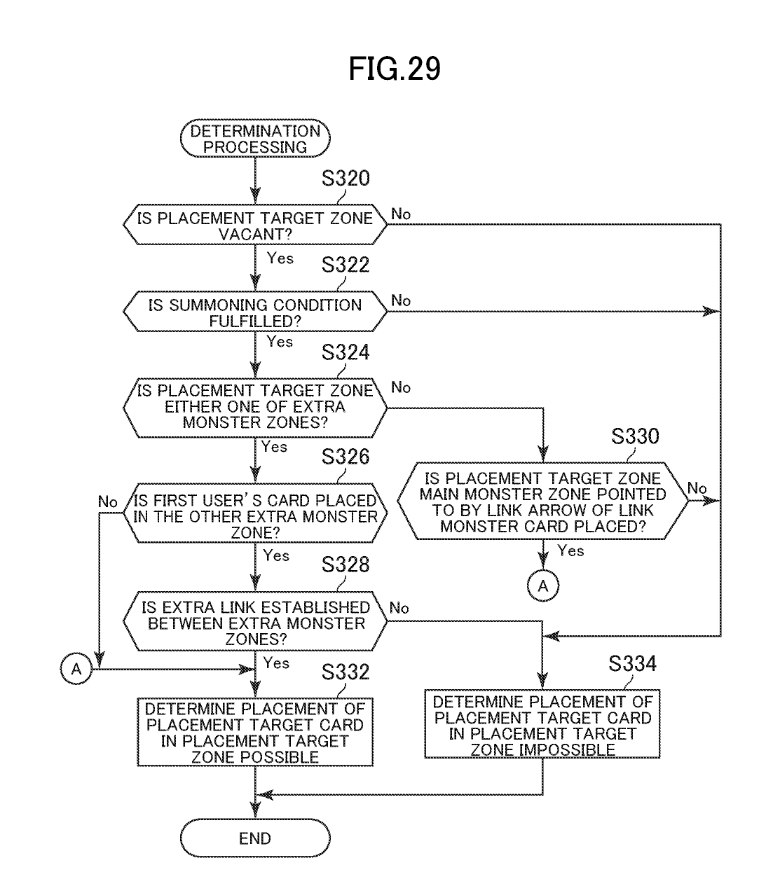

For example, in the case where the placement target card is an Extra Monster Card in the first user's Extra Deck Zone Z7A, the control unit 31 executes the processing such as is shown in FIG. 29.

Specifically, the control unit 31 initially determines whether or not the placement target zone is vacant (S320). When the placement target zone is not vacant (that is, a card is already placed in the placement target zone), the control unit 31 determines placement of the placement target card in the placement target zone is impossible (S334). However, in the case where the Extra Monster Card is an Xyz Monster Card, exceptionally, the control unit 31 executes the Step S322 to be described later, instead of determining that placement of the placement target card in the placement target zone is impossible.

Meanwhile, when the placement target zone is vacant, the control unit 31 determines whether or not the Summoning Condition of the placement target card is fulfilled (S322). For a placement target card having no Summoning Condition set thereto, the control unit 31 determines that the Summoning Condition of the placement target card is fulfilled. When the Summoning Condition of the placement target card is not fulfilled, the control unit 31 determines that placement of the placement target card in the placement target zone is impossible (S334).

Meanwhile, when the Summoning Condition of the placement target card is fulfilled, the control unit 31 determines whether or not the placement target zone is either of the Extra Monster Zones Z1A, Z1B (S324). When the placement target zone is either of the Extra Monster Zones Z1A, Z1B, the control unit 31 determines whether or not any of the first user's cards is already placed in the other of the Extra Monster Zones Z1A, Z1B (S326). When no card of the first user is placed in the other of the Extra Monster Zones Z1A, Z1B, the control unit 31 determines that placement of the placement target card in the placement target zone is possible (S332).

Meanwhile, when any of the first user's cards is already placed in the other of the Extra Monster Zones Z1A, Z1B, the control unit 31 determines whether or not the Extra Monster Zones Z1A, Z1B are linked to each other via an Extra Link, as is in the example illustrated in FIG. 9 (S328). When the Extra Monster Zones Z1A, Z1B are linked to each other via an Extra Link, the control unit 31 determines that placement of the placement target card in the placement target zone is possible (S332). However, when the Extra Monster Zones Z1A, Z1B are not linked to each other via an Extra Link, the control unit 31 determines that placement of the placement target card in the placement target zone is impossible (S334).

When it is determined at Step S324 that placement target zone is not either of the Extra Monster Zone Z1A, Z1B, the control unit 31 determines whether or not the placement target zone is a Main Monster Zone pointed to by the Link Arrow M31 of a Link Monster Card already placed (S330). When the placement target zone is such a Main Monster Zone, the control unit 31 determines that placement of the placement target card in the placement target zone is possible (S332). However, when the placement target zone is not such a Main Monster Zone, the control unit 31 determines that placement of the placement target card in the placement target zone is impossible (S334).

With a determination that placement of the placement target card in the placement target zone is possible, the control unit 31 updates the game situation data such that the placement target card is placed in the placement target zone. If removal of a card placed in the Main Monster Zones Z2A to Z2E or the like and sending of the card removed to the Graveyard Z4A is necessary in exchange for placement of the placement target card in the placement target zone (that is, if Tribute is necessary), the control unit 31 updates the game situation data such that the card is removed and sent to the Graveyard Z4A, for example. Meanwhile, with a determination that placement of the placement target card in the placement target zone is impossible, the control unit 31 does not update the game situation data (without placing the placement target card in the placement target zone) but notifies the first user terminal 10-1 of that situation.

In the case where operation data indicating an operation for instructing to conduct a Pendulum Summon is received with Pendulum Monster Cards placed in both the Spell & Trap Zones Z3A, Z3E, the control unit 31 places a Monster Card designated by the user (that is, a Monster Card whose level is in between the Pendulum Scales of these Pendulum Monster Cards) from the first user's hand C1 and the Extra Deck Zone Z7A in the Main Monster Zones Z2A to Z2E, following the operation.

In the case where operation data indicating an operation for instructing to conduct an attack (an operation for instructing to conduct an attack from a Monster Card of the first user placed in any of the Main Monster Zones Z2A to Z2E and the Extra Monster Zones Z1A, Z1B against the second user's Monster Card placed in the Main Monster Zones Z2F to Z2J, or the like,) is received, for example, the control unit 31 executes processing such as is described below to update the game situation data.

Specifically, in the case where a Monster Card of the second user as an attack target is in Attack Position, the control unit 31 compares the attack points of a Monster Card of the first user and those of the Monster Card of the second user. When the attack points of the first user's Monster Card are higher than those of the second user's Monster Card, the control unit 31 decreases the second user's Life Points by an amount corresponding to the difference in attack points. When the attack points of the first user's Monster Card are lower than those of the second user's Monster Card, the control unit 31 decreases the first user's Life Points by an amount corresponding to the difference in attack points. When the attack points of the first user's Monster Card are equal to the attack points of the second user's Monster Card, the control unit 31 moves the first user's Monster Card to the Graveyard Z4A and the second user's Monster Card to the Graveyard Z4B.

In the case where a Monster Card of the second user as an attack target is in a Defense Position, the control unit 31 compares the attack points of a Monster Card of the first user and the defense points of the Monster Card of the second user. When the attack points of the first user's Monster Card are higher than the defense points of the second user's Monster Card, the control unit 31 moves the second user's Monster Card to the Graveyard Z4B. When the attack points of the first user's Monster Card are lower than the defense points of the second user's Monster Card, the control unit decreases the first user's Life Points by an amount corresponding to the difference between the defense points and the attack points. When the attack points of the first user's Monster Card are equal to the defense points of the second user's Monster Card, the control unit 31 maintains the current state with neither updating the first user's and second user's Life Points nor moving the first user's and second user's Monster cards to the respective Graveyards Z4A, Z4B.

After execution of Step S312, the control unit 31 sends updated result data indicating the updated game situation data to the first game terminal 10-1 and the second game terminal 10-2 via the communication unit 33 (S314). The first game terminal 10-1 and the second game terminal 10-2 receive the data via the communication unit 13 (S122, S130), and the respective control units 11 update the game image G1 displayed on the display unit 15, based on the data (S124, S132).

### 5. CONCLUSION

In the game system 1 (the first structure), the first or second user is restricted from placing an Extra Monster Card in the Main Monster Zones Z2A to Z2J but allowed to place in the Extra Monster Zones Z1A, Z1B that are commonly used by the first user and the second user. This makes it less easy for the first user and the second user to place Extra Monster Cards having higher attack points than those of Normal Monster Cards. This can resultantly improve the strategic characteristic of the card game.

In the game system 1 (the first structure), when an Extra Monster Card of the first user is already placed in one of the Extra Monster Zones Z1A, Z1B, the first user is restricted from placing another Extra Monster Card in the other of the Extra Monster Zones Z1A, Z1B, while, when an Extra Monster Card of the second user is already placed in one of the Extra Monster Zones Z1A, Z1B, the second user is restricted from placing another Extra Monster Card in the other of the Extra Monster Zones Z1A, Z1B. This makes it less likely that a situation where Extra Monster Cards of either one of the first user and the second user are placed in both the Extra Monster Zones Z1A, Z1B occurs.

In the game system 1 (the first structure), a fewer number of Extra Monster Zones Z1A, Z1B than the number of the first user's Main Monster Zones Z2A to Z2E or the second user's Main Monster Zones Z2F to Z2J are set. This makes it less easy to place many Extra Monster Cards. This can resultantly improve the strategic characteristic of the card game.

In the game system 1 (the first structure), the Extra Monster Zones Z1A, Z1B are set between the first user's Main Monster Zones Z2A to Z2E and the second user's Main Monster Zones Z2F to Z2J which are positioned opposed to each other. This helps the first user and the second user intuitively understand that the Extra Monster Zones Z1A, Z1B are commonly used by the first user and the second user.

In the game system 1 (the second structure), the first user is basically restricted from placing Extra Monster Cards in the first user's Main Monster Zones Z2A to Z2E, and, only when a Link Monster Card of the first user (one type of the Extra Monster Card) is placed in either of the Extra Monster Zones Z1A, Z1B, is allowed to place an Extra Monster Card in one of the Main Monster Zones Z2A to Z2E, the one positioned in the direction pointed to by the Link Arrow M31 of the Link Monster Card. With the above, the first user can increase the number of Extra Monster Cards that can be placed by placing a Link Monster Card in the Extra Monster Zones Z1A, Z1B in consideration of the Link Arrow M31 of the Link Monster Card. This can resultantly improve the strategic characteristic of the card game.

In the game system 1 (the second structure), in the case where a Link Monster Card of the first user is placed in any of the first user's Main Monster Zones Z2A to Z2E, the first user is allowed to place an Extra Monster card also in one of the Main Monster Zones Z2A to Z2E, the one positioned in the direction pointed to by the Link Arrow M31 of the Link Monster Card placed. With the above, the first user can further increase the number of Extra Monster Cards that can be placed by placing a Link Monster Card in the Main Monster Zone in consideration of the Link Arrow M31 of the Link Monster Card. This can resultantly improve the strategic characteristic of the card game.

In the game system 1 (the second structure), the second user is basically restricted from placing Extra Monster Cards in the second user's Main Monster Zones Z2F to Z2J, and, when a Link Monster Card of the first user is placed in either of the Extra Monster Zones Z1A, Z1B, is allowed to place an Extra Monster Card in one of the Main Monster Zones Z2F to Z2J, the one positioned in the direction pointed to by the Link Arrow M31 of the Link Monster Card. That is, the first user's placing a Link Monster Card in either of the Extra Monster Zones Z1A, Z1B may allow the second user to place an Extra Monster Card in the Main Monster Zones Z1F to Z2J, depending on the direction pointed to by the Link Arrow M31 of the Link Monster Card. With the above, the first user needs to determine whether or not to place a Link Monster Card in the Extra Monster Zones Z1A, Z1B and to select a Link Monster to be placed in the Extra Monster Zones Z1A, Z1B in consideration of the Link Arrow M31 of the Link Monster Card. This can resultantly further improve the strategic characteristic of the card game.

In the game system 1 (the second structure), in the case where a Link Monster Card of the first user is placed in either one of the Extra Monster Zones Z1A, Z1B, the first user is restricted from placing a Link Monster Card in the other of the Extra Monster Zones Z1A, Z1B on principle, and, only when an Extra Link such as is illustrated in FIG. 9 is completed, is allowed to place a Link Monster Card in the other of the Extra Monster Zones Z1A, Z1B as well. With the above, the first user can exceptionally place Link Monster Cards in both the Extra Monster Zones Z1A, Z1B through selection of a Link Monster Card to be placed in consideration of the Link Arrow M31 of the Link Monster Card. This can resultantly further improve the strategic characteristic of the card game.

In the game system 1 (the second structure), the Extra Monster Zones Z1A, Z1B are set such that the first user's Main Monster Zones Z2A to Z2E are positioned in at least three directions viewed from each of the Extra Monster Zones Z1A, Z1B. With the above, the Link Monster Card placed in the Extra Monster Zones Z1A, Z1B can increase the patterns of the Main Monster Zones where Extra Monster Cards can be placed.

In the game system 1 (the third structure), placement of the first user's Pendulum Monster Cards in the Main Monster Zones Z2A to Z2J or the Spell & Trap Zones Z3A, Z3E is accepted. This eliminates the need of providing an area dedicated to Pendulum Monster Cards, separately from the Main Monster Zones Z2A to Z2J or the Spell & Trap Zones Z3A, Z3E. This can reduce the space necessary in executing the card game.

In the game system 1 (the third structure), Pendulum Monster Cards of the first user function as Monster Cards when the Pendulum Monster Cards are placed in the Main Monster Zones Z2A to Z2J, and as Spell Cards that activate Pendulum Summons when the Pendulum Monster Cards are placed in the Spell & Trap Zones Z3A, Z3E. This is, the ability of Pendulum Monster Cards to exhibit can be changed between when the Pendulum Monster Cards are placed in the Main Monster Zone Z2A to Z2J and when the Pendulum Monster Cards are placed in the Spell & Trap Zone Z3A, Z3E. In other words, whether to implement an ability of a Pendulum Monster Card as a Monster Card or an ability as a Spell Card is selectable.

In the game system 1 (the third structure), when Pendulum Monster Cards of the first user are placed in both the Spell & Trap Zones Z3A, Z3E, the first user is allowed to place, once per turn, as many Monster Cards as the first user wants whose levels are in between the Pendulum Scales indicated by these Pendulum Monster Cards from the first user's hand C1 and the Extra Deck Zone Z7A, in the Main Monster Zones Z2A to Z2E. This can resultantly provide a user with a special method for summoning monsters, that is, a Pendulum Summon as described above, besides Normal Summoning methods. This allows a user to select a method to summon. This can improve the strategic characteristic of the card game.

In the game system 1 (the third structure), the number of Spell & Trap Zones where the first user's Pendulum Monster Cards can be placed can be limited to two. While limitless increase of the Pendulum Summons as described above may possibly deteriorate excitement of the card game, the game system 1 (the third structure) can prevent occurrence of such disadvantage. Also, in the game system 1 (the third structure), two Spell & Trap Zones at the respective ends of the Spell & Trap zones Z3A to Z3E aligned are available for placement of Pendulum Monster Cards therein. This makes it easier to know which of the Spell & Trap Zones Z3A to Z3E is available for placement of Pendulum Monster Cards therein.

### 6. MODIFIED EXAMPLES

The present invention is not limited to the above-described embodiments.

[6-1]

A number of items parameter may be associated with Link Monster Cards, instead of the direction parameter. For example, when a Link Monster Card is placed in the Extra Monster Zone Z1A, the number of Main Monster Zones equal to the number indicated by the number of items parameter may be selected at random from among the Main Monster Zones Z2A to Z2C, Z2F to Z2H adjacent to the Extra Monster Zone Z1A to set as a zone where an Extra Monster Card can be placed. Alternatively, an attribute parameter may be associated with a Link Monster Card, instead of the direction parameter. For example, when a Link Monster Card is placed in the Extra Monster Zone Z1A, at least one of the Main Monster Zone Z2A to Z2C, Z2F to Z2H adjacent to the Extra Monster Zone Z1A may be set as a zone where an Extra Monster Card having an attribute indicated by the attribute parameter can be placed.

[6-2]

In the above-described embodiment, when an Extra Monster Card of the first user is placed in the Extra Monster Zone Z1A, the first user is allowed to place an Extra Monster Card in the Extra Monster Zone Z1B exceptionally only when the Extra Monster Zones Z1A, Z1B are co-linked (that is, an Extra Link established), as is in the example illustrated in FIG. 9. However, such an exception may not be necessarily limited to the case in which the Extra Monster Zones Z1A, Z1B are co-linked. Specifically, in the example illustrated in FIG. 9, for example, placement of an Extra Monster card of the first user in the Extra Monster Zone Z1B may be allowed even when the Link Arrow M31 of the Link Monster Card placed in the Main Monster Zone Z2C does not point to the left direction (or, in the case where the Link Arrow M31 of the Link Monster Card placed in the Main Monster Zone Z2D does not point to the left direction, and so forth).

[6-3]

The processing (S310 to S314) that is executed by the server 30 in the above description with reference to FIG. 29 may be executed by either the first game terminal 10-1 or the second game terminal 10-2 instead. That is, either the first game terminal 10-1 or the second game terminal 10-2 may function as a server as well.

[6-4]

The present invention is applicable to card games other than the above described card game.

### 7. APPENDIX

The above-described description may lead to understanding of the present invention as described below, for example. To help understanding of the present invention, reference numerals in parentheses are given, which, however, should not limit the present invention to the aspects illustrated.

1-1) According to one aspect of the present invention, there is provided a game system (1) for executing a game using cards, including: a first user area setting unit (110) for setting a first user area (Z2A to Z2E) in a game field (f), a second user area setting unit (120) for setting a second user area (Z2F to Z2J) in the game field, a common area setting unit (130) for setting a common area (Z1A, Z1B) which is different from the first user area and the second user area in the game field, a first placement control unit (140) for accepting placement of a first-class card of a first user in the first user area, and for restricting placement of a second-class card of the first user in the first user area, a second placement control unit (150) for accepting placement of the first-class card of a second user in the second user area, and for restricting placement of the second-class card of the second user in the second user area, a third placement control unit (160) for accepting placement of the second-class card of the first user or the second-class card of the second user in the common area, and a game processing executing unit (170) for executing game processing, based on a card placed in the first user area, the second user area, or the common area. The first-class card of the first user is a Normal Monster Card in the hand C1, for example. The second-class card of the first user is an Extra Monster Card in the Extra Deck Zone Z7A, for example. The first-class card of the second user is a Normal Monster Card in the hand C2, for example. The second-class card of the second user is an Extra Monster Card in the Extra Deck Zone Z7B, for example.

1-5) According to one aspect of the present invention, there is provided a game control system (10 or 30) for executing a game using cards, including: a first user area setting unit (110) for setting a first user area (Z2A to Z2E) in a game field (f), a second user area setting unit (120) for setting a second user area (Z2F to Z2J) in the game field, a common area setting unit (130) for setting a common area (Z1A, Z1B) which is different from the first user area and the second user area in the game field, a first placement control unit (140) for accepting placement of a first-class card of a first user in the first user area, and for restricting placement of a second-class card of the first user in the first user area, a second placement control unit (150) for accepting placement of the first-class card of a second user in the second user area, and for restricting placement of the second-class card of the second user in the second user area, a third placement control unit (160) for accepting placement of the second-class card of the first user or the second-class card of the second user in the common area, and a game processing executing unit (170) for executing game processing, based on a card placed in the first user area, the second user area, or the common area. The first-class card of the first user is a Normal Monster Card in the hand C1, for example. The second-class card of the first user is an Extra Monster Card in the Extra Deck Zone Z7A, for example. The first-class card of the second user is a Normal Monster Card in the hand C2, for example. The second-class card of the second user is an Extra Monster Card in the Extra Deck Zone Z7B, for example.

1-6) According to one aspect of the present invention, there is provided a program for causing a computer to function as the game system (1) according to any one of 1-1) to 1-4) or the game control device (10 or 30) according to 1-5).

1-7) According to one aspect of the present invention, there is provided a computer readable information storage medium storing the program according to 1-6).

1-8) According to one aspect of the present invention, there is provided a control method for controlling a game system (1) or a game control device (10 or 30) for executing a game using cards, the control method including: a first user area setting step (S300) of setting a first user area in a game field, a second user area setting step (S300) of setting a second user area in the game field, a common area setting step (S300) of setting a common area which is different from the first user area and the second user area in the game field, a first placement control step (S312) of accepting placement of a first-class card of a first user in the first user area, and for restricting placement of a second-class card of the first user in the first user area, a second placement control step (S312) of accepting placement of the first-class card of a second user in the second user area, and for restricting placement of the second-class card of the second user in the second user area, a third placement control step (S312) of accepting placement of the second-class card of the first user or the second-class card of the second user in the common area, and a game processing executing step (S312) of executing game processing, based on a card placed in the first user area, the second user area, or the common area.

1-2) In one embodiment of the present invention, the common area setting unit (130) may set a first common area (Z1A) and a second common area (Z1B), and when the second-class card of the first user is placed in either one of the first common area and the second common area, the third placement control unit (160) may restrict placement of the second-class card of the first user in the other of the first common area and the second common area, and when the second-class card of the second user is placed in either one of the first common area and the second common area, the third placement control unit (160) may restrict placement of the second-class card of the second user in the other of the first common area and the second common area.

1-3) In one embodiment of the present invention, the first user area setting unit (110) may set a plurality of first user areas,
the second user area setting unit (120) may set a plurality of second user areas, and the common area setting unit (130) may set a smaller number of common areas than the number of the first user areas or the second user areas.

1-4) In one embodiment of the present invention, the first user area setting unit (110) and the second user area setting unit (120) may set the first user area and the second user area so as to be opposed to each other, and the common area setting unit (130) may set the common area between the first user area and the second user area.

2-1) According to one aspect of the present invention, there is provided a game system (1) for executing a game using cards, including a first area setting unit (110A) for setting a plurality of first areas (Z2A to Z2E) in a game field (F), a second area setting unit (120A) for setting a second area (Z1A, Z1B) in the game field, a first placement control unit (140A) for accepting placement of a first-class card of a user in the first areas, and restricting placement of a second-class card of the user in the first areas, a second placement control unit (150A) for accepting placement of the second-class card in the second area, and restricting placement of the first-class card in the second area, a game processing executing unit (170A) for executing game processing based on a card placed in the first area or the second area, wherein when the second-class card is placed in the second area, the first placement control unit (140A) sets one of the plurality of first areas, the one determined based on a parameter of the second-class card as an area for accepting placement of the second-class card. The first-class card of the user is a Monster Card in the hand C1, for example. The second-class card of the user is an Extra Monster Card in the Extra Deck Zone Z7A or a Link Monster Card, for example. The parameter of the second-class card is the Link Arrow 31M, for example.

2-7) According to one aspect of the present invention, there is provided a game control device (10 or 30) for executing a game using cards, including a first area setting unit (110A) for setting a plurality of first areas (Z2A to Z2E) in a game field (F), a second area setting unit (120A) for setting a second area (Z1A, Z1B) in the game field, a first placement control unit (140A) for accepting placement of a first-class card of a user in the first areas, and restricting placement of a second-class card of the user in the first areas, a second placement control unit (150A) for accepting placement of the second-class card in the second area, and restricting placement of the first-class card in the second area, a game processing executing unit (170A) for executing game processing based on a card placed in the first area or the second area, wherein when the second-class card is placed in the second area, the first placement control unit (140A) sets one of the plurality of first areas, the one determined based on a parameter of the second-class card as an area for accepting placement of the second-class card. The first-class card of the user is a Monster Card in the hand C1, for example. The second-class card of the user is an Extra Monster Card in the Extra Deck Zone Z7A or a Link Monster Card, for example. The parameter of the second-class card is the Link Arrow 31M, for example.

2-8) According to one aspect of the present invention, there is provided a program for causing a computer to function as the game system (1) according to any one of 2-1) to 2-6) or the game control device (10 or 30) according to 2-7).

2-9) According to one aspect of the present invention, there is provided a computer readable information storage medium storing the program according to 2-8).

2-10) According to one aspect of the present invention, there is provided a control method for controlling a game system (1) or a game control device (10 or 30) for executing a game using cards, the control method including: a first area setting step (S300) of setting a plurality of first areas (Z2A to Z2E) in a game field (F), a second area setting step (S300) of setting a second area (Z1A, Z1B) in the game field, a first placement control step (S312) of accepting placement of a first-class card of a user in the first areas, and restricting placement of a second-class card of the user in the first areas, a second placement control step (S312) of accepting placement of the second-class card in the second area, and restricting placement of the first-class card in the second area, a game processing executing step (S312) of executing game processing based on a card placed in the first area or the second area, wherein at the first placement control step (S312), when the second-class card is placed in the second area, one of the plurality of first areas, the one determined based on a parameter of the second-class card is set as an area for accepting placement of the second-class card. The first-class card of the user is a Monster Card in the hand C1, for example. The second-class card of the user is an Extra Monster Card in the Extra Deck Zone Z7A or a Link Monster Card, for example. The parameter of the second-class card is the Link Arrow 31M, for example.

2-2) In one embodiment of the present invention, the parameter may include a direction parameter pointing one or more directions, when the second-class card is placed in the second area, the first placement control unit (140A) may set one of the plurality of first areas, the one corresponding to the direction pointed to by the direction parameter of the second-class card as an area for accepting placement of the second-class card. The direction parameter may be a Link Arrow 31M, for example.

2-3) In one embodiment of the present invention, when the second-class card is placed in the first area, the first placement control unit (140A) may set one of the plurality of first areas, the one determined based on the parameter of the second-class card as an area for accepting placement of the second-class card.

2-4) In one embodiment of the present invention, the user may be a first user, and the game system (1) may further include a third area setting unit (130A) for setting a plurality of third areas (Z2F to Z2J) in the game field, and a third placement control unit (160A) for accepting placement of a first-class card of a second user in the third areas, and for restricting placement of a second-class card of the second user in the third areas, wherein when the second-class card of the first user is placed in the second area, the third placement control unit (160A) may set one of the plurality of third areas, the one determined based on the parameter of the second-class card as an area for accepting placement of the second-class card of the second user.

2-5) In one embodiment of the present invention, the user may be a first user, the second area setting unit (120A) may set a first common area (Z1A) and a second common area (Z1B) as the second area, and the second placement control unit (150A) may accept placement of the second-class card of the first user or of the second user in the first common area or the second common area, when the second-class card of the first user is placed in the first common area, the second placement control unit (150A) may restrict placement of the second-class card of the first user in the second common area, and even though the second-class card of the first user is placed in the first common area, when the second-class card is placed in the first area and the second common area corresponds to an area determined based on the parameter of the second-class card placed in the first area, the second placement control unit (150A) may set the second common area as an area for accepting placement of the second-class card of the first user.

2-6) In one embodiment of the present invention, the first area setting unit (140A) and the second area setting unit (150A) may set the plurality of first areas and the second area such that the first areas are positioned in at least three directions viewed from the second area.

3-1) According to one aspect of the present invention, there is provided a game system (1) for executing a game using cards, including an area setting unit (110B) for setting a first area (Z2A to Z2E) and a second area (Z3A, Z3E) in a game field (F), a first placement control unit (140B) for accepting placement of a first-class card of a user in the first area and restricting placement of a second-class card of the user in the first area, a second placement control unit (150B) for accepting placement of the second-class card in the second area, and restricting placement of the first-class card in the second area, a third placement control unit (160B) for accepting placement of a third-class card of the user in the first area or the second area, and
a game processing executing unit (170B) for executing game processing based on a card placed in the first area or the second area. The first-class card of the user is a Monster Card, for example. The second-class card is a Spell Card, for example. The third-class card of the user is a Pendulum Monster Card, for example.

3-5) According to one aspect of the present invention, there is provided a game control device (10 or 30) for executing a game using cards, including an area setting unit (110B) for setting a first area (Z2A to Z2E) and a second area (Z3A, Z3E) in a game field (F), a first placement control unit (140B) for accepting placement of a first-class card of a user in the first area and restricting placement of a second-class card of the user in the first area, a second placement control unit (150B) for accepting placement of the second-class card in the second area, and restricting placement of the first-class card in the second area, a third placement control unit (160B) for accepting placement of a third-class card of the user in the first area or the second area, and a game processing executing unit (170B) for executing game processing based on a card placed in the first area or the second area. The first-class card of the user is a Monster Card, for example. The second-class card is a Spell Card, for example. The third-class card of the user is a Pendulum Monster Card, for example.

3-6) According to one aspect of the present invention, there is provided a program for causing a computer to function as the game system (1) according to any one of 3-1) to 3-4) or the game control device (10 or 30) according to 3-5).

3-7) According to one aspect of the present invention, there is provided a computer readable information storage medium storing the program according to 3-6).

3-8) According to one aspect of the present invention, there is provided a control method for controlling a game system (1) or a game control device (10 or 30) for executing a game using cards, the control method including: an area setting step (S300) of setting a first area (Z2A to Z2E) and a second area (Z3A, Z3E) in a game field (F), a first placement control step (S312) of accepting placement of a first-class card of a user in the first area and restricting placement of a second-class card of the user in the first area, a second placement control step (S312) of accepting placement of the second-class card in the second area, and restricting placement of the first-class card in the second area, a third placement control step (S312) of accepting placement of a third-class card of the user in the first area or the second area, and a game processing executing step (S312) of executing game processing based on a card placed in the first area or the second area. The first-class card of the user is a Monster Card, for example. The second-class card is a Spell Card, for example. The third-class card of the user is a Pendulum Monster Card, for example.

3-2) In one embodiment of the present invention, the third-class card may be associated with first ability information relevant to a first ability and second ability information relevant to a second ability, and when the third-class card is placed in the first area, the game processing executing unit (170B) may execute the game processing, based on the first ability information associated with the third-class card, and when the third-class card is placed in the second area, the game processing executing unit (170B) may execute the game processing, based on the second ability information associated with the third-class card. The first ability information may be the attack points or the defense points, for example. The second ability information may be the Pendulum Scale, for example.

3-3) In one embodiment of the present invention, when the third-class cards are placed in two second areas (Z3A, Z3E), the first placement control unit (140B) may accept simultaneous placement of the plurality of first-class cards or third-class cards in the plurality of first areas, based on a combination of the third-class cards placed in the two second areas.

3-4) In one embodiment of the present invention, the area setting unit (110B) may set a plurality of second areas so as to be aligned in a predetermined direction in the game field, and the third placement control unit (160B) may accept placement of the third-class cards in two second areas at the respective ends of the plurality of second areas aligned, and restrict placement of the third-class cards in the other second areas.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A game system comprising:
at least one processor configured to:
set a first user area in a game field;
set a second user area in the game field;
set a common area which is different from the first user area and the second user area in the game field;
accept placement of a first-class card of a first user in the first user area;
restrict placement of a second-class card of the first user in the first user area;
accept placement of the first-class card of a second user in the second user area;
restrict placement of the second-class card of the second user in the second user area;
accept placement of the second-class card of the first user or the second-class card of the second user in the common area; and
execute game processing, based on a card placed in the first user area, the second user area, or the common area.

2. The game system according to claim 1, wherein the at least one processor:
sets a first common area and a second common area,
restricts placement of the second-class card of the first user in either one of the first common area or the second common area when the second-class card of the first user is placed in another of the first common area or the second common area, and
restricts placement of the second-class card of the second user in either of the first common area or the second common area when the second-class card of the second user is placed in another of the first common area or the second common area.

3. The game system according to claim 1,
wherein the at least one processor sets a plurality of first user areas, a plurality of second user areas, and at least one common area, and
wherein a number of the at least one common area is smaller than a number of the first user areas or the second user areas.

4. The game system according to claim 1, wherein the at least one processor:
sets the first user area and the second user area so as to be opposed to each other, and
sets the common area between the first user area and the second user area.

5. A game control device comprising:
at least one processor configured to:
set a first user area in a game field;
set a second user area in the game field;
set a common area which is different from the first user area and the second user area in the game field;
accept placement of a first-class card of a first user in the first user area;
restrict placement of a second-class card of the first user in the first user area;
accept placement of the first-class card of a second user in the second user area;
restrict placement of the second-class card of the second user in the second user area;
accept placement of the second-class card of the first user or the second-class card of the second user in the common area; and
execute game processing, based on a card placed in the first user area, the second user area, or the common area.

6. A computer readable non-temporary information storage medium storing a program for causing a computer to:
set a first user area in a game field;
set a second user area in the game field;
set a common area which is different from the first user area and the second user area in the game field;
accept placement of a first-class card of a first user in the first user area;
restrict placement of a second-class card of the first user in the first user area;
accept placement of the first-class card of a second user in the second user area;
restrict placement of the second-class card of the second user in the second user area;
accept placement of the second-class card of the first user or the second-class card of the second user in the common area; and
execute game processing, based on a card placed in the first user area, the second user area, or the common area.
